(19) United States
(12) Patent Application Publication
(10) Pub. No.: US 2026/0352071 A1
(43) Pub. Date: Nov. 5, 2026

(54) MODULAR POWER CONVERTER SYSTEM FOR A VEHICLE

(71) Applicants: TAU MOTORS, INC., Redwood City, CA (US); THE TRUSTEES OF COLUMBIA UNIVERSITY IN THE CITY OF NEW YORK, New York, NY (US)

(72) Inventors: Walter Wesley PENNINGTON, III, Menlo Park, CA (US); Gregory Gordon STEVENSON, San Carlos, CA (US); Ethan Bagget SWINT, Redwood City, CA (US); Michael Parker OWEN, Raleigh, NC (US); Matthias PREINDL, New York, NY (US)

(21) Appl. No.: 19/484,270

(22) PCT Filed: May 17, 2024
(86) PCT No.: PCT/US2024/030010

§ 371 Date: Nov. 13, 2025

Related U.S. Application Data
(60) Provisional application No. 63/467,510, filed on May 18, 2023.
(60) Provisional application No. 63/536,303, filed on Sep. 1, 2023.

(51) Int. Cl. H02K 11/33; H02K 5/04

(52) U.S. Cl. CPC H02K 11/33; H02K 5/04

(57) ABSTRACT

Disclosed are systems for a modular power converter in a drive unit for a vehicle. The modular power converter includes a first power conversion unit including a first power conversion module disposed within a first housing, the first housing defining a first external recess. The modular power converter further includes a second power conversion unit including a second power conversion module disposed within a second housing. The second housing defines a second external recess and is configured to couple to the first housing so that the first external recess and the second external recess collectively define a first coolant channel between the first housing and the second housing.

### CROSS-REFERENCE TO RELATED APPLICATIONS

This application claims the benefit of U.S. Provisional Patent Application No. 63/467,510, filed on May 18, 2023, and U.S. Provisional Patent Application No. 63/536,303, filed on Sep. 1, 2023, each of which is incorporated herein by reference in its entirety.

### BACKGROUND

The present disclosure relates generally to drive units for a vehicle. More specifically, the present disclosure relates to systems for providing integrated drive units with (modular) power converter systems to supply electrical power to the drive unit.

### SUMMARY

A power converter can be coupled to a drive unit to form an integrated drive unit assembly (e.g., for vehicle, such as an automobile, a boat, an aircraft, etc.). The power converter can be shaped or contoured around various components of the drive unit (e.g., a motor or transmission) to allow for more compact packaging, and can share a coolant path with the drive unit so that the same cooling fluid can be used to cool, for example, a transmission, a motor, and the power converter. The power converter can be configured as a modular power converter with a plurality of power converter units that can be stacked together in accordance with a size or power output of a motor. Each power conversion unit can define a cooling path with an adjacently coupled power conversion unit to allow coolant to flow between the units.

Within a power converter unit, power converter modules can be arranged in an opposed configuration to position a power electronic component near the coolant to provide directed cooling thereto. For example, a power electronic component can be received in a seat that is in fluid communication with a coolant path through the power converter to provide direct cooling to the power electronic component (e.g., via submerged or jet impingement cooling). Additionally, power converter modules arranged in an opposed configuration can be coupled to a shared bus bar that can extend between the opposed power converter modules.

According to one aspect of the present disclosure, a drive unit for a vehicle can include a transmission and a motor operatively coupled to the transmission, and a power converter configured to supply electrical power to the motor. The power converter can include a housing that can be secured to at least one of the transmission and the motor. The housing can be shaped corresponding to a shape of the motor so that the housing at least partially surrounds the motor. For example, the housing can define a first cylindrically concave side that can be contoured around the motor.

According to another aspect of the disclosure, a modular power converter can include a first power conversion unit and a second power conversion unit. The first power conversion unit can include a first power conversion module disposed within a first housing, which can define a first external recess. The second power conversion unit can include a second power conversion module disposed within a second housing, which can define a second external recess. The second housing can be configured to couple to the first housing so that the first external recess and the second external recess collectively define a first coolant channel between the first housing and the second housing.

According to yet another aspect of the disclosure, a modular power converter can include a plurality of power conversion units each having a first power conversion module disposed within a housing. The plurality of power conversion units can include a first power conversion unit, a second power conversion unit, and a plurality of third power conversion units. The plurality of third power conversion units can be arranged in a stacked configuration between the first power conversion unit and the second power conversion unit.

According to still another aspect of the disclosure, a power converter can include a housing. A first power conversion module can be disposed in the housing and can be configured to supply electrical power at a first maximum power level. A second power conversion module can be disposed in the housing and can be configured to supply electrical power at a second maximum power level. A bus bar can be secured between the first power conversion module and the second power conversion module so that the first power conversion module and the second power conversion module are in an opposed configuration about the bus bar.

According to yet another aspect of the disclosure, a power converter can include a housing defining a cooling path configured to receive a flow of a coolant, and a seat having an internal area that is in fluid communication with the cooling path. A power conversion module, which can include a power electronic component, can be received in the seat so that the coolant flows over the power electronic component.

According to yet another aspect of the disclosure, a bus bar assembly can include a first bar, a second bar spaced from the first conduction bar to define a gap therebetween, and a capacitor positioned within the gap and coupled to each of the first conduction bar and the second conduction bar.

According to yet another aspect of the disclosure, a power conversion module can include a circuit board, a power electronic component coupled to the circuit board, a cooling jacket surrounding the power electronic component, and a jacket housing coupled to the circuit board and covering the cooling jacket. The cooling jacket can define a coolant duct configured to receive a flow of coolant so that coolant can flow over the power electronic component.

According to yet another aspect of the disclosure, a thermal regulation system for a power conversion module that includes a power electronic component can include a cooling jacket configured to enclose the power electronic component. The cooling jacket can include a top jacket and a bottom jacket configured to couple to the top jacket. At least one of the top jacket and the bottom jacket can be shaped in accordance with the power electronic component to define a coolant duct between the cooling jacket and the power electronic component. The coolant duct can be configured to receive a flow of coolant.

According to yet another aspect of the disclosure, a power conversion module can include a core, a coil wound around the core, and a housing assembly coupled to at least one of the core and the coil. The thermal regulation system can further include an insert coupled to at least one of the core and the housing assembly, and the insert can define a coolant duct configured to receive a flow of coolant so that coolant can flow through the coil.

The foregoing and other aspects and advantages of the present disclosure will appear from the following description. In the description, reference is made to the accompanying drawings that form a part hereof, and in which there is shown by way of illustration one or more embodiment. These embodiments do not necessarily represent the full scope of the invention, however, and reference is therefore made to the claims and herein for interpreting the scope of the invention. Like reference numerals will be used to refer to like parts from Figure to Figure in the following description.

### BRIEF DESCRIPTION OF THE DRAWINGS

The invention will be better understood and features, aspects, and advantages other than those set forth above will become apparent when consideration is given to the following detailed description thereof. Such detailed description makes reference to the following drawings.

FIG. 1 is an exploded view of a drive unit, according to aspects of the present disclosure.

FIG. 2 is an isometric view of the drive unit of FIG. 1 with the housing removed to illustrate internal components thereof.

FIG. 3 is a partially exploded isometric view of the drive unit of FIG. 2.

FIG. 4 is a top view of the drive unit of FIG. 2.

FIG. 5 is a front view of a transmission housing of the drive unit of FIG. 1.

FIG. 6 is a front view of a gasket that is disposed between the transmission housing and the power converter housing when the drive unit of FIG. 1 is assembled.

FIG. 7 is a detail view of a first catch tray defined by the transmission housing of FIG. 5.

FIG. 8 is a detail view of a second catch tray defined by the transmission housing of FIG. 5 with the gasket depicted by phantom lines.

FIG. 9 is an isometric view of a power converter with a converter housing depicted by phantom lines to illustrate internal components of the power converter, according to aspects of the present disclosure.

FIG. 10 is a front view of the power converter of FIG. 8.

FIG. 11 is a schematic view of coolant channels defined by recesses in the power conversion unit of FIG. 10.

FIG. 12 is a front view of a power conversion unit of the power converter of FIG. 8.

FIG. 13 is an schematic of a power conversion unit including a coolant jet according to aspects of the present disclosure.

FIG. 14 is another schematic of a power conversion unit according to aspects of the present disclosure.

FIG. 15 is an isometric view of a power conversion module of the power conversion unit of FIG. 12.

FIG. 16 is a front view of a bus bar assembly according to aspects of the present disclosure.

FIG. 17 is a top view of the bus bar assembly of FIG. 16.

FIG. 18 is an partial isometric view of a first end of the bus bar assembly of FIG. 16.

FIG. 19 is an isometric view of another power conversion unit with power component cooling jackets according to aspects of the present disclosure.

FIG. 20 is an exploded view of a cooling jacket assembly according to aspects of the present disclosure.

FIG. 21 is an isometric view of the cooling jacket assembly of FIG. 20.

FIG. 22 is a top view of the cooling jacket assembly of FIG. 20.

FIG. 23 is a left side cross-sectional view of the cooling jacket assembly of FIG. 20 taken through line 23-23 of FIG. 22.

FIG. 24 is an isometric view of an inductor assembly according to aspects of the present disclosure.

FIG. 25 is a heat map of the inductor assembly of FIG. 24.

FIG. 26 is an isometric view of a core spacer of the cooling jacket assembly of FIG. 24.

FIG. 27 is an isometric view of another inductor assembly according to aspects of the present disclosure.

FIG. 28 is a perspective view of a coolant guide according to aspects of the present disclosure.

FIG. 29 is a cross sectional view of the inductor assembly of FIG. 27 taken through line 29-29 of FIG. 27 with a coolant guide disposed therein.

FIG. 30 is a cross sectional view of the inductor assembly of FIG. 26 taken through line 29-29 with another coolant guide disposed therein.

FIG. 31 is a perspective view of a core with cooling fins, according to aspects of the present disclosure.

FIG. 32 is a front, top, and left isometric view of a cooling fin for a power electronic component, according to aspects of the present disclosure.

FIG. 33 is a front, bottom, and left isometric view of the cooling fin of FIG. 32.

FIG. 34 is an isometric view of another cooling fin for a power electronic component, according to aspects of the present disclosure.

FIG. 35 is an isometric view of yet another cooling fin for a power electronic component, according to aspects of the present disclosure.

FIG. 36 is a cross-sectional view of the example heatsink of FIG. 35 taken through line 36-36 of FIG. 35.

FIG. 37 is a cross-sectional view of the example heatsink of FIG. 35 taken through line 37-37 of FIG. 34.

FIG. 38 is a cross-sectional view of the example heatsink of FIG. 35 taken through line 38-87 of FIG. 34.

FIG. 39 is an isometric view of the cooling fin of FIG. 35 including an outer shell.

FIG. 40 is a heat map showing coolant flow through the heat sink of FIG. 39.

FIG. 41 is a perspective view of a cooling jacket assembly enclosing a cooling fin, according to aspects of the present disclosure.

### DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

The term “about,” as used herein, refers to variations in the numerical quantity that may occur, for example, through typical measuring and manufacturing procedures used for articles of footwear or other articles of manufacture that may include embodiments of the disclosure herein; through inadvertent error in these procedures; through differences in the manufacture, source, or purity of the ingredients used to make the compositions or mixtures or carry out the methods; and the like. Throughout the disclosure, the terms “about” and “approximately” refer to a range of values ±5% of the numeric value that the term precedes.

As used herein, a vehicle or electric vehicle (EV) may refer to, for example, a passenger car, a commercial vehicle (e.g., bus, semitruck, etc.), an industrial vehicle (e.g., shovel, front loader, fork truck, etc.), an aerospace vehicle (e.g., an airplane, helicopter, etc.), or a marine craft (e.g., boat, submarine, etc.). In the context of an EV, a motor may be referred to as a propulsion motor configured to propel the EV. In the context of a land-based EV (e.g., passenger car, commercial vehicle, industrial vehicle), a motor may be referred to more specifically as a traction motor configured to propel the EV over land.

The following discussion is presented to enable a person skilled in the art to make and use embodiments of the invention. Various modifications to the illustrated embodiments will be readily apparent to those skilled in the art, and the generic principles herein can be applied to other embodiments and applications without departing from embodiments of the invention. Thus, embodiments of the invention are not intended to be limited to embodiments shown, but are to be accorded the widest scope consistent with the principles and features disclosed herein. The following detailed description is to be read with reference to the figures, in which like components or elements in different figures have like reference numerals. The figures, which are not necessarily to scale, depict selected embodiments and are not intended to limit the scope of embodiments of the invention. Skilled artisans will recognize the examples provided herein have many useful alternatives and fall within the scope of embodiments of the invention.

A highly efficient power converter is able to convert power (e.g., AC to DC, DC to AC, and/or DC to DC) without significant losses in energy. A low efficiency power converter experiences higher losses in energy during the power conversion. Such energy losses may manifest as heat generated by the power converter while converting power, for example. Power efficiency for a power converter, inductor, or other electronic component may be expressed as a percentage between 0 and 100% and determined based on the power input to the component and the power output from the component using the equation: Power Efficiency=(Power Out)/(Power In). A power converter with high power density has a high ratio of power output by the power converter compared to the physical space occupied by the power converter. The power density can be calculated using the equation: Power Density=(Power Out)/(Volume of Power Converter).

Applications, particularly advanced or modern applications, that include power electronics (e.g., IGBT, MOSFET, and GAN switches, etc.) and power converters (e.g., transformers, converters, inverters, etc.) benefit from an increase to the power density (or power per unit volume—or mass) of the power electronics and power converters. Effective thermal management is a tool to increase the power density of such systems where, by definition, more power is pushed through a given (or smaller) area. Traditional methods include air cooling, convective heat transfer using heat sinks, and indirect convection using coolants. These solutions, however, often provide inferior thermal management capability and limit increases in power density for existing power electronic and power converters. Disclosed herein are devices and methods for providing an increase in power density of such systems, offering an increase in power within the context of traditional devices beyond what is otherwise achievable.

Further, traditional systems that may utilize direct or indirect liquid cooling methods focus on increasing the flow rate of the liquid, which is often prohibitive (e.g., due to the increased pressures required) and limits the efficiency and/or viability of the method altogether not withstanding thermal limitations further discussed herein. Disclosed herein are devices and methods that overcome these shortcomings and enable improved power densities while maintaining overall system efficiency.

In addition, conventional power converter (e.g., inverter) systems typically require a circuit board with a large surface area to achieve adequate power output. Accordingly, a power converter is disposed on a large, substantially two-dimensional circuit board and away from a drive unit of a vehicle (e.g., in a different part of a vehicle). Conventional power converters are generally disposed linearly along a circuit board that is connected to a drive unit for the purpose of converting or transferring power to the drive unit. Circuit boards with large or linear surface areas are generally configured as such to provide for adequate cooling and to allow power converters to function efficiently.

However, the surface area of a circuit board drastically increases the space occupied by a power converter in or around a drive unit. This in turn can increase the amount of unused space within a drive unit, leading to increased manufacturing costs and large, but not powerful, drive unit sizes in electric vehicles. In addition, large circuit board surface areas are generally not capable of being modified after they have been installed in a power converter system. As a result, conventional power converter systems are relatively inflexible with regard to providing variable power input to a motor and generally must be installed in a location separate from the drive unit that they power. This, as well as the limitations associated with large circuit board surface areas, can lead to inefficient drive unit performance, increased manufacturing costs, and less compact drive systems (e.g., the combination of a drive unit and associated power converter).

Generally, the present disclosure provides systems for modular power converter systems that can be advantageously integrated with a drive unit. In some non-limiting examples, a modular power converter system may be configured as a power converter that can be modified in size according to a desired power output or in relation to other components of a drive unit. The power converter can be coupled to a motor and a transmission in a drive unit. For example, the power converter can be secured between a motor and a transmission within a compact drive unit to eliminate unused space therein. To that end, the power converter can be shaped according to the other components in the drive unit such as, for example, the motor or the transmission so that the power converter can fit inside the drive unit alongside or in between the motor or the transmission.

Because the power converter can be positioned within an empty portion of an envelope of the drive unit, the amount of unused space in a drive unit can be drastically reduced when compared to conventional drive units power converter systems, resulting in more compact and efficient packaging. Further, due to its modular construction, the power converter can be sized according to the power demands of a motor. For example, a power converter can be extendable as a size of the motor is increased, meaning that a size of the power converter can grow with the motor in order to meet the power demands of the motor. Thus, the power converter is capable of being modified as the motor is modified. In particular, one or more power conversion units can be added or removed from a power converter to modify the size thereof.

Correspondingly, a power conversion unit can include a plurality of power conversion modules (PCMs) within which individual power electronic components are arranged. In some cases, multiple PCMs can be coupled to a shared bus bar and arranged in a stacked configuration to more efficiently utilize the physical space available for power electronic components, which in turn, can increase the power density of the power converter. Accordingly, the arrangement of PCMs in a power conversion unit and the use of shared bus bars therebetween in combination with the modularity of the power converter can provide a more effective and more capable power converter system.

In some aspects, a power converter system that includes PCMs can include local electronic controllers for individual components of the power converter system and a master or central electronic controller for the overall converter system. In particular, an electronic controller can be configured to selectively operate one or more power conversion units, power conversion modules, and/or power electronic components in any combination in order to modulate the power output of a power converter. Further, local electronic controllers can be software controllers that are implemented using the same hardware as used for the master electronic controller (e.g., a global and/or central controller that is used to manage a plurality of local electronic controllers). In some aspects, individual elements of a power converter system can include integrated controllers, and communication between electronic controllers can be performed via a communications system which could include a DC bus, an Ethernet (ETH) protocol, a Controller Area Network (CAN) protocol, a Serial Peripheral Interface (SPI) protocol, or any other communications protocol implemented over a wired or wireless connection.

In some examples, a power converter system with PCMs includes a hierarchical control system comprising a central controller cascaded with one or more local controllers to provide, for example, resonance damping, improved dynamic performance, and/or leakage current attenuation capabilities. A hierarchical control system can improve the modularity of the components (e.g., easing the addition and removal of local controllers and corresponding PCMs). For example, the central controller can provide an outer loop of control, while each of the local controllers can provide a distinct inner loop of control. It is contemplated that the central controller may implement a proportional integral (PI) controller, a proportional integral derivative (PID) controller, or other regulating controller, that regulates the control for a power converter, or for individual PCMs of a power converter. As part of the outer loop of control, the central controller can generate control reference targets (e.g., three reference targets) based on the regulation in a rotating reference frame (e.g., a dqn reference frame). The control reference targets may be generated in a stationary (abc) reference frame. The central controller may translate between the stationary and rotating reference frame using the Clarke and Park transforms, and the inverse Clarke and Park transforms. Additionally, the central controller may provide the control reference targets to the local controllers. The local controllers may be configured to control one or more of N phases of the PCMs of the power converter, where the control of the N phases of the power converter is divided up among the local controllers. Thus, each phase of each PCM of the power converter may be associated with and controlled by a particular local controller. Each local controller may generate control signals (e.g., PWM signals) for each power switching element of the PCM(s) corresponding to that local controller, where the PWM signals have a duty cycle and/or frequency determined based on the control reference target received by that local controller. For example, the local controller may implement a PI algorithm, a PID algorithm, or the like, that receives the control reference target (e.g., a voltage or current reference for an output of the PCM) and a sensed characteristic of the PCM(s) corresponding to that control reference target (e.g., a sensed voltage or current at the output of the PCM), and generates the duty cycle to cause the sensed characteristics of the PCM(s) to trend towards the control reference target.

In addition, a shared cooling loop can be formed between each component of the drive unit (e.g., motor transmission, power convertor, etc.). This is different from conventional drive unit systems that use separate coolant paths and cooling mediums for each component therein to regulate the temperature of the various components and prevent overheating. These separate cooling loops and mediums generally require separate tubes, pipes, etc., to direct and transfer coolant mediums through components in a drive unit to facilitate heat transfer between the components and the coolant, thereby cooling the components of the drive unit. As a result, the overall design of a drive unit becomes more complex, and less space in a drive unit is available for the power generating components therein. Put another way, the use of multiple cooling loops that are not in fluid communication with one another increases the complexity of the design of the drive unit while also decreasing power output. Further, the use of extra parts (e.g., tubes, pipes, etc.) increases the size and cost of manufacture of the drive unit.

Accordingly, the present disclosure can provide systems and arrangements for a shared coolant path in an integrated drive unit that can be advantageously formed by components therein. In some non-limiting examples, a drive unit system may include a shared coolant loop that uses a shared cooling medium (e.g., an oil with dielectric properties) that cools a motor, a transmission, a power converter, another drive unit component, or any combination thereof. While each of the components can define a respective coolant path, each of the coolant paths can be in fluid communication with one another to collectively define a shared or integrated coolant path, meaning that coolant can flow between a motor, a transmission, a power converter, or any combination thereof. Additionally, a shared coolant path can include coolant channels that extend through the power converter, for example, that are formed between or around power conversion units in a power converter to provide cooling to the power electronic components therein. In other words, coolant channels can extend through the power converter between power conversion units, or housings thereof, that are stackable to form the power converter. The coolant channels in a power converter can be in fluid communication with one another to collectively form a fully integrated coolant path within a power converter.

Because the coolant path is a fully integrated coolant path, coolant can be re-used in multiple components and the number of separate coolant loops for each component in the drive unit can be reduced. Accordingly, the thermal efficiency of the drive unit can be increased.

In some aspects, thermal management devices and methods described herein for power electronics or power conversion devices provides a coolant (e.g., dielectric fluid, oil, automatic transmission fluid, or the like) stream in operation onto the device(s) with coolant jets that are part of the integrated coolant flow path through the drive unit. This in turn allows an impinged fluid to be recycled through multiple power electronics arranged within a power converter, thus reducing the amount of coolant needed to effectively regulate the power converter. As a result, the overall efficiency of the power converter is increased. Further, in some examples provided herein, coolant may be directed at the top and bottom of a device under cooling, or both, which is atypical of traditional cooling methods.

As discussed above, conventional thermal management systems that utilize cooling fins suffer from suboptimal designs that result in either ineffective cooling or decreased power converter output due to size constraints within a drive unit. In contrast, the thermal management devices and methods described herein provide cooling fins that increase the surface area for a given volume by using three-dimensional lattice structures. Increasing the surface area of a cooling fin can improve the exchange of thermal energy between the cooling fin and coolant, which in turn can enhance cooling of power electronic components within a power converter. Further a three-dimensional lattice structure cooling fin can provide a winding or tortuous path for coolant as it flows through the cooling fin, which can improve fluid mixing and promote turbulent flow to further improve cooling. Accordingly, implementing a cooling fin as a three-dimensional lattice structure can enhance cooling within a power converter, thus further improving the overall efficiency of the power converter.

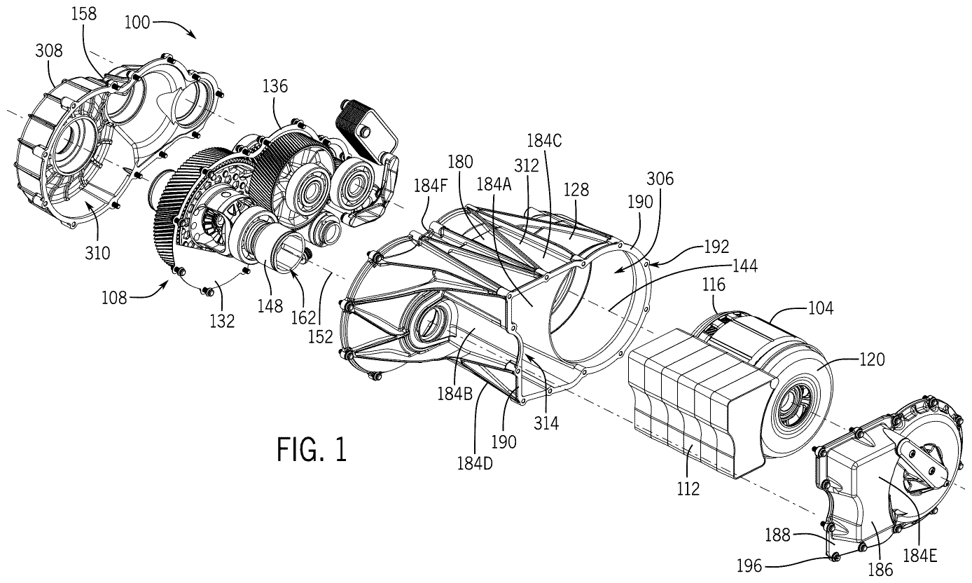

FIGS. 1-4 illustrate a drive unit according to aspects of the present disclosure. The drive unit may be configured as a drive unit for a vehicle such as, for example, an electric vehicle. A drive unit (e.g., a drive unit 100) is generally configured to transform electrical energy into mechanical energy or other forms of electrical energy. For example, a drive unit can transform electrical energy into rotational mechanical energy or torque that can be transferred to an actable or rotatable shaft. Accordingly, a drive unit can be configured to provide mechanical energy to an actuatable shaft such as, for example, a drive shaft that is coupled to one or more wheels to provide motive force to an electrical vehicle. Put another way, a drive unit can provide power to drive an electrical vehicle. In some aspects, multiple drive units can be utilized to drive an electrical vehicle, and drive units can be use separately or together (i.e., in communication with one another) to power an electrical vehicle. A drive unit can be configured as a single drive unit or plurality of drive units, including configurations such as, for example, a dual motor drive unit, a tri-motor drive unit, or another multiple motor drive unit. Drive units can be connected to one or more actuatable members in a vehicle and can be arranged at any position in a vehicle, such as, for example, along or adjacent to an actuatable member.

A drive unit can generally include components that are configured to convert electric potential energy into (rotational) kinetic energy, which can be used to do work. In particular, a drive unit can generally include an electric machine (e.g., a motor) configured to convert electrical energy into kinetic energy, a transmission to transfer kinetic energy from the motor to an actuated component (e.g., a drive shaft), and a power converter that can be configured to provide the electrical energy to the motor (e.g., at a desired power, current type, etc.). In the non-limiting example illustrated in FIGS. 1-4, the drive unit 100 includes a motor 104, a transmission 108, and a power converter 112. In some aspects, a drive unit can include a motor that is coupled to a transmission and a power converter. A motor can be an electric motor such as, for example, a permanent magnet synchronous motor, a direct current (DC) series motor, a brushless DC motor, a switched reluctance motor, an alternating current (AC) induction motor, or another type of motor. In some aspects, a motor can be a three-phase AC induction motor. A three-phase AC induction motor can be a field-wound synchronous machine. In some aspects, a three-phase induction motor can include a stator and a rotor, the rotor being rotatable within the stator to generate mechanical energy. In some aspects, a rotor is an electric machine or a linear actuator machine, and a stator is configured to wirelessly communicate with the electric machine.

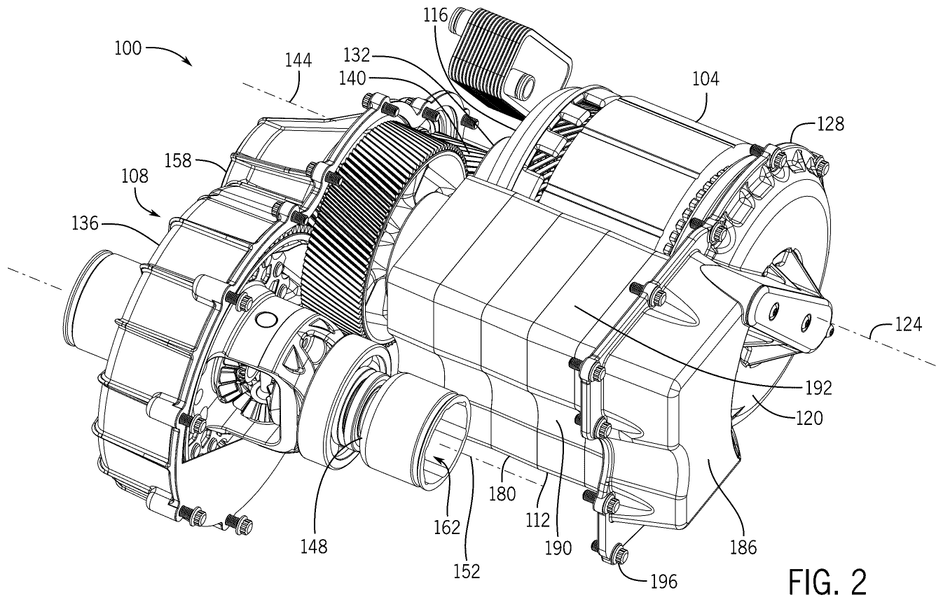

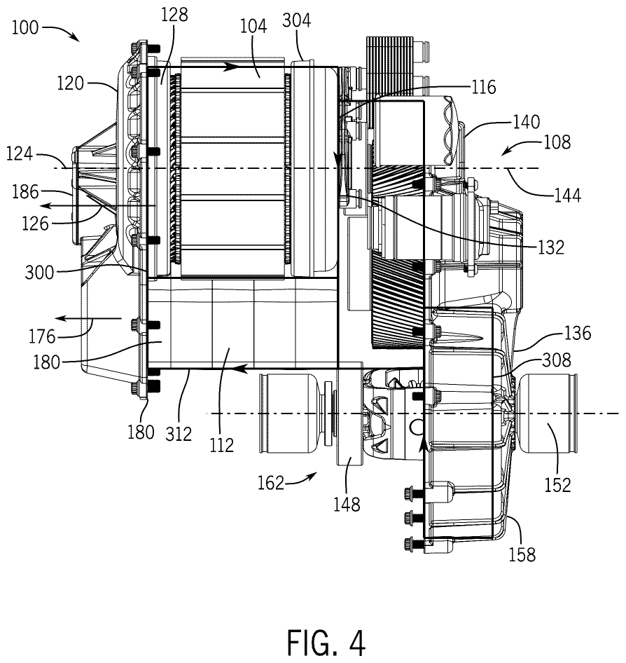

A motor can include a motor housing that extends between a first end and a second end, along a motor axis defined therebetween. A motor can be arranged in any shape such as, for example, a substantially cylindrical shape, a rectangular shape, or a triangular shape. A motor housing can generally extend or cover a motor to provide protection to the sensitive electrical components therein, as well as to couple the motor to other components in a drive unit. In the illustrated non-limiting example of FIGS. 2-4, the motor 104 extends between a first end 116 and a second end 120 that is opposite the first end 116. Accordingly, the motor 104 can extend along a motor centerline or axis 124 that is defined between the first end 116 and the second end 120, which can, for example, correspond with a rotational axis of a rotor. In some aspects, the motor 104 can extend along the motor axis 124 at any desired length as indicated by arrow 126 (see FIG. 4). In this way, the size of the motor 104 can be modified to achieve desired power characteristics for the drive unit 100. In the illustrated non-limiting example, the motor 104 is a substantially cylindrical motor, although it is contemplated that the motor 104 can be arranged in other shapes as well. The motor 104 can also include a motor housing 128 (see FIG. 1) that extends between the first end 116 and the second end 120 along the motor axis 124 and encases the motor 104.

As discussed above, a motor can be coupled to a transmission in a drive unit. A transmission can generally include components that are configured to transfer kinetic energy from a motor to an actuated component (e.g., a drive shaft). To that end, in the case of rotational kinetic energy, a transmission can control or modify and amount of torque and rotational speed that is transferred to the actuated component by the motor. In some aspects, a transmission can be a single-speed transmission, a continuously variable transmission, a multiple-gear transmission, a direct-shift or direct-drive transmission, or a manual transmission, an automatic transmission, or any combination thereof. A transmission can include an input and an output, the input being an input shaft and the output being an output shaft. In this way, a transmission can include an input that defines an input axis and an output that defines an output axis. An input can be coupled to a motor, and an output can be coupled to an actuatable or rotatable member such as, for example, a drive shaft. For example, an input can be coupled to a motor by clutch components or linear actuator members, and an output can be coupled to an actuatable member by a differential. A transmission can also include one or more gears, belts, bands, shafts, or valves that can be arranged to facilitate mechanical energy transfer across a transmission. Put another way, a transmission can include an input connected to a motor and an output connected to an actuatable member (e.g., an axle) to facilitate energy transfer from the motor to the actuatable member.

In the non-limiting example illustrated in FIGS. 1-3, the transmission 108 includes a first side 132 and a second side 136, the first side 132 being coupled to the first end 116 of the motor 104 and the second side 136 being opposite the first side 132. In some aspects, the first side 132 defines a plane along which the motor 104 and the transmission 108 are coupled. In other words, the motor 104 and the transmission 108 are coupled to one another at the first side 132 of the transmission 108. Specifically, the motor 104 can be operatively coupled or secured to the transmission 108 using fasteners (e.g., bolts, nuts, screws, tabs, or another type of fastener), or the motor 104 and the transmission 108 can be formed as a unitary construction. Additionally, the transmission 108 can be coupled to an actuatable member at the first side 132 or the second side 136, or the transmission 108 can be coupled to an actuatable member that extends through each side 132, 136 of the transmission 108.

In some aspects, the transmission 108 can also include an input 140 defining an input axis 144 and an output 148 defining an output axis 152 that can extend in a direction that is parallel to the input axis 144. In some aspects, the input axis 144 extends in a direction that is parallel to the motor axis 124, or the input axis 144 can extend along the motor axis 124 (i.e., the centerline of the motor 104) such that the input axis 144 and the motor axis 124 are coaxial. In this way, the input 140 can be arranged concentrically to the motor 104 such that the motor 104 can be coupled to the transmission 108 at the input 140 along the first side 132. In a similar way, the transmission 108 can be coupled to the actuatable member at the output 148 along the first side 132, the second side 136, or both the first side 132 and the second side 136. In the illustrated non-limiting axis, the output axis 152 is illustrated as extending in a direction that is parallel to the input axis 144, although it is contemplated that other configurations in which the output axis 152 is not parallel to the input axis 144 may also be used, such as, for example, configurations in which the output axis 152 is perpendicular to the input axis 144.

Referring now to FIG. 1, in some aspects, the transmission 108 can include a transmission housing 158 that extends around or covers any internal components of the transmission 108 (e.g., gears, actuators, clutches, etc.). The transmission housing 158 can secure the transmission 108 to the motor 104, the motor housing 128, or both using fasteners (e.g., bolts, nuts, screws, tabs, or another type of fastener), or the transmission housing 158 and the motor housing 128 can be formed as a unitary construction to secure the motor 104 to the transmission 108. The transmission housing 158 can completely envelop the transmission 108, or the transmission housing 158 can partially enclose the transmission 108. In particular, the transmission housing 158 can include an output aperture 162 through which the output 148 can extend. In the illustrated non-limiting example, the output aperture 162 is a substantially circular aperture, although it is contemplated that other shapes or sizes can be used for the output aperture 162. As will be discussed below in greater detail, the transmission 108 can include additional components that are configured to transfer power received by the motor 104 at the input 140 to the actuatable member at the output 148. In other examples, other methods for coupling a transmission to an actuatable member may be used.

In some examples, the components of the drive unit 100 are integrated into a single device (e.g., an EV). In this example, grid connection points or terminals of a grid may be integrated into the single device, while other portions of the grid are separate from the single device. In other examples, the components of the drive unit 100 are distributed between multiple devices. For example, the motor 104 and the transmission 108 may be integrated into the drive unit 100 within an EV, while the power converter 112 may be integrated into an electric vehicle supply equipment (EVSE) (e.g., a charging station). In this example, grid connection points or terminals of the grid may be integrated into the EVSE, while other portions of the grid may be separate.

Aspects of a power converter will now be described in greater detail. As discussed above, a power converter can be coupled to a motor, a transmission, or other components in a drive unit. A power converter can be a charger, an inverter, an AC-AC converter, an AC-DC converter, a DC-AC converter, a DC-DC converter, another type of converter, or any combination thereof. In some examples, a power converter can be used to rectify AC power from an AC grid power source to DC power for charging a battery, or inverting DC power from a battery to AC power to drive a motor or supply AC power to an AC grid. Moreover, a power converter may be provided as a networked power converter that provides multiple stages of power conversion. For example, the power converter may include a DC/DC conversion stage and an AC/DC conversion stage, and may operate bidirectionally. To implement multiple stages, certain modules of a power converter may be assigned to a DC/DC conversion stage (one or more DC/DC ACMs) and certain modules may be assigned to an AC/DC conversion stage (one or more AC/DC ACMs). Additional hardwired connections or selectively controllable contactors can provide a connection of the DC/DC modules to a high-voltage DC power supply, a connection between the DC/DC modules, and the AC/DC modules, and a connection of the AC/DC modules and an AC load or source (e.g., a motor and/or an AC grid).

Further, a power converter can generally be arranged adjacently to a motor, adjacently to a transmission, between a motor and a transmission, or in any position with a drive unit. In some aspects, a power converter can be coupled or secured to a motor, a transmission, or both using fasteners (e.g., bolts, nuts, screws, tabs, or another type of fastener). A power converter can also be dimensioned according to a motor or a transmission such that a power converter can be positioned between a motor and a transmission. In some aspects, a power converter can be arranged directly next to or contacting a motor and a transmission such that the power converter can be precisely contoured around a motor and a transmission. The power converter can include a power converter housing that encases the power converter and is secured to a motor or a transmission. As will be discussed below in greater detail, a power converter can be a modular or cascaded power converter that includes a plurality of individual power conversion units. Correspondingly, a power converter can be a scalable or modular power converter that can be extended to reach any desired length, which may, for example, correspond to a size or power output of a motor.

As mentioned above, a power converter can include a power converter housing that is dimensioned according to a shape of a motor or a transmission. A power converter housing can have a plurality of sides that may include planar, cylindrical, curved, concave, and convex sides, or any combination thereof, that are formed around a power converter and are also shaped to correspond to geometries of a motor, a transmission, an actuatable member, or another component in a drive unit.

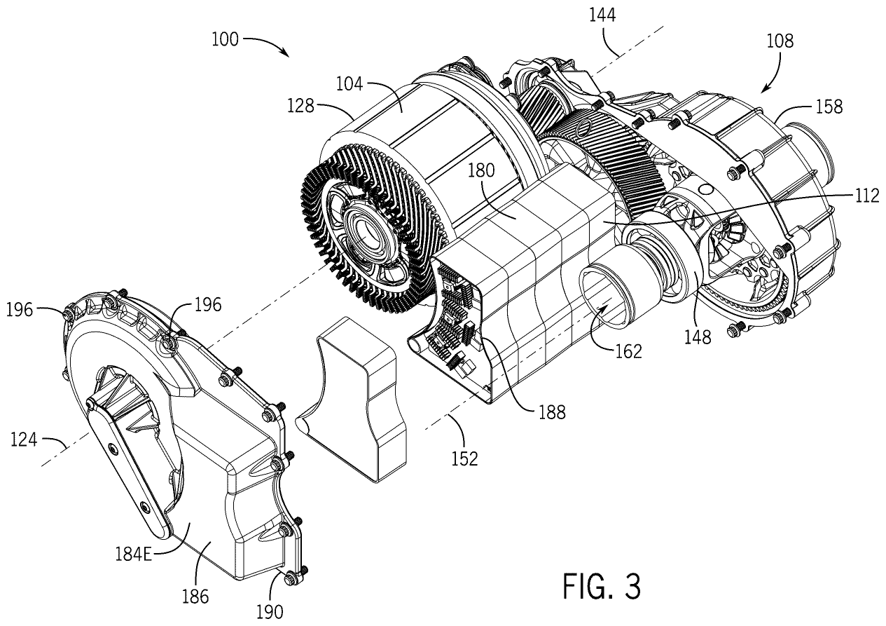

For example, with reference to FIG. 3, the power converter 112 can extend in a direction that is parallel to the motor axis 124 as indicated by arrow 176. Specifically, the power converter 112 can extend between from the first side 132 of the transmission 108 to the second end 120 of the motor 104 such that a length of the power converter 112 is similar to a length of the motor 104. Similar to the motor 104, the power converter 112 can extend in a direction indicated by the arrow 176 at any desired length (e.g., along the motor axis 124). In this way, the size of the power converter 112 can be modified to achieve desired power characteristics for the drive unit 100, while also remaining within a footprint of the drive unit 100. In some aspects, and as will be discussed in greater detail below, the power converter 112 can increase in size or length as a size or length of the motor 104 is increased. A relationship between the size of the motor 104 and the size of the power converter 112 can be characterized as linear, logarithmic, a step function, another type of function, or any combination thereof.

As illustrated in FIG. 1, the power converter can include a power converter housing 180 that surrounds a plurality of power conversion units as will be discussed below in greater detail. The power converter housing 180 can be secured to the motor 104, or, in some instances, the power converter housing 180 can be secured to the motor housing 128, the transmission housing 158, or both. The power converter housing 180 can be at least partially integrally formed with the motor housing 128, the transmission housing 158, or both such that the power converter housing 180, the motor housing 128, the transmission housing 158, or any combination thereof define a combined housing (i.e., the combined housing is a unitary component). Accordingly, the combined housing can envelop the motor 104, the transmission 108, the power converter 112, or any combination thereof.

In some aspects, the power converter housing 180 can include a plurality of sides 184. One or more of the sides 184 can be curved, cylindrical, or concavely shaped to partially surround a component of a drive unit (e.g., motor 104, the transmission 108, the output 148 of the transmission 108, the actuatable member, or any combination thereof). In particular, one or more of the sides 184 of the power converter housing 180 can be shaped to fit around, partially surround, and/or contact a first component of the drive unit 100 and a second component of the drive unit 100. In some aspects, the plurality of sides 184 of the power converter housing 180 can be specifically contoured according to the other components in the drive unit 100. At least one of the plurality of sides 184 can have a planar, curved, concave, or convex profile according to the shapes of the other components in the drive unit 100. For example, at least one of the plurality of sides 184 can have a cylindrically concave profile that corresponds to the substantially cylindrically shaped motor 104 such that the aforementioned side can at least partially surround the motor 104.

In some aspects, the plurality of sides 184 of the power converter housing 180 can include a first side 184A, a second side 184B, a third side 184C, a fourth side 184D, a fifth side 184E, and a sixth side 184F. In the illustrated non-limiting example, the first side 184A is a cylindrically concave side that is contoured around the motor housing 128 such that the first side 184A can be arranged concentrically with respect to the input axis 144. Further, the second side 184B can be a combination cylindrically concave and planar wall (i.e., the second side 184B can include both planar portions and cylindrically concavely shaped portions) such that the second side 184B is contoured around the output 148 and the actuatable member. Put another way, the second side 184B can be arranged concentrically with respect to the output axis 152. In this way, side profiles of the power converter housing 180 may correspond to shapes of the motor 104, the transmission 108, and the actuatable member. However, it is contemplated that the plurality of sides 184 can include other shapes that correspond to a shape or profile of the transmission 108, so as to remain within a footprint of the drive unit 100 (e.g., to not extend beyond a spatial envelope defined by, for example, the sides of transmission 108 and motor 104 in one or more directions). Specifically, the footprint of the drive unit 100 may be defined as the profile of the drive unit 100 when viewing the drive unit 100 directly down the motor axis 124. When viewed down the motor axis 124, the power converter 112 can be shaped as to remain within a footprint of the drive unit 100 such that it does not extend past profiles of the motor 104, the transmission 108, or both.

Now referring specifically to FIGS. 1-3, the power converter housing 180 will be discussed in greater detail. It will be understood that the housings 128, 158, 180 have been removed from FIGS. 2 and 3 to illustrate internal components of the motor 104, the transmission 108, and the power converter 112, respectively. The power converter housing 180 can include a removable housing lid 186 having a substantially planar profile with a flange 188 formed integrally therearound. A rim 190 of the power converter housing 180 can be defined by outward facing edges of the plurality of sides 184. The flange 188 can abut the rim 190 when the housing lid 186 is placed in contact with other sides of the power converter housing 180. In some aspects, the flange 188 and the rim 190 can include fastener recesses 192 disposed therein. Fasteners 196 can be inserted through the fastener recesses 192 to secure the flange 188 to the rim 190, thereby sealing the power converter housing 180 to entirely enclose the power converter 112 therein. As discussed above, the power converter housing 180 can be integrally formed with the motor housing 128, the transmission housing 158, or both. Accordingly, the housing lid 186 can be shaped to correspond to the motor housing 128, the transmission housing 158, the converter housing 180, or any combination thereof such that the housing lid 186 can cover one or more of the motor 104, the transmission 108, or the power converter 112 when secured to any of the housings 128, 158, 180. In some aspects, the flange 188 may be configured to receive the fasteners 196 therein to secure the housing lid 186 to any of the housings 128, 158, 180. It is contemplated that other methods of securing the housing lid 186 may also be used, such as, for example, hinges, latches, vacuum seals, another type of securing method, or any combination thereof.

There are several advantages of sizing the power converter 112 to correspond with shapes of other components in the drive unit 100 as discussed above. In particular, dimensioning the power converter 112 and the power converter housing 180 to correspond to the motor 104, the transmission 108, an actuatable member, or a combination thereof reduces overall size of the drive unit 100, which can lead to increased efficiency, decreased manufacturing cost, and enhanced power output. Shaping the power converter 112 to fit between the motor 104 and the transmission reduces wasted space in the drive unit 100, and the close proximity of the motor 104, the transmission 108, and the power converter 112 relative to one another provides a variety of shared energy and coolant path benefits as will be discussed in detail below.

While the non-limiting example illustrates the power converter 112 as being positioned between the motor 104 and the output 148, it is contemplated that other spatial arrangements may also be used. For example, the power converter 112 can be coupled to a side of either the motor 104 or the transmission 108, adjacently to one of the motor 104 and the transmission 108, separately from (i.e., not contacting) the motor 104 or the transmission 108, or any combination thereof.

It will be apparent to one of skill in the art that the above description is an example of a power converter arrangement in a drive unit and that a power converter can be configured in any desired shape or combination of shapes to fit around certain components in a drive unit for at least the purpose of reducing unused space therein. Accordingly, an advantage of the present disclosure is that a power converter can be configured to fit around other components in a drive unit to reduce the surface area of the power converter, thus providing a more compact power converter system and drive unit which can further increase drive unit efficiency while decreasing manufacturing cost.

In addition, integrated drive units can also provide for improved cooling arrangements that allow for a shared cooling paths between the various components of a drive unit, including for example, a transmission, motor, and power convertor. Coolant (i.e., a liquid or gaseous cooling medium) is generally used to regulate the temperature of different components therein, such as, for example, a drive unit. Any type of coolant can be used to regulate the temperature of a drive unit, such as, for example, dielectric fluid or oil, ethylene glycol-based coolants, propylene glycol-based coolants, hybrid organic acid technology coolants, inorganic acid technology coolants, organic acid technology coolants, or any combination thereof. Where a coolant is used to cool both mechanical and electrical systems, it can be advantageous to use a coolant with dielectric properties. In some case, cooling systems can also be configured for single-phase (e.g., gas or liquid cooling) or two-phase cooling (e.g., evaporating a liquid cooling medium).

A coolant path (e.g., a shared coolant path) may be a path or loop along which coolant flows through a drive unit (e.g., the drive unit 100) to regulate the temperature of one or more components therein. Put another way, coolant can be introduced to a drive unit to absorb heat from one or more components therein and maintain an optimal operating temperature (or range of operating temperatures) to prevent overheating of a drive unit. Any appropriate method of regulating the temperature of the drive unit may be used, such as, for example, liquid cooling, direct liquid cooling, air cooling, mixed phase cooling, two-phase cooling, or any combination thereof. In some aspects, a coolant path can be defined by a loop formed between a motor, a transmission, a power converter, another component, or any combination thereof. A coolant path can comprise any number of individual coolant paths that can be in fluid communication with one another to define a shared coolant path through the drive unit. In this way, a single coolant path can be used in a drive unit to streamline cooling and increase the thermal efficiency of the drive unit.

In the non-limiting example illustrated in FIGS. 1 and 4, a shared coolant path 300 can be defined by the motor 104, the transmission 108, the power converter 112, or any combination thereof. In some aspects, the motor 104 can define a first coolant path 304, the transmission 108 can define a second coolant path 308, and the power converter 112 can define a third coolant path 312. The first coolant path 304, the second coolant path 308, and the third coolant path 312 can be in fluid communication with one another in any combination to form the shared coolant path 300. In this way, the shared coolant path 300 can be formed as a single loop to streamline cooling of drive unit 100.

Specifically, a coolant (e.g., a dielectric oil, or other dielectric cooling medium) can be introduced to the shared coolant path 300 and, may flow through or between the motor 104, the transmission 108, the power converter 112, another component in the drive unit 100, or any combination thereof. For example, coolant may flow along the shared coolant path 300 from the transmission 108 to the power converter 112 and from the power converter 112 to the motor 104. It is contemplated that alternative coolant paths may be used, such as, for example, configurations in which coolant first flows to the power converter 112 the motor 104, or another component of the drive unit 100 before being introduced to the transmission 108.

The shared coolant path 300 can be formed by recesses, tubes, cooling lines, pipes, or any other means of transporting fluid along or through the drive unit 100 and any combination of components therein. For example, the shared coolant path 300 may be formed in recesses in the motor housing 128, the transmission housing 158, the converter housing 180, or any combination thereof. More specifically, the first coolant path 304 can be formed by recesses or by a first interior cavity 306 defined by the motor 104 or the motor housing 128 such that the first coolant path 304 is in fluid communication with internal components (e.g., a rotor, a stator, or both) of the motor 104 to regulate the temperature thereof. In a similar way, the second coolant path 308 can be formed by recesses or by an interior cavity 310 defined by the transmission 108 or the transmission housing 158 such that the second coolant path 308 is in fluid communication with internal components (i.e., gears, belts, bands, shafts, or valves) of the transmission 108 to regulate the temperature thereof. In such cases, the coolant can also act as a lubricated to simultaneously provide lubrication between any moving parts of the transmission 108. Additionally, the third coolant path 312 can be formed by recesses or by an interior cavity 314 defined by the power converter 112 or the power convert housing 180 such that the third coolant path 312 is in fluid communication with internal components of power converter 112, as will be described below in greater detail.

There are several advantages of arranging the shared coolant path 300 as a shared coolant path or loop between the motor 104, the transmission 108, the power converter 112, another component of the drive unit 100, or any combination thereof. In particular, use of a shared coolant path can simplify the design of the drive unit 100 by reducing the number of separate coolant paths or cooling mediums needed for each component. By using a single, shared coolant path and cooling medium, it may be possible to reduce the complexity of the drive unit 100, thereby increasing ease of manufacture, installation, and maintenance thereof. Correspondingly, the use of a shared coolant path can also lead to decreased costs to manufacture a drive unit since fewer components (e.g., tubes, hoses, valves, or other components of a coolant circuit) may be required to adequately regulate the temperature of the drive unit 100. Additionally, coolant can be shared between the motor 104, the transmission 108, the power converter 112, another component of the drive unit 100, or any combination thereof which can further decrease costs of manufacturing and enhance the thermal efficiency of the drive unit 100. This in turn can provide for more effective temperature regulation or heat management of the drive unit 100 and can improve performance, efficiency, and longevity for all components in the drive unit 100.

It will be apparent to one of skill in the art that the above description is an example of a shared coolant path in a drive unit and that a coolant path can be configured in any desired shape or along any desired route to travel through and regulate the temperature of any component in a drive unit. Accordingly, an advantage of the present disclosure is that a single coolant path can be configured to be a shared coolant path that travels through different components in a drive unit to increase the thermal efficiency thereof. In addition, designing a shared coolant path to be provided within different components of a drive unit may significantly reduce the number of parts required to adequately regulate the temperature of the drive unit which can further increase overall drive unit efficiency while decreasing manufacturing cost.

As discussed above, coolant can be used to regulate the temperature of a variety of components within a drive unit. In addition, coolant may be used to lubricate components within a drive unit to increase overall operational efficiency. For example, coolant may be introduced directly onto components that are enclosed within a transmission, (e.g., differential gears, axles, bearings, etc.) to cool and lubricate such components. However, direct introduction of coolant can lead to coolant accumulation or pooling within a cavity defined by a housing (e.g., within a gear cavity defined by the transmission, due to gravity). This in turn can cause components (e.g., gears) within the cavity to be submerged in coolant, which may increase drag on such components and thereby decrease efficiency and power output.

To prevent such coolant accumulation, a gasket, according to some aspects of the disclosure, can be positioned within a housing. In some examples, a housing can be a housing assembly that includes a first housing defining a first internal volume and a second housing defining a second internal volume. When the housing is assembled, the first housing can be configured to couple to the second housing so that the first internal volume is in communication with the second internal volume to form or define an internal volume (i.e., a combined volume) of the housing. Correspondingly, a gasket can advantageously be positioned between the first housing and the second housing to seal or separate the first internal volume from the second internal volume. For example, a gasket can be positioned along a bottom side of the housing to seal bottom regions or sections of the first and second internal volumes. Further, and a gasket can include an outer rim that wraps around a perimeter of first housing. Put another way, an outer rim can be a portion of the gasket that is positioned for sealing between two portions of a housing. In addition, a partition or wall can extend upward and/or inward from a section of the outer rim that extends along a bottom side of the housing, and the partition can span from a first section of the outer rim to a second section of the outer rim to form a wall/flange that extends into an internal cavity of a housing (e.g., a transmission housing). Further, one or more catch trays can be defined by a housing to passively receive coolant before it falls into an internal cavity of the housing, and the catch trays can direct (i.e., drain) coolant away from the internal cavity. That is, coolant that is flung against the housing (e.g., coolant that is picked up by teeth of gears and flung outward due to the centrifugal force provided by rotating the gears) can be guided by the catch trays to be directed to another section of the housing and/or drive unit.

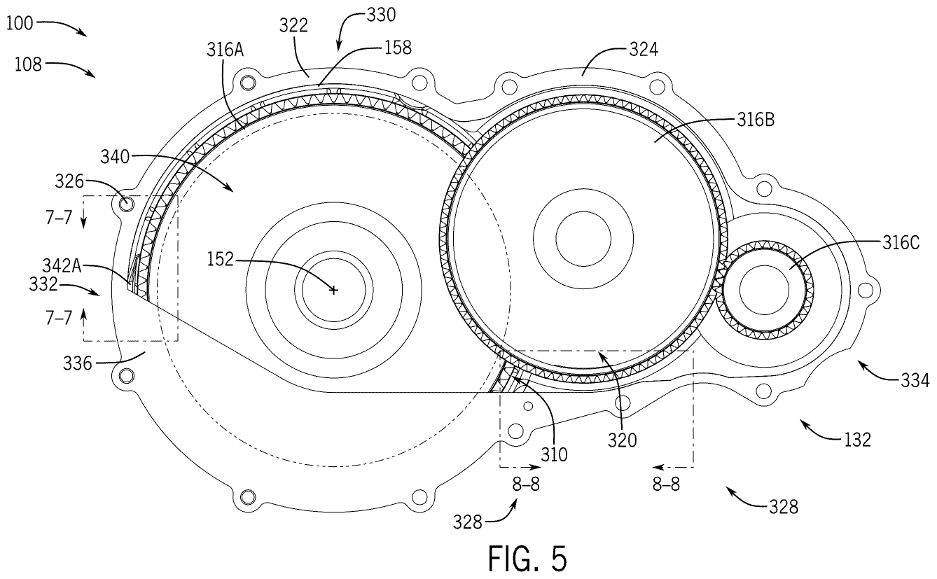

A gasket can be used to at least partially seal a cavity defined within a housing. Referring now to FIG. 5, and as discussed above, an example first housing (e.g., the transmission housing 158) can be used to cover a plurality of internal components, such as gears 316 (e.g., a first gear 316A, a second gear 316B, and a third gear 316C), clutches, actuators, etc. In some aspects, the gears 316 can be disposed within a first internal cavity, (e.g., the internal cavity 310 defined by the transmission housing 158, see FIG. 1). Further, the transmission 108 can include a gasket 322 that can wrap around a periphery of the internal cavity 310 to seal the internal cavity 310 from other sections of the transmission 108 and/or the drive unit 100. In particular, the gasket 322 can be positioned between a first housing (e.g., the transmission housing 158) defining a first internal volume and a second housing (e.g., the motor housing 128 and/or the power converter housing 180, see FIG. 1) defining a second internal volume. In this way, the gasket 322 can control a flow of coolant between the first internal volume and the second volume to, for example, prevent excessive coolant from accumulating within the internal cavity 310. Correspondingly, the gasket 322 can also prevent coolant from leaking out of the internal cavity 310 to allow components 316 disposed within the internal cavity 310 to be lubricated. Accordingly, the gasket 322 helps maintain a balance of coolant inside the internal cavity 310 by retaining a sufficient amount of coolant for lubrication while also preventing excess coolant from entering and submerging the components 316 disposed within the internal cavity 310. Further, the gasket 322 may define an outer rim 324 that extends around a perimeter of the internal cavity 310. The outer rim 324 is configured to be positioned between housing portions (e.g., a cover and a main housing, two halves of a housing, etc.). More specifically, the gasket 322 can be compressed between the first and second housings (e.g., the transmission housing 158 and the power converter housing 180, see FIG. 1) to seal therebetween. The outer rim 324 can be shaped in accordance with a sealing surface of the housing (e.g., the transmission housing 158). In some examples, the outer rim 324 may define one or more concave curves and/or inflection points to correspond to the circular profile of the gears 316. In addition, the gasket 322 can be secured to the transmission 108 by a plurality of fasteners 326 that are distributed around the outer rim 324 (i.e., disposed around a perimeter of the internal cavity 310), which when tightened, can compress the outer rim 324 of the gasket 322. It is contemplated that a gasket may be formed of any suitable material, such as, for example, rubber, silicone, aluminum, polyurethane, paper, cork, steel, and/or any combination thereof.

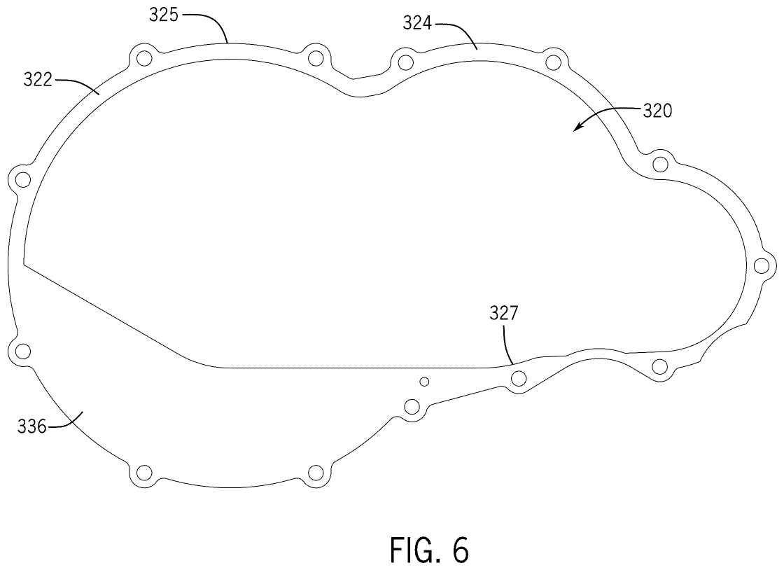

Moreover, referring now to FIGS. 5 and 6, the outer rim 324 defines an outer peripheral edge 325 corresponding to an exterior of the gasket 322 (e.g., a surface of the gasket 322 that is exposed to an exterior of the drive unit 100, see FIG. 1) and an inner peripheral edge 327 corresponding to an interior of the gasket 322. The region between the outer peripheral edge 325 and the inner peripheral edge 327 is configured to be positioned between a first housing and a second housing (e.g., transmission and power converter housings). The inner edge 327 can be exposed to the internal cavity 310 and can bound a perimeter thereof. Put another way, the inner edge 327 can bound an internal area 320 of the gasket 322.

Further, the gasket 322 can include a wall 336 that is formed as a unitary component with the outer rim 324 and that at least partially separates the internal cavity 310 from other sections of the housing. It is contemplated that the wall 336 can be implemented using a variety of suitable shapes and/or dimensions in order to at least partially seal the internal cavity 310. In some examples, the wall 336 can extend from the inner edge 327 of the outer rim 324 into the internal area 320 to reduce a portion of the internal cavity 310 that is “open” (i.e., a portion of the internal cavity 310 that is in direct fluid communication with other components of the drive unit 100, see FIG. 1). In some cases, the wall 336 may be formed as a flange that extends into the internal area 320 bounded by the inner edge 327. In other cases, such as the non-limiting example illustrated in FIG. 5, the wall 336 can span across the internal area 320 from a first section of the outer rim 324 to a second section of the outer rim 324. The first section and the second section can be spaced from one another or angled relative to one another (e.g., the first section can be positioned at a non-zero angle relative to the second section).

In some cases, a gasket can include multiple walls that extend into the internal area 320 from the inner edge 327 at a first section of the outer rim 324. That is, the wall 336 can span between different sections of the inner peripheral edge 327 of the outer rim 324 (i.e., between a first point disposed along a first section of the inner peripheral edge 327 and a second point disposed along a second section of the inner peripheral edge). Thus, the wall 336 may occupy or cover a portion of the internal area 320 bounded by the outer rim 324. In some examples, the wall 336 defines a wall area that is between about 5% and about 50% of the internal area 320, or between about 5% and about 25% of the area 320, or between about 5% and about 15% of the internal area 320, or about 12% of the internal area 320, or at least 5% of the internal area 320, or at least 2% of the internal area 320, or less than 5% of the internal area 320.

As discussed above, coolant flow through a transmission of a drive unit provides a multitude of benefits, such as temperature regulation and lubrication of gears to reduce friction therebetween, which in turn can enhance overall transmission efficiency. However, due to the force of gravity, coolant may be directed toward a bottom end of the transmission after it has been used to cool and/or lubricate the gears. With continued reference to FIG. 5, the transmission 108 defines a first end 328 (e.g., a bottom end), a second end 330 (e.g., a top end) opposite the first end 328, a third or lateral end 332, and a fourth or medial end 334 opposite the third end 332. Thus, the internal cavity 310 can be generally enclosed by the first, second, third, and fourth ends 328, 330, 332, 334 of the transmission 108. Correspondingly, it will be understood that gravity may cause coolant that enters the internal cavity 310 to flow toward the first end 328 of the transmission 108.

In the non-limiting example illustrated in FIGS. 5 and 6, the wall 336 can extend between the first end 328 and the third end 332 of the transmission 108 to at least partially cover the internal cavity 310. Put another way, the wall 336 can extend upward (i.e., inward toward the output axis 152 from a first section of the outer rim 324 that extends along the first end 328 of the transmission 108, and laterally toward the third end 332 of the transmission 108 along a second section of the outer rim 324. In some examples, the wall 336 is configured to cover a portion of a second area 340 defined by the first gear 316A (e.g., the largest differential gear in the transmission). As illustrated in the non-limiting example of FIG. 5, the first gear 316A is disposed farther toward the first end 328 of the transmission 108 than the second gear 316B or the third gear 316C. Correspondingly, the wall 336 is configured to cover a portion of the first gear 316A to prevent excessive coolant from entering the internal cavity 310 and partially submerging the first gear 316A. For example, the wall 336 may define a wall area that is between 10% and about 50% of the second area 340 defined by the first gear 316A, or between about 15% and about 40% of the second area 340 defined by the first gear 316A, or between about 20% and about 35% of the second area 340 defined by the first gear 316A, or about 30% of the second area 340 defined by the first gear 316A. In some examples, the wall 336 is contoured around the output 148 that extends along the output axis 152 (see FIG. 2).

Further, the wall of the gasket can be used in combination with catch trays defined by the transmission housing to direct coolant away from the gear cavity. In some aspects, coolant that is intentionally provided to a gear cavity to cool and/or lubricate gears disposed therein may be picked up by teeth of the gears and flung outward toward the transmission housing due to the centrifugal force provided by rotating the gears. The coolant may then flow downward along the transmission housing due to gravity before again reaching the bottom end of the transmission and being picked by teeth of the gears. This cycle can be used to advantageously cool and re-lubricate the gears during operation of the transmission, although excessive accumulation of coolant within the gear cavity can impede gear rotation and lead to decreased efficiency. To prevent such accumulation, the teeth of the gears can also fling coolant out of the cavity. For example, the teeth of the gears can fling coolant over the wall of the flange, or toward recesses and/or protrusions formed in the housing that define coolant catch trays, which are configured to intercept coolant running along the transmission housing and re-direct such coolant away from or out of the gear cavity.

Referring now to FIG. 5, a front view of the transmission 108 is illustrated with the first gear 316A depicted by shadow lines. As discussed above, the first gear 316A can be disposed within the internal cavity 310 that is defined, in part, by the transmission housing 158, and the wall 336 of the gasket 322 can be disposed along the front or first side 132 of the transmission 108. That is, the wall 336 can be disposed in front of the first gear 316A (i.e., in a direction that is measured along the output axis 152). In this way, the wall 336 can partially enclose the internal cavity 310, and/or the first gear 316A along the first end 328 of the transmission 108. In addition, one or more catch trays 342 can be formed by the transmission housing 158. For example, the transmission housing 158 can define a first catch tray 342A that is formed as a protrusion along the third end 332 of the transmission 108 and a second catch tray 342B that is formed as a recess along the first end 328 of the transmission 108.

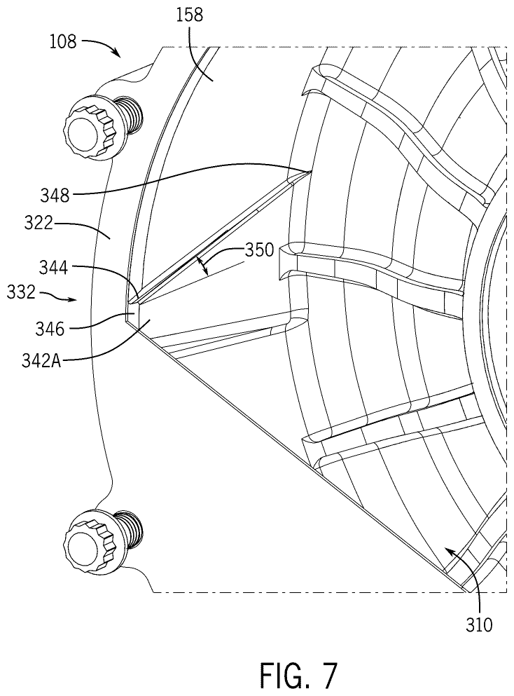

Referring now to FIG. 7, a detail view is illustrated of the first catch tray 342A that can be formed along the third end 332 of the transmission 108. In some aspects, the first catch tray 342A can be unitary with the transmission housing 158 and may be formed as a protrusion that extends inwardly therefrom, as discussed above. Further, the first catch tray 342A may be positioned at least partially above the wall 336 so that coolant can flow along the first catch tray 342A, over the wall 336, and out of the internal cavity 310. That is, the first catch tray 342A can guide a flow of coolant over the wall 336 from a first internal volume (e.g., the first internal cavity 310 defined by the transmission housing 158) to a second internal volume (e.g., internal cavity 314 defined by the power converter housing 180, see FIG. 1). To accomplish this, the first catch tray 342A can define a trough 344 that catches or collects coolant and directs flow over the wall 336. The trough 344 can be configured to direct coolant in a forward direction (i.e., toward the first side 132 (see FIG. 5) of the transmission 108). Specifically, the trough 344 may define an angled or “V”-profile when viewed from the front that prevents coolant from falling back into the first internal cavity 310 as the coolant is directed into the second internal cavity 314 (see FIG. 1). Moreover, the first catch tray 342A can define a first or forward end 346 and a second or rear end 348, and the first end 346 of the first catch tray 342A can be positioned above the wall 336 at the third end 332 of the transmission 108. Put another way, the first end 346 of the first catch tray 342A can be located along the inner peripheral edge 327 of the gasket 322 while the second end 348 can be positioned along the second side 136 (see FIG. 4) of the transmission 108. In some examples, the trough 344 is wider at the first end 346 than at the second end 348.

Correspondingly, the first catch tray 342A may be angled downward toward the wall 336 from the second side 136 (see FIG. 4) of the transmission 108. Put another way, the first end 346 of the first catch tray 342A may be disposed at a lower height along the transmission 108 (i.e., a lower position taken along a perpendicular direction with respect to the output axis 152, see FIG. 5) than the second end 346 of the first catch tray 342A. For example, the trough 344 may be disposed on an angle 350 that is measured between the trough 344 and a line that is parallel to the output axis 152 (see FIG. 5). In some examples, the angle 350 is between about 5 degrees and about 60 degrees, or between about 15 degrees and about 45 degrees, or between about 25 degrees and about 30 degrees, or about 30 degrees. Thus, coolant that flows into the first catch tray 342A can flow downward along the trough 344 due to gravity before flowing over the wall 336 and out of the internal cavity 310. In this way, the first catch tray can passively prevent excessive coolant accumulation within the gear cavity.

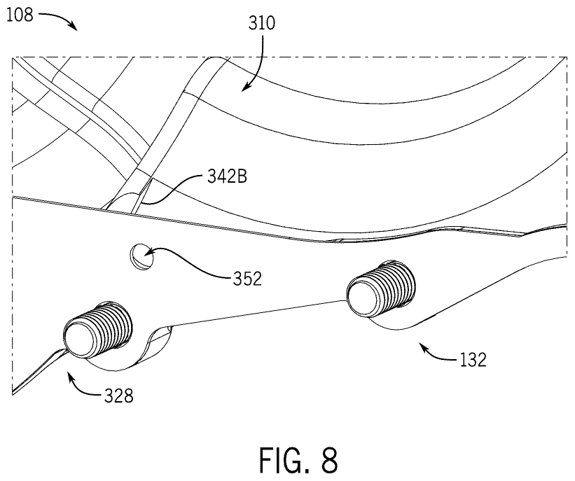

Relatedly, the second catch tray can further prevent pooling in the gear cavity by serving, for example, as a drain that directs excessive coolant out of the gear cavity. Referring now to FIG. 8, a detail view is illustrated of the second catch tray 342B that is formed as a recess or trough along the first end 328 of the transmission 108. In some aspects, the second catch tray 342B is configured to block fluid from reaching a rear-most point of the internal cavity 310 and/or drain any coolant captured therein out of the internal cavity 310 (e.g., out toward the first side 132 (see FIG. 4) of the transmission 108). For example, the second catch tray 342B may be provided as substantially concave recess or trough to collect a flow of coolant. Further the wall 336 of the gasket 322 can span the second catch tray 342, and the wall 336 can include an aperture or opening 352 (e.g., a check or one-way valve) that extends therethrough to meter coolant flow out of the internal cavity 310. Put another way, the opening 352 can control a flow of coolant from a first internal volume to a second internal volume. However, in some examples, the second catch tray 342B may be formed by a differently shaped recess that is capable of draining coolant without using an aperture.

There are several advantages of arranging a gasket within a transmission to at least partially seal a gear cavity formed therein from other regions of the transmission. In particular, sealing a bottom end of a gear cavity can prevent coolant from pooling in a gear cavity to ensure that components of a transmission (e.g., gears) do not become submerged in coolant. This in turn can enhance the efficiency of a transmission and, for example, decrease drag on the gears disposed within the transmission. Moreover, the use of catch trays can direct excessive coolant out of the gear cavity to further prevent excessive coolant accumulation within the gear cavity. In this way, more efficient transmission operation can be achieved. Correspondingly, the use of a gasket and catch trays such as those discussed above can also lead to decreased maintenance and/or repair costs in comparison with conventional drive units, as reducing coolant accumulation within a transmission may increase the longevity of components (e.g., gears, shafts, bearings, etc.) therein. As a result, overall drive unit performance, efficiency, and longevity can be enhanced.

It will be apparent to one of skill in the art that the above description is an example of a transmission, and that a transmission can be configured in any desired shape or combination of shapes to direct coolant therethrough for at least the purpose of improving thermal regulation while preventing excessive coolant accumulation. Accordingly, an advantage of the present disclosure is that a gasket can be coupled to a transmission housing, which include catch trays formed therein to direct coolant out of a gear cavity of the transmission housing, thus providing a more thermally efficient transmission system which can further increase overall drive unit efficiency. Accordingly, gaskets described herein can also be used in different applications.

Relatedly, a modular power converter according to the disclosure can be arranged to provide coolant channels (e.g., internal coolant paths) to efficiently cool power electronic components therein. As discussed above, a power converter (e.g., the power converter 112) can be a scalable or modular power converter that can be extended to reach any desired length which may correspond to a size or power output of a motor. A power converter can include one or more power conversion units that can be coupled to one another to form the power converter. In some aspects, one or more power conversion units can be stackable with one another to form the power convertor. For example, a plurality of power conversion units can include a top or first power conversion unit, a bottom or second power conversion unit, and one or more third power conversion units (e.g., a plurality of third power conversion units) that are coupled to one another to form a power converter. In some aspects, one or more third power conversion units can be sandwiched between a first power conversion unit and a second power conversion unit.

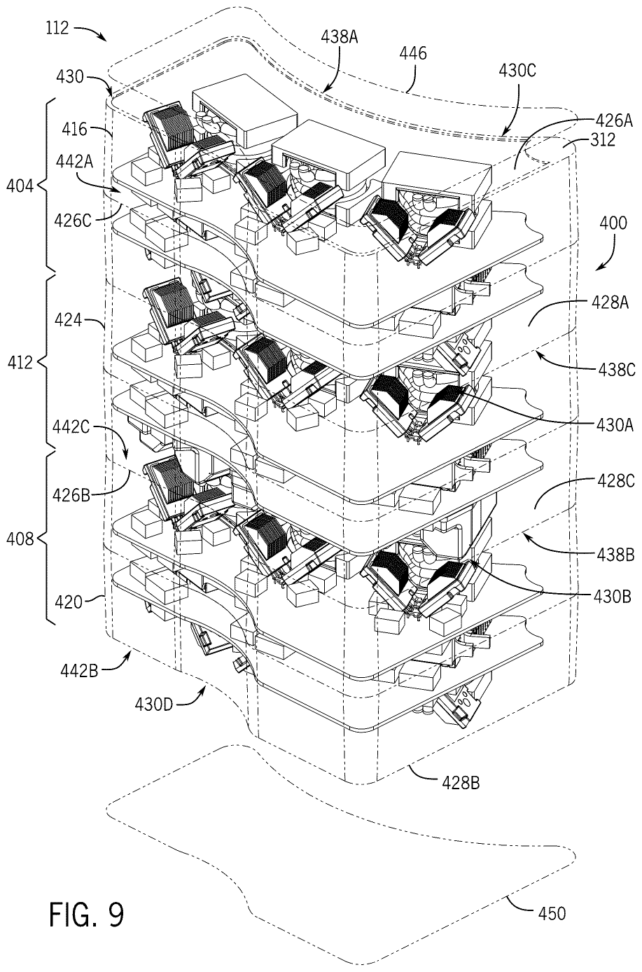

In the non-limiting example illustrated in FIGS. 9-12, the power converter 112 is configured as a modular power converter that includes a plurality of power conversion units 400. As illustrated, the plurality of power conversion units 400 is arranged in a stacked configuration, which includes a top or first power conversion unit 404, a bottom or second power conversion unit 408, and a plurality of third power conversion units 412 arranged between the first power conversion unit 404 and the second power conversion unit 408. That is, one or more third power conversion units 412 can be sandwiched between the first power conversion unit 404 and the second power conversion unit 408. It will be understood that any features or aspects of the first power conversion unit 404, the second power conversion unit 408, and the third power conversion unit 412 described herein are applicable to any power conversion unit. Additionally, while only three power conversion units 404, 408, 412 are illustrated in the non-limiting example, it is contemplated that any number of power conversion units may be used in the power converter 112 to achieve desired power characteristics for the drive unit 100 (see FIG. 1). In particular, the third power conversion unit 412 can be one of a plurality of third power conversion units 412.

The plurality of power conversion units 400 can be contained within the power converter housing 180 (see FIG. 1) such that the power converter housing 180 (see FIG. 1) fully surrounds the plurality of power conversion units 400. Each of the power conversion units 404, 408, 412 can include and be defined by a respective housing, such that the first power conversion unit 404 can be surrounded by a first unit housing 416, the second power conversion unit 408 can be surrounded by a second unit housing 420, and the third power conversion unit 412 can be surrounded by a third unit housing 424.

In some aspects, the power conversion units 404, 408, 412 and their respective unit housings 416, 420, 424 can be similarly shaped to correspond to a shape of the power converter housing 180 (i.e., shaped to correspond to geometries of the motor 104, a transmission 108, an actuatable member (e.g., an axle), or another component in a drive unit) (see e.g., FIG. 1). In particular, the plurality of power conversion units can be shaped to fit around, partially surround, or contact a first component of the drive unit 100 and a second component of the drive unit 100. In some aspects, the plurality of power conversion units 400 can be specifically contoured according to the other components in the drive unit 100. For example, a profile of the plurality of power conversion units 400 can include planar, curved, concave, or convex sides according to the shapes of the other components in the drive unit 100. In particular, at least one side of the profile of the plurality of power conversion units 400 can have a cylindrically concave side that corresponds to the substantially cylindrically shaped motor 104 such that the aforementioned side can at least partially surround the motor 104.

Correspondingly, coolant channels can be defined between power conversion units that are coupled together to provide coolant flow therebetween. Specifically, a housing for a power conversion unit can be shaped to at least partially define a coolant channel within the power convertor (e.g., a portion of the third coolant path 312). When arranged in a stacked configuration, two adjacent power conversion units can be coupled to form a coolant path therebetween. Thus, in some cases, recesses of adjacent power conversion units can define lateral halves of a shared coolant path. In other non-limiting examples, coolant paths can be formed in other ways.

In some aspects, a power conversion unit (e.g., a housing thereof) can have a first side (e.g., a top side) and an opposing second side (e.g., a bottom side), and coolant paths can be formed between pairs of opposing power conversion units when stacked. For example, a first power conversion unit can be stacked on a second power conversion unit, with a second side of a first power conversion unit can be coupled to a first side of a second power conversion unit. In this way, the second side of the first power conversion unit can define a first lateral half of a coolant channel, and the first side of the second power conversion unit can define a second lateral of the coolant channel. When the first power conversion unit is coupled with the second power conversion unit, the lateral halves can combine to collectively form a coolant channel between the power conversion units. Other power conversion units may also be used to form coolant channels.

Correspondingly, in some cases, a plurality of power conversion units can include a third conversion unit that can be coupled to a first power conversion unit and a second power conversion unit. Specifically, a third power conversion unit can be sandwiched between a first power conversion unit and a second power conversion unit. A third power conversion unit can include a first side and an opposing second side. In some cases, a first power conversion unit can be stacked on a third power conversion unit, meaning that a second side of a first power conversion unit can be coupled to a first side of a third power conversion unit. Correspondingly, the third power conversion unit can be stacked on a second power conversion unit, with a second side of the third power conversion unit can be coupled to a second side of the second power conversion unit. In this way, cooling channels can be formed between the first and third power conversion units, and between the third and second power conversion units. In some cases, a plurality of third power conversion units can be coupled between the first and second power conversion units and addition cooling channels can be formed between each pair of the third power conversion units.

To that end, still referring to FIGS. 9-12, coolant channels can be defined between each of the power conversion units 404, 408, 412. In particular, the coolant channels can be defined between pairs of the power conversion units 404, 408, 412 that are coupled to one another. More specifically, coolant channels can be defined between the first and third power conversion units 404, 412 as well as between the second and third power conversion units 408, 412.

To form the coolant channels, each of the power conversion units 404, 408, 412 can have a top or first side 426 and a bottom or second side 428 (e.g., the first power conversion unit 404 can have first and second sides 426A, 428A, the second power conversion unit 408 can have first and second sides 426B, 428B, and the third power conversion unit 412 can have first and second sides 426C, 428C, respectively). When arranged in a stacked configuration, the second side 428A of the first power conversion unit 404 can be coupled to the first side 426C of the third power conversion unit 412, and the second side 428C of the third power conversion unit 412 can be coupled to the first side 426B of the second power conversion unit 408. Accordingly, coolant channels 430 can be formed at interfaces of the coupled power conversion units to provide flow paths through which coolant can flow to regulate the temperature of the power conversion units 404, 408, 412.

In some aspects, the coolant channels 430 can be in fluid communication with one another and the third coolant path 312. In this way, the shared coolant path 300 can include the coolant channels 430, meaning that the third coolant path 312 and the coolant channels 430 are part of the shared coolant path 300 of the drive unit 100 (see FIG. 4).

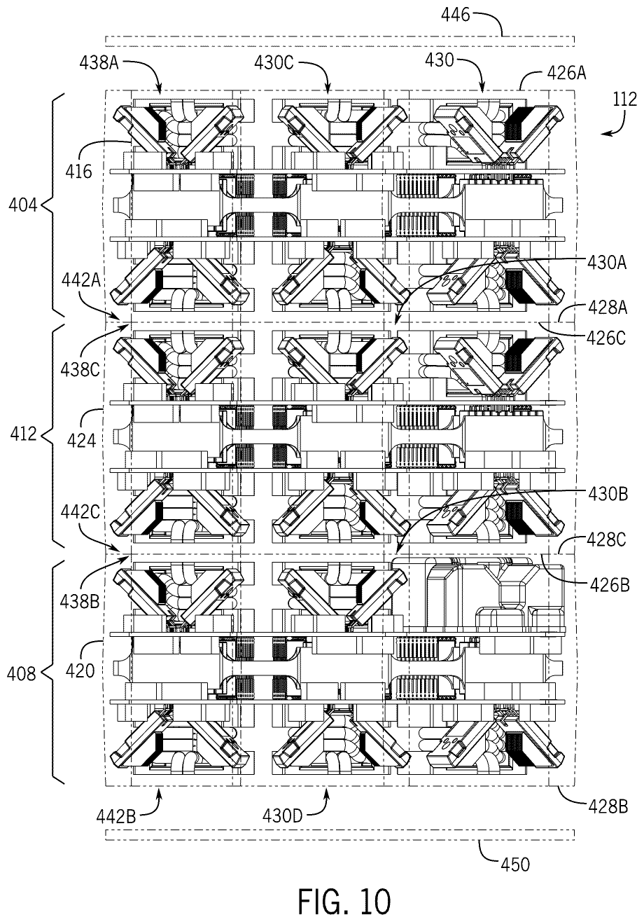

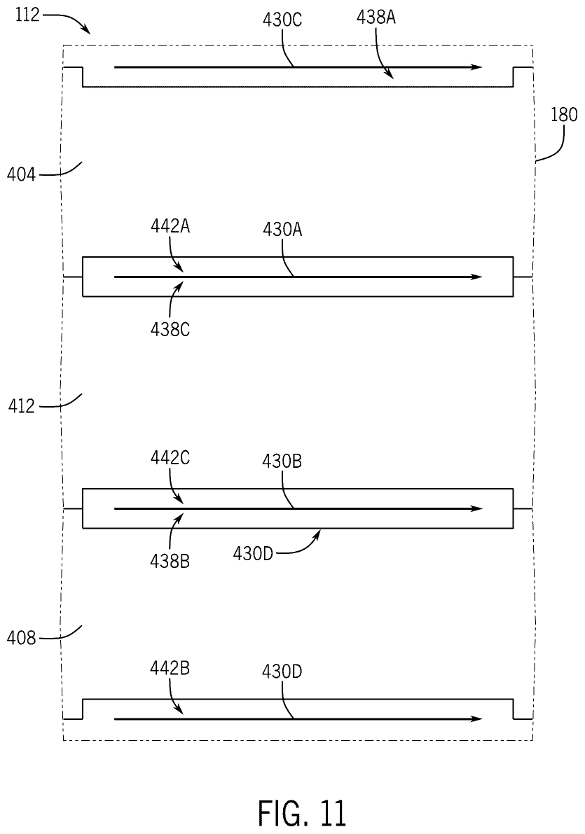

Coolant channels can be defined by external recesses disposed in a power conversion unit (e.g., the first power conversion unit 404) or a corresponding unit housing (e.g., the first unit housing 416) thereof. An external recess can be formed in any shape, such as, for example, cylindrical recesses, rectangular recesses, curved recesses, another shape, or any combination thereof. Additionally, it is contemplated that any number of external recesses may be used with any number of power conversion units to form the coolant channels. In the non-limiting example illustrated in FIGS. 10 and 11, a top or first external recess 438A can be disposed on the first side 426A of the first power conversion unit 404, and a bottom or second external recess 442A can be disposed on the second side 428A of the first power conversion unit 404. Put another way, the first external recess 438A can be opposite the second external recess 442A on the first power conversion unit 404.

Similar recesses can also be provided in the second power conversion unit 408 and the third power conversion unit 412. For example, with particular reference to FIGS. 9-11, the second power conversion unit 408 can include first and second external recesses 438B, 442B, and the third power conversion unit 412 can include first and second external recesses 438C, 442C. For example, the first external recess 438B can be disposed on the first side 426B of the second power conversion unit 408, and the second external recess 442B can be disposed on the second side 428B of the second power conversion unit 408. Correspondingly, the first external recess 438C can be disposed on the first side 426C of the third power conversion unit 412, and the second external recess 442C can be disposed on the second side 428C of the third power conversion unit 412.

In some aspects, external recesses can be aligned with one another when the power conversion units are coupled with one another. In this way, coolant channels can be formed between power conversion units that are coupled to one another. For example, the first power conversion unit 404 can be coupled to the third power conversion unit 412 so that the second external recess 442A of the first power conversion unit 404 is aligned with the first external recess 438C of the third power conversion unit 412, thereby forming a first coolant channel 430A. In this way, the second external recess 442A of the first power conversion unit 404 and the first external recess 438C of the third power conversion unit 412 can each define lateral halves of the first coolant channel 430A such that the first coolant channel 430A is fully defined when the first power conversion unit 404 is coupled to the third power conversion unit 412.

In a similar way, the second power conversion unit 408 can be coupled to the third power conversion unit 412 so that the second external recess 442C of the third power conversion unit 412 can be aligned with the first external recess 438B of the second power conversion unit 408, thereby forming a second coolant channel 430B. Accordingly, the second external recess 442C of the third power conversion unit 412 and the first external recess 438B of the second power conversion unit 408 each define lateral halves of the second coolant channel 430B such that the second coolant channel 430B is fully defined when the second power conversion unit 408 is coupled to the third power conversion unit 412.

However, it is contemplated that the arrangements of the power conversion units 404, 408, 412 relative to one another are example arrangements, and that the power conversion units 404, 408, 412 can be arranged, stacked, or coupled to one another in other arrangements to define the coolant channels 430. For example, coupling the power conversion units 404, 408, 412 to one another can include stacking the power conversion units 404, 408, 412 on top of one another, to the side of one another, in direct contact with another, in another arrangement, or any combination thereof.

In some aspects, a power converter a can include additional components to further define coolant channels therein. In particular, a power converter unit positioned at an end of a power converter may define an external recess (e.g., a portion of a cooling channel) that is exposed and not enclosed by another power convertor unit. To allow for coolant flow in the exposed cooling channel, a cover can be provided, which can be configured to enclose the cooling channel. For example, with continued reference to FIGS. 4 and 5, the power converter 112 can further include a first cover 446 and a second cover 450 that are configured to couple to either end of the power converter 112. The first and second covers 446, 450 can be shaped in a similar way to the unit housings 416, 420, 424 such that the first and second covers 446, 450 completely cover or partially cover either end of the power converter 112, respectively, when coupled thereto. In particular, the first cover 446 can be configured to couple to the first power conversion unit 404 (e.g., the first unit housing 416), and the second cover 446 can be configured to couple to the second power conversion unit 408 (e.g., the second unit housing 420). For example, the first cover 446 can be configured to couple to the first side 426A of the first power conversion unit 404, and the second cover 446 can be configured to couple to the second side 428B of the second power conversion unit 408. In this way, the unit housings 416, 420, 424 and the first and second covers 446, 450 can fully enclose the power conversion units 404, 408, 412. However, it is contemplated that the first and second covers 446, 450 can be arranged in other ways such as, for example, arrangements in which the first and second covers 446, 450 may only partially cover the first power conversion unit 404 and the second power conversion unit 408, respectively.

In some aspects, the first and second covers 446, 450 can be coupled to the power conversion units 404, 408, 412 to define additional coolant channels. As discussed above, the first external recess 438A can be disposed on the first side 426A of the first power conversion unit 404. As such, the first cover 446 can form a third coolant channel 430C with the first external recess 438A when coupled to the first side 426A of the first power conversion unit 404. In particular, the first cover 446 can be coupled to the first side 426A of the first power conversion unit 404 to act as an upper boundary for the first external recess 438A, thereby forming the third coolant channel 430C with the first external recess 438A. Put another way, coupling the first cover 446 to the first power conversion unit 404 (e.g., the first unit housing 416) can form the third coolant channel 430C between the first power conversion unit 404 and the first cover 446. In some aspects, the first cover 446 can include additional recesses (not shown) that are similarly shaped to the first external recess 438A. For example, the additional recesses (not shown) of the first cover 446 and the first external recess 438A can each define lateral halves of the third coolant channel 430C such that the third coolant channel 430C is fully defined when the first power conversion unit 404 is coupled to the first cover 446.

In a similar way, the second cover 450 can be configured to cover the second power conversion unit 408, or, more specifically, the second side 428B of the second power conversion unit 408. As discussed above, the second external recess 442B can be disposed on the second side 428B of the second power conversion unit 408. As such, the second cover 450 can form a fourth coolant channel 430D with the second external recess 442B when coupled to the second side 428B of the second power conversion unit 408. In particular, the second cover 450 can be coupled to the second side 428B of the second power conversion unit 408 to act as an upper boundary for the second external recess 442B, thereby forming the fourth coolant channel 430D with the second external recess 442B. Put another way, coupling the second cover 450 to the second power conversion unit 408 (e.g., the second unit housing 420) can form the fourth coolant channel 430D between the second power conversion unit 408 and the second cover 450. In some aspects, the second cover 450 can include additional recesses (not shown) that are similarly shaped to the second external recess 442B. For example, the additional recesses (not shown) of the second cover 450 and the second external recess 442B can each define lateral halves of the fourth coolant channel 430D such that the fourth coolant channel 430D is fully defined when the second power conversion unit 408 is coupled to the second cover 450.

In some aspects, the first and second coolant channels 430A, 430B can be in fluid communication with one another, the third and fourth coolant channels 430C, 430D, and the third coolant path 312. In this way, the shared coolant path 300 can include the coolant channels 430, meaning that the third coolant path 312 and the coolant channels 430 are integrated as part of the shared coolant path 300 of the drive unit 100 (see FIG. 1).

There are several advantages of arranging power conversion units to define coolant channels therebetween. In particular, use of an integrated flow path in a power converter can enhance the thermal efficiency of the power converter and decrease the surface area needed to adequately regulate the temperature of the power converter. By using an integrated coolant path between multiple power conversion units in a power converter, the number of separate coolant paths can be reduced, thereby increasing ease of manufacture. Correspondingly, the use of an integrated coolant path can also lead to decreased costs to manufacture a drive unit since fewer components (e.g., tubes, hoses, valves, or other components of a coolant circuit) may be required to adequately regulate the temperature of a power converter. This in turn can provide for more efficient cooling of individual power conversion units in a power converter and can improve overall performance, efficiency, and longevity of the power converter.

It will be apparent to one of skill in the art that the above description is an example of a flow path for coolant in a power converter and that power converter units can be configured in any desired shape or combination of shapes to form cooling channels therebetween for at least the purpose of increasing the thermal efficiency of the power converter unit. Accordingly, an advantage of the present disclosure is that a power converter can include stackable power converter units that form coolant channels therebetween, thus providing a more thermally efficient power converter system which can further increase drive unit efficiency.

Relatedly, coolant channels can be used to regulate the temperature of power electronics or power electronic components disposed within in a power converter. As will be discussed below in greater detail, one or more power electronics (e.g., IGBT, MOSFET, and GAN switches, etc.) can be arranged in a power converter to control a supply of electric to and from a motor or battery. To provide effective thermal management of power electronics, coolant channels can be arranged in a power converter to facilitate heat exchange between the power electronics therein and a coolant that flows through the coolant channels, thereby convectively cooling the power electronics. Any type of cooling can be used to cool power electronics using cooling channels, such as, for example, direct cooling, indirect cooling, liquid cooling, air cooling, jet impingement cooling, cold plate cooling, two-phase cooling, etc., or any combination thereof. In some aspects, power electronics can be arranged within a power conversion unit of a power converter, and a power unit housing can be configured to provide direct cooling to a power electronic component.

Specifically, a coolant channel formed within a power unit housing can include one or more coolant jets that are configured to provide direct cooling to a power electronic component. For example, a power electronic component can be coupled to a seat, and a seat can be in fluid communication with a coolant channel. In this way, a flow of coolant can be directed from a coolant channel to a seat for the power electronic component to provide direct cooling to the power electronic component. In some aspects, coolant can flow through a coolant channel to a seat so that the coolant can flow across the power electronic (e.g., cooling fins or another heat rejection surface of the power electronic). Still, in some aspects, a nozzle can be positioned between the coolant channel and the power electronic component to provide jet impingement cooling to the power electronic component. In such cases, a first flow of coolant is defined by a coolant channel and a second flow of coolant is defined by a coolant jet.

Referring now to FIGS. 7 and 8, example schematics are illustrated of a power conversion unit 500 that is similar to the power conversion units 404, 408, 412 of FIG. 7. The power conversion unit 500 can include a power unit housing 504 and a coolant channel 508 that are similar to the power unit housings 416, 420, 424 and the coolant channels 430, respectively, as discussed above and as illustrated in FIGS. 4 and 5. As such, it will be understood that any aspects of the power conversion unit 500, power unit housing 504, and coolant channel 508 may be applicable to the power conversion units 404, 408, 412, the power unit housings 416, 420, 424, and the coolant channels 430, respectively.

In the non-limiting examples illustrated in FIGS. 7 and 8, the coolant channel 508 can be configured to provide direct cooling to one or more power electronic components 512 arranged within the power conversion unit 500. As will be discussed below in greater detail, the power electronic component 512 can be any suitable power electronic component (e.g., IGBT, MOSFET, and GAN switches, etc.) or any combination of power electronic components. In some aspects, one or more coolant jets 516 can be formed in the power unit housing 504 such that the coolant channel 508 is in fluid communication with the coolant jet 516 to provide cooling to the power electronic component 512.

In particular, the coolant jet 516 can be integrally formed within the power unit housing to define a jet aperture 520 through which coolant may flow. For example, the coolant jet 516 can be integrally formed within a surface 524 of the power unit housing 504 that can be shared with the coolant channel 508. In this way, the coolant channel 508 can be in fluid communication with the coolant jet 516 such that coolant is directed from the coolant channel 508 and through the jet aperture 520 by the coolant jet 516. In this way, coolant can flow from the coolant channel 508, through the jet aperture 520, and onto the power electronic component. Accordingly, coolant can be provided to the power electronic component 512 by the coolant jet 516.

In some aspects, a coolant jet can include additional structures (e.g., valves nozzles, etc.) that are configured to enhance coolant flow therethrough. Further, it is contemplated that any number of coolant jets can be formed in a power unit housing and that coolant jets can be formed along any surface or combinations of surfaces of a power unit housing.

With particular reference to the non-limiting example illustrated in FIG. 7, the power electronic component 512 can be directly coupled to the surface 524 of the power unit housing 504 in which the coolant jet 516 is be formed. Specifically, coolant can flow from the coolant channel 508 to the power electronic component 512 (e.g., an underside of power electronic component 512) though the jet aperture 520 by way of the coolant jet 516. Put another way, the coolant jet 516 can be configured to provide jet impingement cooling directly to the power electronic component 512 (i.e., an impingement surface). For example, the coolant jet 516 can squirt coolant directly onto the power electronic component 512 or onto cooling fins of the power electronic component 512, thereby providing direct cooling for the power electronic component 512. However, it is contemplated that coolant jets can also provide indirect cooling to a power electronic component.

To facilitate cooling of a power electronic component, the power electronic component can be coupled to a power unit housing. For example, a power electronic component can be arranged within a seat that is coupled to the power unit housing. As discussed above, a seat can be in fluid communication with a coolant channel such that a flow of coolant can be directed from a coolant channel and into the seat (e.g., via an opening therebetween, such as, for example, a jet nozzle), in which a power electronic component is arranged. A seat can be arranged in any shape, such as, for example, a rectangular seat, triangular seat, cylindrically shaped seat, or the like. In some aspects, a seat can have an internal area that is in fluid communication with a coolant channel, a coolant jet, or both. In this way, coolant can flow over a power electronic component that is arranged in the internal area of the seat, thereby cooling the power electronic component.

With particular reference to the non-limiting example illustrated in FIG. 8, a seat 528 can be arranged between the power electronic component 512 and the coolant jet 516. Specifically, the seat 528 can be coupled to the surface 524 of the power unit housing 504 that may be shared with the coolant channel 508, and the power electronic component 512 can be arranged within the seat 528. In particular, the seat 528 can be directly secured to the surface 524 of the power unit housing 504, or it can be integrally formed (e.g., co-molded) with the power unit housing 504, so that the seat 528 extends from the power unit housing 504 (e.g., the surface 524 thereof).

The seat 528 can be coupled to the coolant jet 516, and an internal area 534 of the seat 528 can be in fluid communication with the coolant jet 516. Put another way, the internal area 534 of the seat 528 can be aligned with the jet aperture 520 so that coolant can flow from the coolant channel 508 and (optionally) through the coolant jet 516 or other opening into the internal area 534 of the seat 528. Accordingly, coolant can flow over the power electronic component 512 that can be received within the internal area 534 of the seat 528.

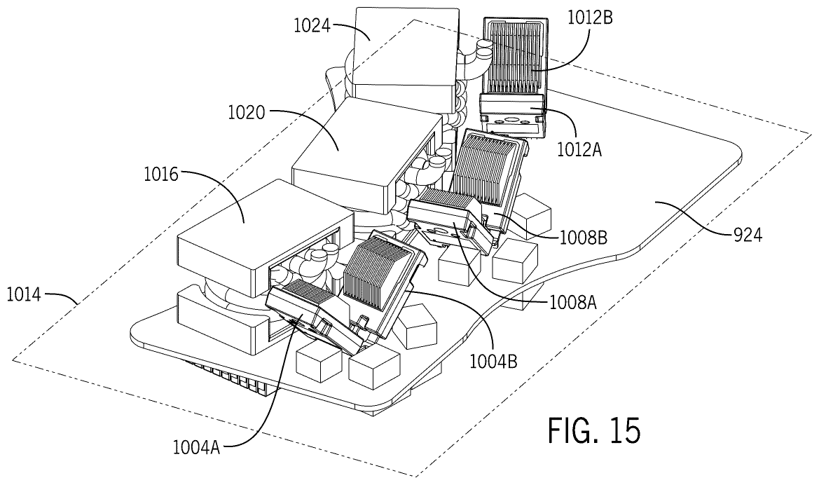

However, it is further contemplated that other arrangements of the seat may be employed to cool a power electronic component, such as, for example, arrangements in which a fluid conduit or plate is included within the internal area the seat that may define a flow pattern along which fluid can flow, such as, for example, a tortuous path pattern or another type of pattern. Alternatively, coolant may be allowed to accumulate or pool within the internal area of the seat such that a power electronic component can be partially or fully submerged in coolant. Additional examples of seats for cooling power electronic components are described below in relation to FIGS. 15-25. Further, it is contemplated that a plurality of power electronic components can be arranged within a single seat, or the ratio of seats to power electronic components can be 1:1 (i.e., a single power electronic component is arranged in each seat).

As discussed above, a coolant jet can be configured to direct a flow of coolant from a coolant channel to a power electronic component. In particular, a first flow of coolant can flow through a coolant channel, and a second flow of coolant can flow through a coolant jet. In the non-limiting examples illustrated in FIGS. 7 and 8, a first flow of coolant 538 flows can flow through the coolant channel 508, and a second flow of coolant 542 can flow from the coolant channel 508 through the coolant jet 516 and the jet aperture 520. It is contemplated that any number of second flow paths of coolant (i.e., flow paths of coolant through coolant jets) can exist. In some aspects, the second flow of coolant 542 may originate from the first flow of coolant 538, meaning that coolant can be provided from the coolant channel 508 to the coolant jet 516. Additionally, coolant can be returned through the coolant jet 516 to the coolant channel 508. In this way, multiple coolant jets can be in fluid communication with one another, meaning that coolant can be recycled in a power conversion unit or between power electronic components arranged therein.

There are several advantages of arranging a housing of a power conversion unit to form coolant jets therein. In particular, coolant jets can provide direct cooling to power electronic components arranged within a power conversion unit which can enhance the thermal efficiency of the power converter and decrease the surface area needed to adequately regulate the temperature of the power converter. By using cooling jets that are in fluid communication with an integrated fluid path in a power conversion unit, more efficient and direct cooling of the power electronic components can be provided. Correspondingly, the use of an integrated coolant path including cooling jets can also lead to decreased costs to manufacture a drive unit since fewer components (e.g., tubes, hoses, valves, or other components of a coolant circuit) may be required to adequately regulate the temperature of individual power conversion units in a power converter. This in turn can improve overall performance, efficiency, and longevity of the power converter as a whole.

It will be apparent to one of skill in the art that the above description is an example of a flow path for coolant in a power converter and that power unit housings can be configured in any desired shape or combination of shapes to form cooling jets therein for at least the purpose of increasing the thermal efficiency of the power converter unit. Accordingly, an advantage of the present disclosure is that power converter units can include coolant jets formed therein that provide direct cooling to one or more power electronic components, thus providing a more thermally efficient power converter system which can further increase drive unit efficiency.

Relatedly, power electronic components can be arranged within a power converter to provide power conversion with increased power efficiency, increase power density, and/or reduced cost. In particular, one or more power electronic components (e.g., IGBT, MOSFET, and GAN switches, etc.) can arranged within a power conversion unit of a power converter unit. More specifically, power electronic components can be arranged on one or more power conversion modules (PCMs) that are included in a single power conversion unit. As will be discussed in greater detail below, a PCM can include one or more power electronic components coupled to a first side of a circuit board and a bus bar coupled to a second side of the circuit board to direct or supply electrical power to the power converter at a maximum power level. In addition, PCMs can be disposed within a power unit housing of a power conversion unit, and multiple PCMs can be included in a single power converter unit. In this way, a power converter can include a plurality of PCMs that are configured to provide electrical power to one or more components in a drive unit (e.g., a motor, a transmission, etc.) at a plurality of discrete maximum power levels. In some examples, PCMs can provide power to an AC grid (e.g., for commercial or residential applications), or part of electric vehicle supply equipment (EVSE) in the form of a standalone EV battery charging station (e.g., where the PCMs are connected to an AC grid and charge a high-voltage (HV) DC power supply that is part of an EV separate from the EV battery charging station). In addition, it is contemplated that a PCM can be configured to operate as one or more of a charger, an inverter, a three-phase inverter, an AC-AC converter, an AC-DC converter, a DC-AC converter, or a DC-DC converter, either individually or in combination with one or more additional PCMs. As discussed above, an electronic controller can be configured to selectively operate PCMs, individually or in any combination, based on an operational parameter of a drive unit.

In some aspects, PCMs in a power conversion unit can be arranged in an opposed configuration, which can allow for more efficient cooling ad reduction of parts, To that end, a first PCM (e.g., a first side of a first circuit board) can be positioned along a first side of a power conversion unit to be cooled by a first cooling channel and a second PCM (e.g., first side of a second circuit board) can be positioned along a second side of the power conversion unit to be cooled by a second cooling channel. Correspondingly, the first PCM and the second PCM can be coupled to a shared bus bar extending between the PCM's. In some aspects, the first PCM and the second PCM, individually or in combination, can be selectively operated as a three-phase inverter and/or a charger in a charging mode to supply electrical power to a battery. In some examples, a PCM can be selectively operated to provide multiple phases of AC current (e.g., three phases) or one phase of a plurality of phases that are provided by the power converter as a whole (e.g., one of three or nine phases provided by the power converter). In some examples, a PCM can be selectively operated to provide multiple phases in a broader plurality of phases of AC current (e.g., three phases of a nine-phase AC system).

Referring now to FIG. 9, and as generally discussed above, a power conversion unit 900 can includes a power unit housing 904 having a first external recess 908A defining a first coolant channel 912A at a top or first side 916A of the power unit housing 904 and a second external recess 908B defining a second coolant channel 912B at a bottom or second side 916B of the power unit housing 904. Additionally, the power conversion unit 900 can include a first PCM 920 and a second PCM 924 disposed therein, which can be positioned to improve cooling of the PCMs.

To that end, PCMs generally include a variety of power electronic components to convert between different types or qualities of electrical power. In some aspects, each PCM includes grounding and/or electromagnetic shielding components that protect the power electronic components of each PCM by preventing unwanted ingress or egress of electromagnetic interference (EMI). Such shielding may be incorporated into a circuit board of a PCM (e.g., by designing ground planes and/or guard traces around sensitive components that are coupled to the circuit board), or provided as cable shielding, faraday cage(s), and/or shielded housings made of conductive materials that reflect or absorb EMI. For example, the first PCM 920 can include a first circuit board 928 defining a first side 932 and a second side 936, and first power electronic components 938 coupled to the first side 932 of the first circuit board 928. Similarly, the second PCM 924 can include a second circuit board 940 defining a first side 944 and a second side 948, and second power electronic components 952 coupled to the first side 944 of the second circuit board 940. As discussed below in greater detail, it is contemplated that the power components can be any suitable combination of power electronic components.

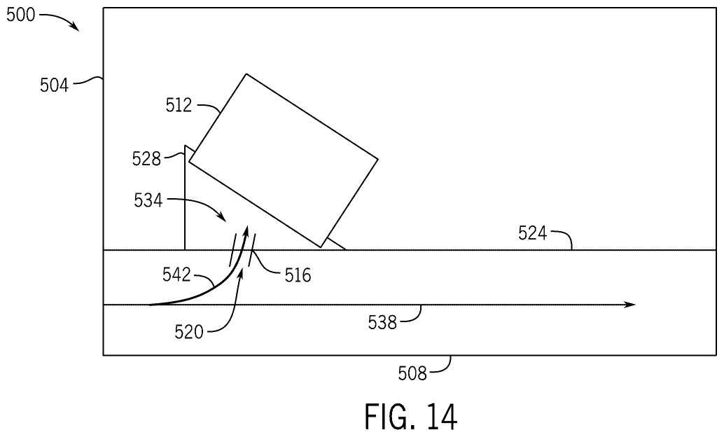

Correspondingly, conversion of this electrical power generally results in the power electronic components generating heat, which must be removed. Accordingly, the first PCM 920 and the second PCM 924 can be arranged in an opposed configuration within the power unit housing 904 to provide more efficient cooling of the power electronic components 938, 952. In particular, the first PCM 920 can be arranged within the power conversion unit 900 with the first side 932 of the first circuit board 928 facing and extending along first side 916A of the power unit housing 904. In this way, the first power electronic components 938, which are supported on the first side 932, can be positioned immediately adjacent the first external recess 908A that defines the first coolant channel 912A. Accordingly, the first power components 938 can be enclosed by the first side 916A of the power conversion unit 900 and the first side 932 of the first circuit board 928. Moreover, this arrangement can allow the first power electronic components 938 (e.g., FET's, etc.) to be seated within seats (e.g., seats 528, see FIG. 14) provided in the first side 916A to allow for direct cooling thereof (e.g., via jet impingement cooling or other cooling flow, as generally discussed above).

Similarly, the second PCM 924 can be arranged within the power conversion unit 900 with the first side 944 of the second circuit board 940 facing and extending along the second side 916B of the power unit housing 904. In this way, the second power electronic components 952, which are supported on the first side 944, can be positioned immediately adjacent the second external recess 908B that defines the second coolant channel 912B. Accordingly, the second power electronic components 952 can be enclosed by the second side 916B of the power conversion unit 900 and the first side 944 of the second circuit board 940. Moreover, this arrangement can allow the second power electronic components 952 (e.g., FET's, etc.) to be seated within the seats provided in the second side 916B to allow for direct cooling thereof (e.g., via jet impingement cooling or other cooling flow, as generally discussed above).

Thus, in such an opposed configuration, the first side 932 of the first circuit board 928 can be arranged facing the first side 916A of the power conversion unit 900, and the first side 944 of the second circuit board 940 can be arranged facing the second side 916B of the power conversion unit 900. Put another way, the first side 932 of the first circuit board 928 can face in a direction that is opposite to a direction in which the first side 944 of the second circuit board 940 faces and the second side 936 of the first circuit board 928 can face the second side 948 of the second circuit board 940.

In some aspects, PCMs arranged in an opposing configuration can allow for sharing of components between the PCMs. For example, a power conversion unit can include a shared bus bar that can direct electrical power supplied by PCMs to one or more output circuits in the power converter which in turn can distribute the electrical power to one or more components in a drive unit, such as, for example, a motor. The bus bar that can extend and be secured between two PCMs, such that the PCMs are arranged in an opposed configuration about the bus bar, thereby making efficient use of space with a power conversion unit and reducing overall part count.

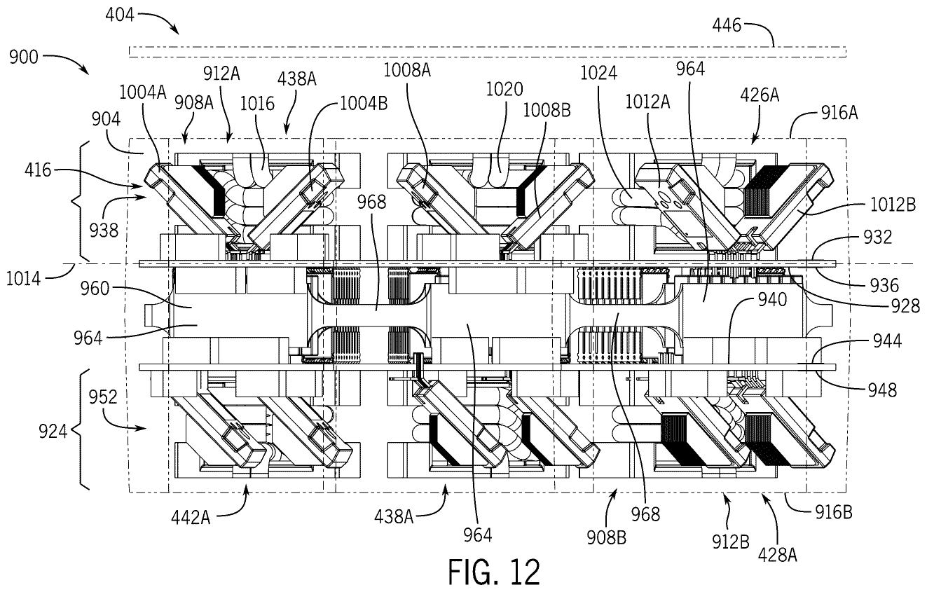

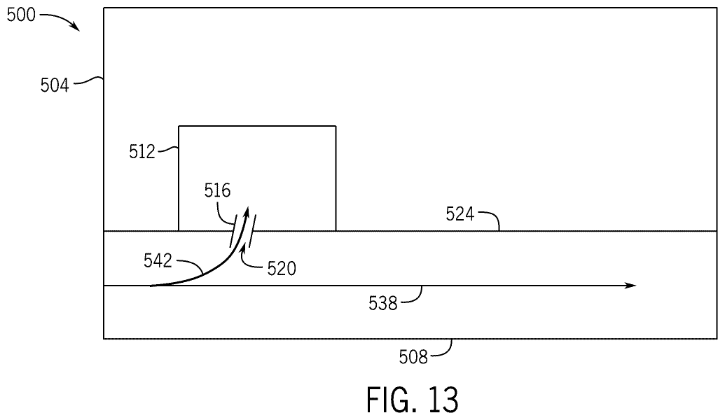

For example, still referring to FIG. 12, a (shared) bus bar 960 can be coupled between the first PCM 920 and the second PCM 924. More specifically, the bus bar 960 can be coupled to the second side 936 of the first circuit board 928 and the second side 948 of the second circuit board 940. In this way, the bus bar 960 can be secured (e.g., stacked) between the first PCM 920 and the second PCM 924. The bus bar 960 can include additional components coupled thereto, such as, for example, additional power components, conduction plates, coverings, terminals, etc. In addition, it is contemplated that the bus bar can be arranged in any suitable shape or combination of shapes to direct electrical power supplied by the PCMs 920, 924 to other components in a drive unit. For example, the bus bar 960 can include tabs 964 that are vertically aligned with the power components 938, 952 and connector rails 968 that can connect adjacent tabs 964 to one another. Put another way, the shared bus bar 960 can be defined by alternating tabs 964 and connector rails 968 to adequately direct electrical power while conserving space in the power conversion unit 900.

The bus bar 960 can provide a high-current capable electrical connection between a power supply (e.g., battery) and the first PCM 920 and the second PCM 924. For example, the bus bar 960 may supply DC power from the power supply to the first PCM 920, and may supply DC power from the power supply to the second PCM 924. Accordingly, the bus bar 960 may also be referred to as a DC bus bar. The first and second PCMs 920, 924 may include one or more power switching elements (e.g., arranged in a bridge circuit) that are switched with a pulse-width modulated (PWM) control signal to invert the DC power to AC power. Additionally, in a charging mode, the first and/or second PCMs 920, 924, may receive AC power (e.g., from a coupled motor acting as a generator during braking, from a coupled utility grid, etc.). The one or more power switching elements may be switched with a PWM control signal to rectify the AC power and provide DC power output on the bus bar 960. The provided DC power may be received by the battery to thereby charge the battery.

There are several advantages of arranging PCMs in an opposed configuration within a power conversion unit. In particular, the use of an opposed configuration can increase the number of power electronic components that can be included in a power conversion unit by conserving space while maintaining adequate cooling of the power electronic components via cooling channels formed in the housing of the power conversion unit (e.g., a power unit housing). Further, arranging power conversion in an opposed configuration can allow a bus bar to be shared therebetween, thus reducing the amount of parts needed to direct electrical power and conserving space within the power conversion unit. Accordingly, the power output of the power converter can be increased while reducing the physical space occupied by the power converter. As a result, the power density of a power converter can be increased which can further enhance drive unit efficiency.

It will be apparent to one of skill in the art that the above description is an example of an arrangement of PCMs within a power conversion unit and that PCMs can be arranged with a shared bus bar in any configuration to consolidate the number of parts in the power conversion unit for at least the purpose of increasing the power density of the power converter unit. For example, a power conversion unit can include additional or fewer PCMs, sets of power components, circuit boards, or shared bus bars than those discussed above. In this way, aspects of a PCM, a power conversion unit, and a power converter can be modulated to achieve desired power output characteristics thereof. In addition, an advantage of the present disclosure is that power converter modules can share a bus bar to reduce the number of parts in a power conversion unit, thus increasing the amount of physical space for power electronic components and enhancing the power density of a power converter system which can further increase drive unit efficiency.

As discussed above, one or more power electronic components can be arranged within a power conversion unit and, specifically, on a circuit board in a PCM. In the non-limiting examples illustrated in FIGS. 12 and 15, a circuit board for a PCM can include electronic components to provide multiple phases of AC current from a single DC input voltage. In particular, as shown, a circuit board (e.g., the first circuit board 928 and/or the second circuit board 940) can include a first pair of field effect transistors (FETs) 1004A, 1004B corresponding to a first phase, a second pair of FETs 1008A, 1008B corresponding to a second phase, and a third pair of FETs 1012A, 1012B corresponding to a third phase. While the description herein refers to the first circuit board 928, it will be understood that the aspects discussed are also applicable to the second circuit board 940.

In some aspects, FETs coupled to a circuit board can include cooling fins disposed thereon, and pairs of FETs can be arranged at specific angles relative to one another and the circuit board. The particular configuration of the FETs can be selected so that each FET can be received in a seat for enhanced cooling. In some aspects, cooling fins disposed on each FET can be received within a seat to further enhance cooling. In the non-limiting example illustrated in FIG. 12, the first circuit board 928 can define a plane 1014 that extends in a direction that is substantially parallel to the first side 916A of the power conversion unit 900. The first pair of FETs 1004 can be coupled to the first side 932 of the first circuit board 928 can be extend at an angle relative to the plane 1014, such as, for example, a non-orthogonal angle relative to the plane 1014 defined by the first circuit board 928. In some aspects, the angle can be between about 0 and 90 degrees, between about 30 and 60 degrees, between about 40 and 50 degrees, or about 45 degrees. In some aspects, the first FET 1004A and the second FET 1004B are arranged in a “V” shape, meaning that the first FET 1004A can extend in a direction that is perpendicular to a direction in which the second FET 1004B extends. In this way, and angle of about 90 degrees can be formed between the first FET 1004A and the second FET 1004B. However, it is contemplated that FETs can be arranged at any angle with respect to one another and a plane defined by a circuit board. As another non-limiting example, a first FET can extend in a direction that is substantially parallel to a direction in which a second FET extends.

In some aspects, FETs provided for PCMs (e.g., pairs of FETs housed on a PCM circuit board) can be a junction FET (JFET), a metal oxide semiconductor FET (MOSFET), or any other type of FET or power switching element. In some examples, FETs of a PCM can perform switching to implement pulse width modulation (PWM) to convert a DC signal into an AC signal with a desired amplitude and frequency. For example, the FETs 1004 can implement PWM in response to a pulse-width modulated input control current to produce an output AC signal at a first phase, with a defined amplitude and frequency. For example, in some cases, the output signal of the first pair of FETs 1004 can be an AC signal with a voltage of root mean squared (RMS) 120 V (i.e., with amplitude (peak-to-peak) of 340 V) and a frequency of 60 Hz. The output signal of the second pair of FETs 1008 can be similar to the output signal of the first pair of FETs 1004 (e.g., an output voltage of RMS 120 V and a frequency of 60 Hz), but the signal can be shifted 120 degrees from the phase of the signal produced by the first pair of FETs 1004. Similarly, the output AC signal of the third pair of FETs 1012 can be shifted 120 degrees from the output signal of the second pair of FETs 1008. In some aspects, other voltage levels and/or frequencies are of AC signals that can be generated by FETs and a circuit board. In some examples, a PCM can use switching components other than FETs to invert a DC signal to AC, including, for example, insulated gate bipolar transistors (IGBTs) or other transistor elements.

Further, each phase of AC current produced by a PCM can be filtered to produce the desired signal characteristics and filter out unwanted frequencies or amplitudes of AC current. In some examples, an AC signal from FETs of a PCM can be filtered by an LC filter before the signal is provided to power a downstream AC load in a drive unit (e.g., a motor). Still referring to FIGS. 12 and 15, the first circuit board 928 can include inductor coils 1016, 1020, 1024, to provide inductance for the LC filters. As shown, a first inductor coil 1016 can be electrically downstream of the first pair of FETs 1004 to produce the first phase of AC voltage. Similarly, a second inductor coil 1020 can provide inductance for an LC filter along the second phase of AC voltage, and the third inductor coil 1024 can provide inductance along the third phase of AC voltage.

In some examples, an inductor (e.g., the inductor coils 1016, 1020, 1024) can provide a sinusoidal output including current and voltage. Because of this sinusoidal output, for example, the output of each PCM does not need to be perfectly timed or in synchronization with one another. For example, the PWM signals driving the power switching elements of the PCMs may vary slightly and not have edges that match precisely, and the power converter system will perform power conversion as intended (e.g., without faults or failures due to misaligned PWM signal edges). Accordingly, the particular PCMs enabled and disabled may be changed over time, with some previously disabled PCMs being brought online and/or some previously enabled PCMs being brought offline on-the-fly safely, quickly, and effectively. Moreover, the sinusoidal output may eliminate EMI shielding requirements for leads that are coupled to the motor due to the reduction of the change in voltage over time, and thus the EMI associated with voltage change.

It is contemplated that a circuit board of a PCM can also include other power electronic components, such as, for example, resistors, capacitors, gate driver isolators, micro-controllers, safety relays, DC/DC bridges, hall-effect transducers, input terminals, output terminals, another electronic component, or any combination thereof.

As discussed above, a (shared) bus bar can be coupled between multiple PCMs to efficiently utilize the physical space available in a power converter and direct electrical power supplied to or by the PCMs to one or more circuits in the power converter. In addition, use of a bus bar can allow for interleaving of PCMs. As used herein, the term “interleaving” can at least mean that sinusoidal outputs of inverters in respective PCMs are phase-shifted with respect to one another, thereby providing interleaved output signals, which in turn can provide an overall smoother, more consistent, and/or otherwise improved output signal from a power converter. In some aspects, a bus bar may be configured as a bus bar assembly which can include one or more conduction bars that may be coupled to and/or partially enclose a plurality of capacitors. That is, a bus bar assembly can include two or more individual bus bars that can be coupled in an opposed configuration about one or more capacitors. The placement of capacitors between bus bars can be beneficial by allowing for PCMs to be interleaved, thereby improving system performance and efficiency.

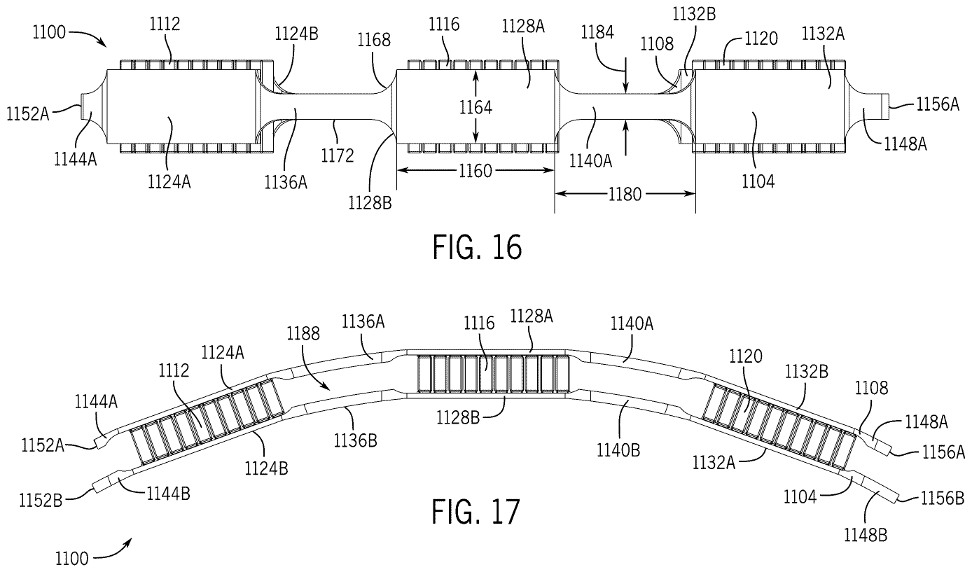

A bus bar assembly can be arranged in a variety of shapes in accordance with relative position of any PMCs that are connected thereto. Accordingly, a bus bar assembly can be a linear or curvilinear bus bar, or it can have another shape, for example, a branched shape. The specific shape of a bus bar assembly can be determined, at least in part, by the shape of the conduction bar(s). For example, as shown in FIGS. 16 and 17, a conduction bar may define a generally arcuate or curved shape and can be arranged concentrically with one or more other conduction bars, such that a bus bar assembly also defines a generally accurate or curved shape. Further, a conduction bar can have a substantially uniform height or thickness along its length, or a conduction bar can have a varying height or thickness defined by alternating tabs and rails to define an undulating or oscillating profile of the bus bar. Put another way, a height of a conduction bar can vary along a curved length of the conduction bar. It is contemplated that a conduction bar can be formed as a unitary component, meaning that tabs and rails thereof can be integrally or monolithically formed with one another, or a conduction bar may be formed from multiple segments that can be coupled with one another.

For example, referring now to FIGS. 16 and 17, a bus bar assembly 1100 (e.g., bus bar 960) can include a one or more conduction bars (e.g., a first conduction bar 1104 and a second conduction bar 1108, and a plurality of capacitors (e.g., a first capacitor 1112, a second capacitor 1116, and a third capacitor 1120). Each of the first capacitor 1112, the second capacitor 1116, and the third capacitor 1120 can include a set of one or more capacitors (i.e., as a single capacitor or a plurality of capacitors). However, it is contemplated that a bus bar assembly can include any suitable number of conduction bars, capacitors, and/or other components. In some aspects, the conduction bars 1104, 1108 may define a linear profile and/or an arcuate profiles. For example, the first conduction bar 1104 can have a first radius of curvature that is between about 75% and about 100%, between about 85% and about 95%, or about 90% of a second radius of curvature that can be defined by the second conduction bar 1108.

It is contemplated that the conduction bars, (e.g., the conduction bars 1104, 1108) may serve as positive and negative DC rails, respectively, for the bridge of switching elements or transistors that form a PCM of a power converter. Accordingly, DC power provided to the power converter may be provided across the conduction bars, which the power converter may in turn provide to one or more inverters (e.g., to drive the motor). Additionally, DC power may be output by the power converter across the conduction bars (e.g., to supply charging power). It is contemplated that, the DC power output may be rectified AC power that the power converter has received from, for example, the motor (from regenerative braking) or a utility grid, which may also be rectified.

Further, the conduction bars can each include conduction tabs and conduction rails that extend between adjacent conduction tabs. For example, the first conduction bar 1104 can include a first conduction tab 1124A, a second conduction tab 1128A, a third conduction tab 1132A, a first rail 1136A, a second rail 1140A, a first end rail 1144A (i.e., a third rail), and a second end rail 1148A (i.e., a fourth rail). The first rail 1136A can extend between the first and second conduction tabs 1124A, 1128A, and the second rail 1140A can extend between the second and third conduction tabs 1128A, 1132A. Accordingly, the first tab 1124A and the second tab 1128A are spaced from one another by the first rail 1136A, and the second tab 1128A and the third tab 1132A are spaced from one another by the second rail 1140A. In addition, the first end rail 1144A can extend outward from the first conduction tab 1124A to define a first end 1152A of the first conduction bar 1104, and the second end rail 1148A can extend outward from the third conduction tab 1132A to define a second end 1156A of the first conduction bar 1104. In other non-limiting examples, a conduction bar can be formed differently to provide for any arrangement of PCMs, or other power electronic components.

Similarly, the second conduction bar 1108 can include first, second and third tabs 1124B, 1128B, 1132B, a first rail 1136B that can extend between the first tab 1124B and the second tab 1128B, and a second rail 1140B that can extend between the second tab 1124B and the third tab 1132B. Further, the second conduction bar 1108 can include a first end rail 1144B that can extend outward from the first conduction tab 1124B to define a first end 1152B of the second conduction bar 1108, and a second end rail 1148B that can extend outward from the third conduction tab 1132B to define a second end 1156B of the second conduction bar 1108.

In some aspects, the tabs 1124B, 1128B, 1132B of the second conduction bar 1108 are arranged to align with the tabs 1124A, 1128B, 1132A of the first conduction bar 1106. Correspondingly, the first and second rails 1136A, 1140A of the first conduction bar 1104 may have longer lengths than the first and second rails 1136B, 1140B, respectively, of the second conduction bar 1108. In addition, the first and second end rails 1144A, 1148A of the first conduction bar 1104 may have shorter lengths than the first and second end rails 1144B, 1148B, respectively, of the second conduction bar 1108. In this way, the first and second conduction bars 1106, 1108 can have different length to account for any curvature in the bus bar assembly 1100, as may allow for the first and second conduction bars 1106, 1108 to extend substantially parallel to one another to maintain a substantially constant gap distance therebetween (e.g., with a tolerance of approximately one millimeter or less). In other cases, the gap distance between conduction bars may vary. For example, the rails may be formed as thickened regions to provide greater strength or current capacity to the bus bar assembly. Accordingly, a gap distance at the rails may be less than a gap distance at the tabs.

Relatedly, it is contemplated that the conduction tabs and rails of the bus bar assembly can be configured in any desired shape or combination of shapes, for at least the purpose of providing a suitable conduction path for electrical power supplied by PCMs. For example, the conduction tabs 1124, 1128, 1132 can have a rectangular profile when viewed from the side and/or top, as illustrated in FIGS. 16 and 17, respectively. In the illustrated non-liming example, the conduction tabs 1124, 1128, 1132 may be identically or similarly shaped to one another, although it is contemplated that conduction tabs may be differently shaped to alter the conduction path through the bus bar assembly, or otherwise affect an electrical property thereof (e.g., electric resistance or current capacity). With particular reference to FIG. 16, the conduction tabs 1124, 1128, 1132 may have a common tab length 1160 and a common tab height 1164 that is measured in a direction that is perpendicular to the tab length 1160. In some aspects, the tab length 1160 may be between about 25% and about 75% of the tab height 1164, or between about 40% and about 60% of the tab height 1164, or between about 40% and about 50% of the tab height 1164, or about 47% of the tab height 1164.

Moreover, the conduction rails can have an “I” shaped profile when viewed from the side and/or a trapezoidal profile when viewed from the top, as illustrated in FIGS. 16 and 17, respectively. For example, the first conduction rail 1136A can be tapered on either end to define curved segments 1168 and linear segments 1172 which extend between the curved segments 1168. Put another way, the curved segments 1168 can be coupled at one end to the first or second conduction tabs 1124A, 1128A and can curve inward (i.e., toward a longitudinal centerline of the conduction bar, for example, which may extend along a centroidal axis thereof) to form the linear segments 1172. With particular reference to FIG. 16, the conduction rails 1136, 1140, may have a rail length 1180, which is measured between the connected tabs, and a rail height 1184 that is measured in a direction that is perpendicular to the rail length 1180. In some aspects, the rail length 1180 may be between about 75% and about 100% of the tab length 1160, or between about 85% and about 95% of the tab length 1160, or about 90% of the tab length 1160. In some aspects, the rail height 1184 may be between about 25% and about 50% of the tab height 1164, or between about 30% and about 35% of the tab height 1164. Thus, it will be understood that each bar in a bus bar assembly can define an undulating profile. However, it will be understood that the above description is a non-limiting example of conduction bars in a bus bar assembly, and that tabs and rails in a conduction bar can be configured differently according to the particular application.

In some cases, conduction bars can be arranged in a spaced configuration with one another to define a gap therebetween, and one or more capacitors can be coupled within the gap (e.g., to be sandwiched between a first conduction bar and a second conduction bar). For example, a capacitor can be secured on either side to opposing tabs on each conduction bar. Correspondingly, it will be understood that each pair of opposing tabs on opposing conduction bars may be coupled to a capacitor disposed therebetween. For example, where multiple tabs are provided along a bus bar assembly, each pair of tabs may correspond with a set of one of more capacitors. Like the tabs, each set of capacitors can be spaced from the other sets by the rails that extend between tabs.

In some aspects, capacitors can serve as electrical contacts that are configured to couple the bus bar assembly to its respective PCMs. More specifically, a capacitor can be configured to couple with contacts from any power electronic component(s) arranged within a power converter, such as, (e.g., IGBT, MOSFET, and GAN switches, etc.). Further, a capacitor can be defined by a top portion and a bottom portion which are symmetric about an opening formed therebetween. Moreover, a capacitor may be dimensioned to receive contacts of power electronic component(s) arranged with a power converter, thereby serving as a connection point between the power electronic component(s) to a bus bar assembly. However, it is contemplated that a bus bar assembly, including conduction bars and capacitors, may be arranged in any suitable configuration to provide a conduction path for electrical power supplied to or by PCMs. Accordingly, a bus bar assembly may be formed of a suitable conduction material, such as, for example, aluminum, brass, bronze, copper, another conductive alloy, and/or any combination thereof.

Referring again to FIG. 17, the first conduction bar 1104 can be arranged concentrically with respect to the second conduction bar 1108 such that a gap 1188 is formed therebetween. Further, the first and second conduction bars 1104, 1108 can be arranged such that the conduction tabs 1124A, 1128A, 1132A of the first conduction bar 1104 are radially aligned with the conduction tabs 1124B, 1128B, 1132B of the second conduction bar 1108. Thus, it will be understood that the gap 1188 may also define an undulating profile when viewed from the top, as illustrated in FIG. 17.

In general, and as mentioned above, capacitors can be provided at the tabs of a bus bar assembly. In the illustrated example, the first capacitor 1112 is coupled to the first tabs 1124A, 1124B, the second capacitor 1116 is coupled to the second tabs 1128A, 1128B, and the third capacitor 1120 is coupled to the third tabs 1132A, 1132B. It is contemplated that the capacitors may be attached to the conduction bars using any suitable technique, such as, for example, fastening, welding, soldering, adhesive, or the like. In some cases, brackets can be provided to maintain capacitors in a particular arrangement or position.

In some cases, capacitors may be configured as contacts for a power electronic component of a power convertor (e.g., a power electronic component arranged on a circuit board in a PCM). In this way, electrical power provided to or generated by a PCM can be directed to a capacitor, and the capacitor can further control the power input or output along a bus bar (e.g., along conduction bars in a shared bus bar, to one or more output circuits in a power converter). In some aspects, a capacitor can be a DC link capacitor that is configured to increasing the stability of the DC voltage of the electrical power supplied to or generated by the power converter. In addition, it is contemplated that a capacitor can be configured in any desired shape or combination of shapes for at least the purpose of providing a suitable conduction path for electrical power supplied by PCMs.

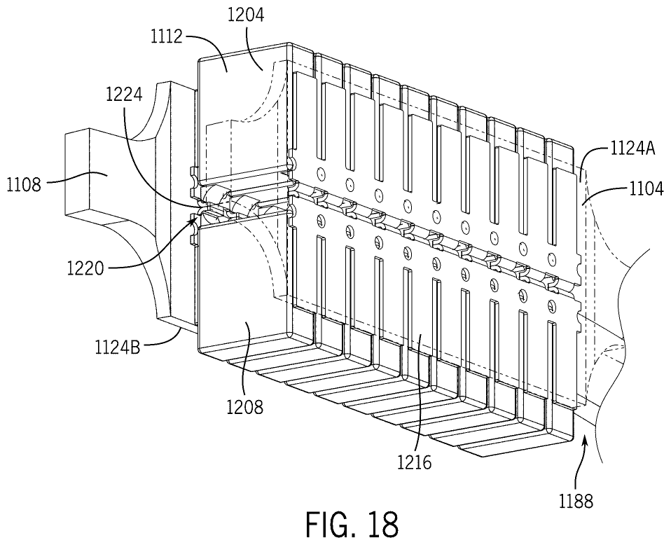

In the non-limiting example of FIGS. 16 and 17, the capacitors 1112, 1116, 1120 can each define rectangular profiles when viewed from the side and/or top. In some aspects, the capacitors 1112, 1116, 1120 are similar or identical to one other. Thus, any description herein of the first capacitor 1112 may also be applicable to the second capacitor 1116 and/or the third capacitor 1120. Referring now to FIG. 18, in which the first conduction bar 1104 being illustrated in phantom, the first capacitor 1112 is fastened within the gap 1188. The first capacitor 1112 can include a top portion 1204 and a bottom portion 1208, each of which can be formed from a plurality of capacitors.

In some cases, mounting plates 1216 can be disposed on the sides of the top portion 1204 and the bottom portion 1208. The mounting plates 1216 can be used to contact the first conduction tabs 1124A, 1124B of the first and second conduction bars 1104, 1108, respectively, thereby fastening the first capacitor 1112 to the conduction bars 1104, 1108. In addition, the mounting plates 1216 can couple the individual capacitors together to be in parallel with one another between the first conduction bar 1106 and the second conduction bar 1108. In this way, the first capacitor 1112 directly contacts the conduction bars 1104, 1108. For example, each capacitor of the first capacitor 1112 may have a first terminal that couples to the mounting plate 1216 and, thereby, to the first conduction bar 1104, and may have a second terminal that couples to the mounting plate 1216 and, thereby, to the second conduction bar 1108. Accordingly, in some examples, the capacitance of the first capacitor 1112 may be equal to a sum of the capacitance of each of the capacitors forming the first capacitor 1112 because of the parallel connection of these capacitors. Further, in some examples, the DC link capacitance of the PCM may be or include a sum of the capacitance of the first capacitor 1112, the second capacitor 1116, and the third capacitor 1120 (i.e., each of the capacitors making up these first, second, and third capacitors 1112, 1116, 1120) due to their parallel connection between the first and second conduction bars 1104, 1108.

When assembled, the first capacitor 1112 can define a cavity 1220. The cavity 1220 can extend and be defined between the top and bottom portions 1204, 1208, and terminal ends 1224 of the mounting plates 1216. The terminal ends 1224 of the mounting plates 1216 may curve inward and be fully or partially disposed in cavity 1220. Correspondingly, the top and bottom portions 1204, 1208 of the first capacitor 1112 can be symmetrical about the cavity 1220.

In some aspects, slits in the capacitor (i.e., gaps between the individual capacitors of the plurality of capacitors) are configured as rectangular slits that are configured to receive contacts from one or more power electronic components arranged on a circuit board or otherwise included in a PCM. Because the slits are formed in both the top and bottom portions of the capacitor, meaning that the slits face upward and downward, the capacitor can be in electrical communication with a first PCM and a second PCM. Further, the slits increase the surface area of the capacitor, which in turn can provide for more efficient heat transfer and cooling of the bus bar assembly.

There are several advantages of arranging a bus bar as a bus bar assembly that is shared between multiple PCMs in a power converter. In particular, using a shared bus bar can reduce the amount of space needed to effectively direct power that is generated from the PCMs out of the power converter (e.g., to a motor). This in turn can increase the amount of available space in a power converter for more power components, thus leading to a more efficient and powerful power converter. Correspondingly, the use of a shared bus bar assembly can also allow PCMs to be stacked on one another in a power converter, which can further increase the power density of the power convert as discussed above. In addition, the shared bus bar can be compatible with a variety of different power components, meaning that individual power components can be removed from, added to, or replaced in a PCM without having to also remove the shared bus bar.

It will be apparent to one of skill in the art that the above description is an example of a shared bus bar assembly in a power converter and that bus bars can be configured in any desired shape or combination of shapes to provide a suitable conduction path for electrical power supplied by PCMs. Accordingly, an advantage of the present disclosure is that a bus bar assembly can be coupled to multiple PCMs to provide efficient power distribution in a power converter.

As discussed above, a power electronic component can be coupled to a seat that is in fluid communication with a coolant channel to provide direct cooling to the power electronic component. Coolant may be provided in a thermal regulation system using various techniques, for example, using nozzles, coolant jets formed in a power unit housing of a power converter, directly submerging the power electronic component in coolant, and/or another suitable technique. For example, a cooling jacket can define a coolant duct therethrough which extends past or is otherwise in fluid communication with one or more power electronic components to allow coolant to flow over the power electronic components. Accordingly, a cooling jacket can be used to further regulate the temperature of power electronic components in a power converter. In some aspects, at least one power electronic component arranged on a circuit board or a PCM can be enclosed by a cooling jacket, which may be provided for a circuit board as a whole or for an individual power electronic component. In other examples, multiple cooling jackets may be provided on circuit board to cool respective components on a circuit board. For example, each cooling jacket may be associated with a circuit element or elements on a circuit board to be cooled with direct jet impingement of the liquid coolant. In some cases, cooling jackets can be provided on both sides of a circuit board.

Further, each cooling jacket on a circuit board can be enclosed by a jacket housing. To that end, a jacket housing can further secure a jacket to a circuit board and protect a jacket and a power electronic component surround by the jacket. It is contemplated that a jacket may be formed as a unitary component with a circuit board, meaning that the jacket and the circuit board can be integrally or monolithically formed with one another. For example, a jacket housing may be injection molded or a 3D-printed housing, or shell that is shaped in accordance with the power electronic component(s) being cooled, as will be discussed below in greater detail. A jacket housing can be welded, soldered, adhered, fastened, or otherwise permanently coupled to a circuit board, or a jacket housing can be removably coupled to a circuit board to allow power electronic components to be easily replaced on the circuit board. Moreover, a jacket housing can be configured in any suitable shape and can be formed as a unitary component, or a jacket housing can be arranged as a jacket housing assembly which includes differently shaped portions corresponding to the shape of the power electronic components disposed therein (e.g., an inductor-shaped portion and/or a FET-shaped portion). Thus, it will be understood that a jacket housing can have a variety of different configurations at least for the purpose of protecting a cooling jacket and/or a power electronic component on a circuit board. In some aspects, two or more jacket housings can be coupled in series, such that an outlet of a first jacket housing can be linked to an inlet of a second jacket housing. In other examples, two or more jacket housings can be coupled in parallel, such that an inlet of a first jacket housing and an inlet of a second jacket housing can be coupled to the same source of coolant (i.e., a common source of coolant) and an outlet of the first jacket housing and an outlet of the second jacket housing can be coupled to a common sump or outflow conduit.

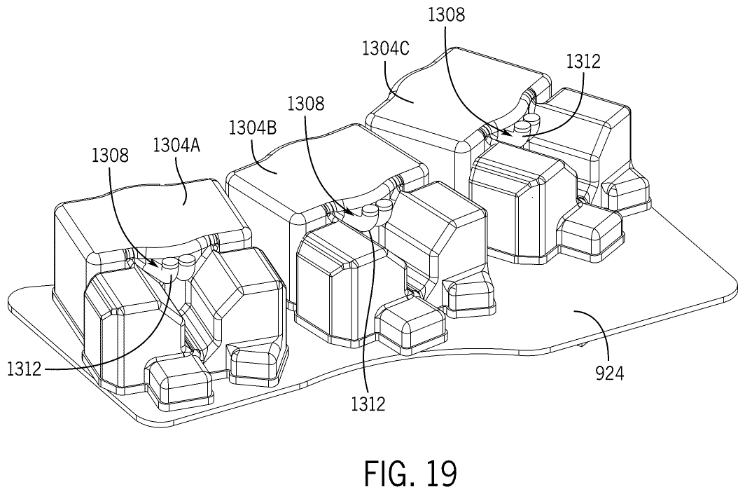

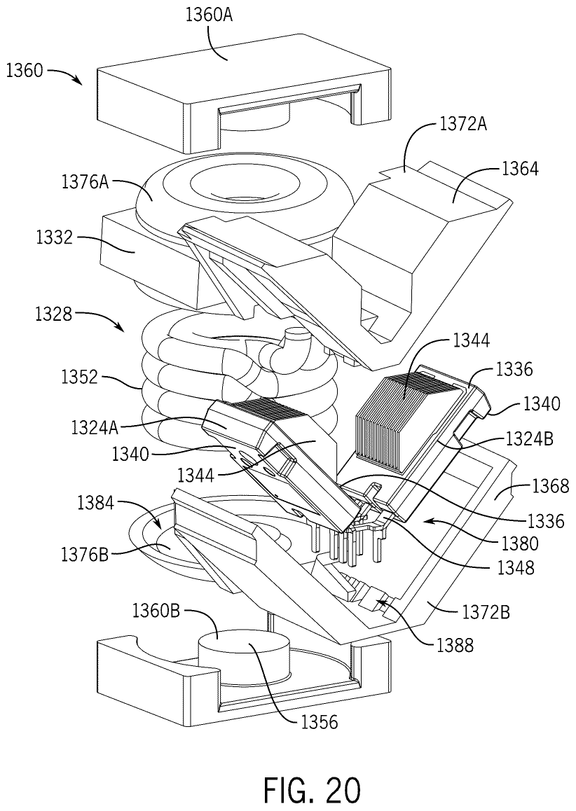

Referring now to FIG. 19, the circuit board 928 can further include includes a plurality of jacket housings 1304 that surround cooling jackets and/or power electronic components (see FIG. 20) disposed thereon. For example, the circuit board 928 can include a first jacket housing 1304A, a second jacket housing 1304B, and a third jacket housing 1304C (collectively jacket housings 1304). Each of the jacket housings 1304 may be arranged on the circuit board 928 to cover corresponding a cooling jacket and/or power electronic components (e.g., inductor coils and/or FETs, see FIG. 20). In some aspects, the jacket housings 1304 can entirely enclose the power electronic components, or the jacket housings can partially enclose the power electronic components. For example, the jacket housings 1304 may define inductor terminal ports 1308 through which terminals 1312 of the inductor coils 1352 (see FIG. 20) can pass. The inductor terminals 1312 may extend outward from the inductor coils 1352 (see FIG. 20) at an upper end of a side of the jacket housings 1304, although it is contemplated that inductor terminals may extend outward from an inductor coil along any surface or portion of a jacket housing. The inductor terminals 1312 function as the input and output of the inductor coils 1352 (see FIG. 20) and may be configured to couple to one or more other power electronic components in a power converter. In some cases, the jacket housings 1304 may be formed integrally with the circuit board 928, or the jacket housings 1304 may be coupled to the circuit board 928 using a suitable connection technique (e.g., welding, fastening, adhesives, etc.). Thus, it will be understood that a cooling jacket housing may be configured in any particular shape for at least the purpose of enclosing and/or protecting a cooling jacket of a power electronic component on a circuit board.

Correspondingly, a cooling jacket can be configured to define a profile that is similar to one or more power electronic components inside the cooling jacket. Put another way, a cooling jacket can be shaped or contoured to follow the shape of a corresponding power electronic components. For example, a cooling jacket can define portions which correspond to differently shaped power electronic components (e.g., FETs and inductor coils). It is contemplated that different portions of a cooling jacket may be formed integrally with one another, or separately, such that the cooling jacket may be configured as a cooling jacket assembly. For example, a cooling jacket may be configured as a clamshell jacket assembly including a first shell and a second shell (e.g., a top shell and a bottom shell, respectively) that can fit together to surround one or more power electronic components. In some aspects, a cooling jacket totally encloses a power electronic component, and/or a cooling jacket can define openings therein (e.g., an inlet opening, an outlet opening, terminal openings, etc.).

Further, a cooling jacket may be injection molded or a 3D-printed shell that has a form fitting shape relative to the power electronic component(s). For example, the jacket may be configured to surround the power electronic component to define a predetermined clearance or gap around the power electronic component As used herein, the clearance or gap may refer to a distance or space between the jacket and power electronic component. The particular magnitude of the clearance may vary depending on the heat transfer coefficients desired to reject a target amount of heat and the available flow rate and back pressure limitations for a given design. For example, the clearance can be set at less than about 10 millimeters (mm), less than about 5 mm, less than about 1 mm, less than about 0.75 mm, less than about 0.5 mm, or less than about 0.3 mm, or any range therein.

Correspondingly, a cooling jacket may be configured to provide a variable clearance distance between its inner surface and any of the various power electronic components it surrounds, or that may be approximately the same for all power electronic components. Further, the clearance distance between the inner surface and a circuit board surface may be different than the spacing between the inner surface of the cooling jacket and the power electronic components, or may be approximately the same.

In some aspects, the clearance can maintain high bulk velocity relative to the dissipating surfaces, yielding high heat transfer coefficients for a given flow rate. Additionally, the clearance can ensure that the pressurized, viscous coolant flows through all available paths, specifically, flowing over and near heat-dissipating components rather than bypassing them. The improved flow of the present examples occurs because, for example, the resistance to bypass components is not significantly lower than the resistance to flow over them. In some aspects, two or more cooling jackets can be coupled in series, such that an outlet of a first cooling jacket is coupled to an inlet of a second cooling jacket. In other aspects, two or more cooling jackets are coupled in parallel, such that an inlet of a first cooling jacket and an inlet of a second cooling jacket are coupled to the same source of coolant, and an outlet of the first cooling jacket and an outlet of the second cooling jacket are coupled as well.

Referring now to FIGS. 20-23, a pair of FETs 1324A, 1324B, an inductor assembly 1328, and a cooling jacket 1332 are illustrated. In some aspects, the FETs 1324 are similar to the FETs 1004, 1008, 1012, and the inductor assembly 1328 is similar to the inductor coils 1016, 1020, 1024 of FIGS. 12 and 15. Thus, it will be understood that any description of the FETs 1324 and the inductor assembly 1328 herein may be applicable to some or all other examples of FETs and inductor coils discussed herein. In some aspects, each of the FETs 1324 has a top or first side 1336 and a bottom or second side 1340 that is opposite of the first side 1336. The FETs 1324 may also have cooling fins 1344 that extend outwardly from the first side 1336 thereof to enhance heat exchange between coolant and the FETs 1324. In addition, the FETs 1324 can have one or more electrical contacts 1348, which may extend outwardly and/or downwardly therefrom. The electrical contacts 1348 can be configured to couple the FETs 1324 with one or more other electronic components (e.g., capacitors in a shared bus bar assembly as discussed above).

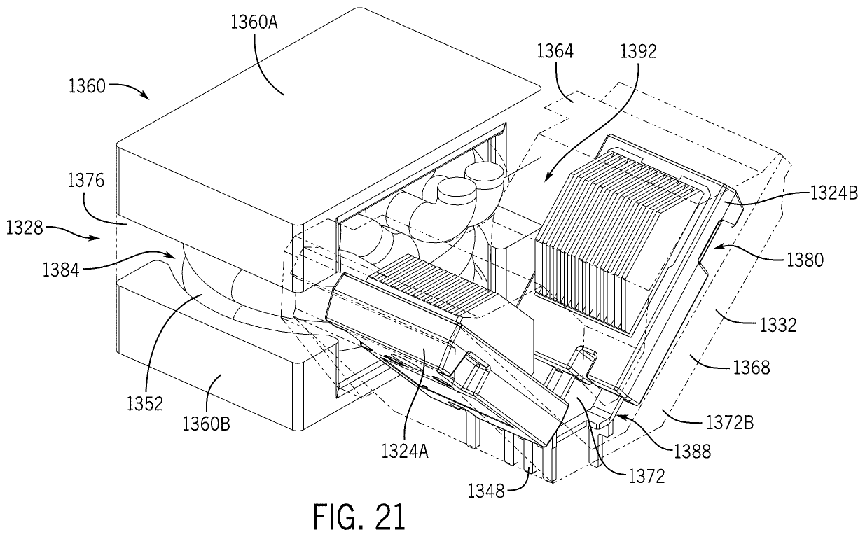

The inductor assembly 1328 can include a (copper) winding or coil 1352 that may be wound around a core. The coil 1352 and core 1356 may be disposed within a housing assembly 1360. The housing assembly 1360 includes a top or first cap 1360A and a bottom or second cap 1360B, which are positioned on either side of the coil 1352 and the core 1356. A window 1360C (see FIG. 21) can be defined between the top cap 1360A and the bottom cap 1360B such that the window 1360C (see FIG. 21) may expose the coil 1352. The inductor assembly 1328 may be for example, a “PQ” style inductor with a litz style coil. In other examples, the inductor assembly 1328 is an inductor of another type and/or includes a non-litz style coil. In addition, the core 1356 and the housing assembly 1360 can be made of any suitable material, such as, for example, a ceramic compound, an iron alloy, ferrite, or the like.

Relatedly, a cooling jacket may enclose an inductor coil and FETs to provide a flow of coolant to dissipate heat and improve system performance. For example, the cooling jacket 1332 may be configured as a clamshell jacket including a top jacket 1364 and a bottom jacket 1368. As illustrated, the cooling jacket 1332 may be configured in accordance with the shape(s) of the FETs 1324 and the inductor assembly 1328. This in turn may maintain high bulk velocity relative to dissipating surfaces thereon, as discussed above. Put another way, the cooling jacket 1332 can define a FET jacket 1372 and a coil jacket 1376. In some aspects, the FET jacket 1372 and the coil jacket 1376 can be monolithically formed with one another, or FET jacket 1372 and the coil jacket 1376 are formed separately of one another. In other examples, the top jacket 1364 can define a top FET jacket 1372A and a top coil jacket 1376A, and the bottom jacket 1368 can define a bottom FET jacket 1372B and a bottom coil jacket 1376B. Thus, it will be understood that the cooling jacket 1332 can be configured in variety of shapes for at least the purpose of creating clearance close to a pair of FETs and/or an inductor coil.

Correspondingly, the FET jacket 1372 may define a FET cavity 1380 in which the FET 1324 is seated, and the coil jacket 1376 may define a coil cavity 1384 in which the inductor assembly 1328 and/or the coil 1352 are seated. In some aspects, the FET cavity 1380 is substantially similar to the internal area 534 of the seat 528 (see FIG. 14). In addition, the cooling jacket 1332 may define one or more apertures therein which can be configured to allow the FETs 1324 and/or the inductor coil 1352 to be attached to a circuit board. For example, a cooling jacket can include apertures that are configured to allow a leg of a coil to extend therethrough and connect the inductor coil to a circuit board and/or another power electronic component. In some cases, only a single leg of an inductor coil may extend outside of a cooling jacket. In some examples, apertures formed in a cooling jacket can also be provided to receive electrical contacts of the FETs 1324. For example, the FET jacket 1372 (e.g., the bottom FET jacket 1372B) can define one or more apertures 1388 through which the electrical contacts 1348 may extend. In this way, a cooling jacket can enclose the FETs 1324 while still allowing them to be in electrical communication with one or more other components in a PCM (e.g., a shared bus bar assembly).

Moreover, it is contemplated that a cooling jacket can define a coolant duct therethrough which extends over, under, around, and/or across a power electronic component. Referring now to FIG. 21, an isometric view is illustrated of the cooling jacket 1332 fastened around the FETs 1324 and the inductor assembly 1328, with the cooling jacket 1332 being depicted with shadow lines. In some aspects, the FET jacket 1372 can fully enclose the FETs 1324, with the electrical contacts 1348 extending downward through the contact apertures 1388. Additionally, the inductor jacket 1376 may extend around the coil 1352 and may be enclosed on either side by the top cap 1360A and the bottom cap 1360B. In this way, the cooling jacket 1332 can define a coolant duct 1392, which at least partially surrounds the FETs 1324 and the inductor assembly 1328, and which can transport coolant therebetween.

Accordingly, it is contemplated that a coolant duct can be defined by the clearance between a cooling jacket and one or more power electronic components therein. Specifically, a cooling jacket can be shaped to at least partially define a coolant duct therein, which may be in fluid communication with a coolant jet, a coolant channel, a coolant path, and/or any combination thereof in a power converter. That is, a flow of coolant may be provided through a coolant path and a coolant channel before being directed to an inlet of a coolant duct defined by a cooling jacket. In this way, a power converter can have an integrated coolant path to provide cooling to power conversion units, PCMs, and/or power electronic components contained therein. In some aspects, a coolant duct can have an inlet at a first end of a cooling jacket and an outlet at a second end of a cooling jacket. Further, a coolant duct can bet provided between a pair of FETs and an inductor coil, meaning that coolant can flow over the FETs and then along the duct to the inductor coil, thereby thermally regulating the FETs and the inductor coils. In some aspects, coolant that has been cycled through the cooling jacket is sumped and returned to a pump for future cycling through an integrated coolant path as discussed above.

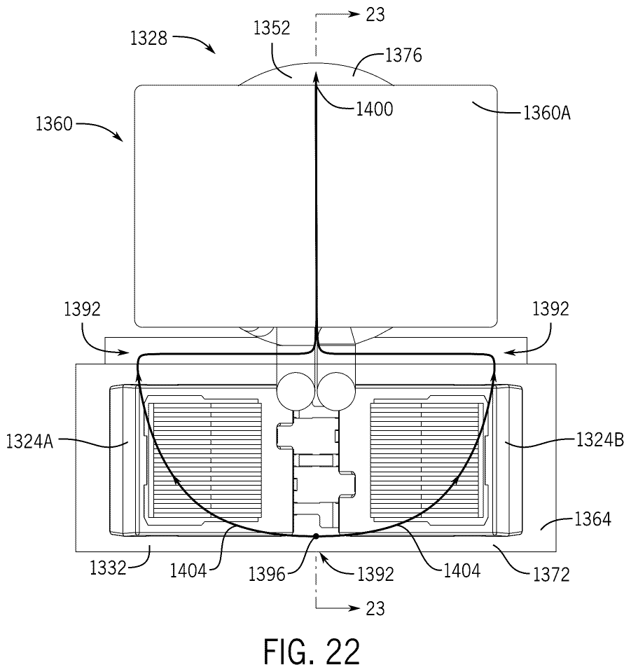

Referring now to FIG. 22, a top plan view is illustrated of the FETs 1324 and the inductor assembly 1328 surrounded by the assembled cooling jacket 1332. In some aspects, assembling the cooling jacket can include securing the top jacket 1364 to the bottom jacket 1368, for example, via ultrasonic welding, soldering, adhesives, or another suitable technique. In some examples, the coolant duct 1392 can be defined between the FETs 1324 and the cooling jacket 1332, and/or the inductor assembly 1328 and the cooling jacket 1332. Further, the cooling jacket 1332 can define a duct inlet 1396 formed in the FET jacket 1372. The duct inlet 1396 can be configured to receive a flow of coolant from a coolant jet, a coolant channel, a coolant path, and/or another coolant source. The coolant duct 1392 can include multiple separate ducts which extend diagonally across each of the FETs 1324 before converging inward in front of the inductor assembly 1328. Further, the coolant duct 1392 can surround the coil 1352 before terminating at a duct outlet 1400 formed at a rear of the coil jacket 1376. Thus, a flow of coolant, indicated by arrow 1404, can enter the coolant duct 1392 at the duct inlet 1396 and flow through the coolant duct 1392 (e.g., over the FETs 1324 and the coil 1352) before exiting the cooling jacket 1332 at the duct outlet 1400.

In some examples, the duct inlet can have a diameter that is substantially smaller (e.g., three, four, five, or more times smaller) than a diameter of a supply tube providing the coolant to the cooling jacket. Put another way, a cross-sectional area of the duct inlet can be smaller than a cross-sectional area of a supply tube, where the cross-sectional areas refer to the surface areas of imaginary two-dimensional planes that are perpendicular to the flow of the coolant fluid. Accordingly, the duct inlet may narrow the fluid flow space such that the fluid flow velocity through the inlet may be increased (relative to the velocity of the fluid through the supply tube) and, ultimately, the heat transfer coefficient (HTC) for the inductor coil provided by the coolant may be higher than would otherwise occur without the increase in velocity.

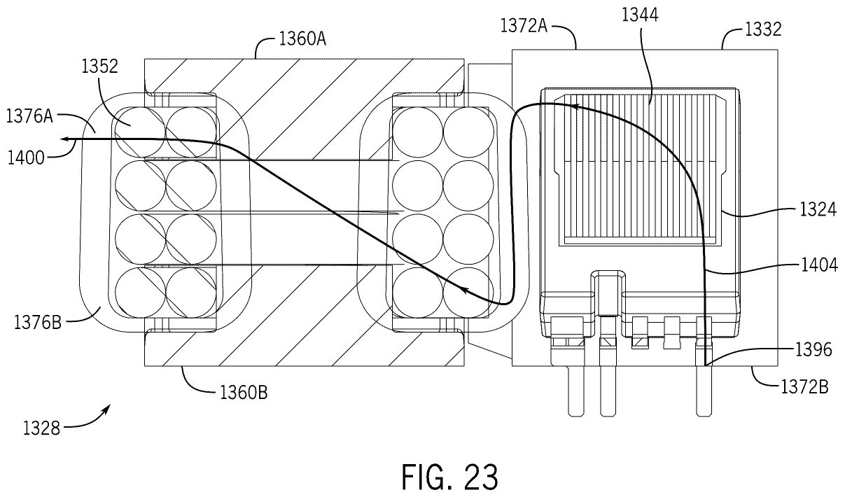

Referring now to FIG. 23, a cross-sectional side view is illustrated of the cooling jacket 1332 taken through line 23-23 of FIG. 22. In some aspects, the duct inlet 1396 can be formed in the bottom FET jacket 1372B, and the coolant duct 1392, can extend upward and across each of the FETs 1324 (e.g., across the cooling fins 1344) before extending downward in front of the inductor assembly 1328. Thus, it will be understood that the flow 1404 of coolant can be directed upward through the coolant duct 1392, upwardly across each of the FETs 1324, and downwardly toward the bottom coil jacket 1376B. Further, the flow 1404 of coolant can extend circumferentially around the coil 1352 before exiting the cooling jacket 1332 at the duct outlet 1400.

It will be understood that the above description is a non-limiting example of a coolant duct formed by a cooling jacket. Thus, it is contemplated, that a coolant duct can have a variety of different designs or configurations without departing from the scope of the present disclosure. For example, coolant may flow in different routes across multiple power electronic components, and coolant may enter and/or exit at different locations in a cooling jacket. As another non-limiting example, coolant may flow through an inductor coil before flowing across the FETs. In some examples, a coolant duct may extend into a coil cavity formed in the center of a coil, and coolant may flow through the coil cavity in addition to flowing across the FETs and the inductor coil to further facilitate cooling of the inductor coil. Thus, it will be understood that a cooling jacket can have a variety of different configurations for at least the purpose of providing a coolant duct around and/or through one or more power electronic components to facilitate thermal regulation in a PCM.

In that regard, a cooling jacket may include a variety of additional components which may define different coolant ducts than those described above. Further, different coolant ducts arrangements may be used and/or combined with those described above to enhance thermal regulation of power electronic components on a circuit board. In particular, an inductor jacket may include different arrangements of fluid inlets and/or fluid outlets, such as, for example, multiple fluid inlets and outlets, fluid inlets and outlets located on a core, and/or fluid inlets and outlets located along the sides of an inductor coil housing. In some examples, an inductor assembly may include inserts that are disposed therein (e.g., adjacently to a core and/or a coil, to direct coolant flow through the inductor coil). In other examples, components of an inductor coil (e.g., an inductor coil housing, a coil, a core, etc.) can be configured to include grooves and/or fins to further direct coolant through the inductor coil.

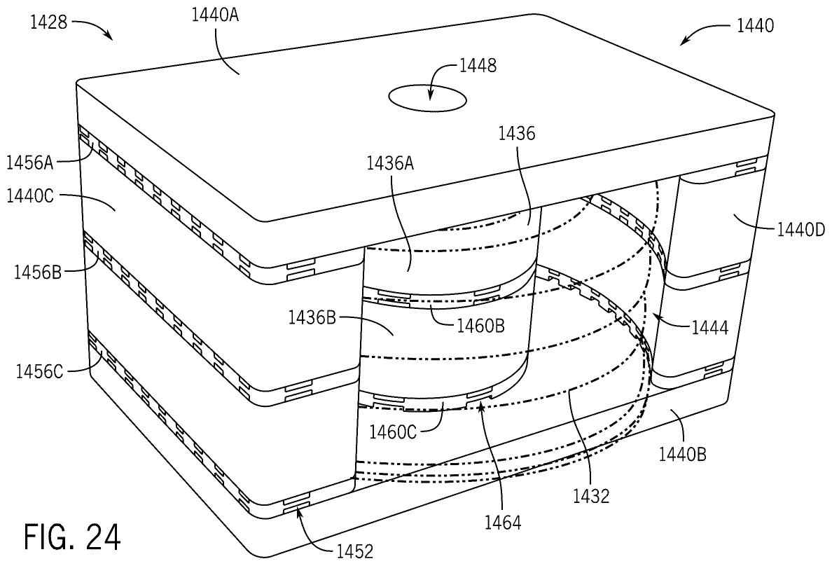

Referring now to FIG. 24, an isometric view is illustrated of an example of a power electronic component (e.g., an inductor assembly) which can include core spacers to direct coolant in and out of a core (e.g., a hollow core) of the power electronic component. Specifically, FIG. 24 illustrates an inductor assembly 1428 which includes a copper winding or coil 1432 that may be wound around a central core 1436 and disposed within a housing assembly 1440. The inductor assembly 1428 may be a “PQ” style inductor with a litz style coil. In other examples, the inductor assembly 1428 is an inductor of another type and/or includes a non-litz style coil.

In some aspects, the housing assembly 1440 includes a top cap 1440A, a bottom cap 1440B, a first side wall 1440C, and a second side wall 1440D which are positioned around the coil 1432 and the core 1436. The caps 1440A, 1440B may be similar to the caps 1360A, 1360B (see FIG. 21), or the caps 1440, 1440B can be substantially planar in shape. Further, the side walls 1440C, 1440D may each define a planar outer profile and a concavely curved inner profile relative to the core 1436. Put another way, the side walls may each have a concave inner face, which can be curved in accordance with the curvature of the coil 1432. Further, a window 1444 can be defined between the top cap 1440A and the bottom cap 1440B such that the window 1444 exposes the coil 1432. The window can define a fluid inlet and/or outlet of the housing assembly. In some aspects, an inlet port 1448 extends through the top cap 1440A and can be configured to receive a flow of coolant. Correspondingly, a plurality of side outlet ports 1452 can be defined in the side walls 1440C, 1440D to direct a flow of coolant out of the housing assembly 1440. In some aspects, the plurality of side outlet ports 1452 are ordered into rows of outlet ports (e.g., a first row 1456A, a second row 1456B, and/or a third row 1456C). Each of the side outlet ports 1452 can be arranged as any shape, such as, for example, rectangular ports, circular ports, ovular, ports, etc.

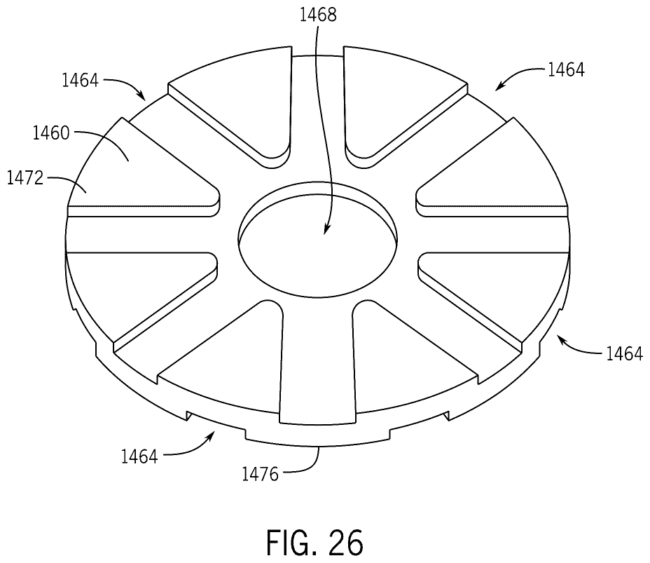

With continued reference to FIG. 24, the inductor assembly 1428 can further include one or more core spacers 1460 which are coupled to the core 1436. While the core spacers 1460 are illustrated as being circular, it is contemplated that a core spacer can be configured in any suitable shape, and the core spacer may have a similar and/or identical profile to the core. In some aspects, the core 1436 can be divided into a top core portion 1436A and a bottom core portion 1436B, which can be separated by a core spacer 1460 (e.g., the core spacer 1460 can be sandwiched between the top core portion 1436A and the bottom core portion 1436B). In other examples, core spacers can be configured differently. For example, the inductor assembly 1428 can include a first core spacer (e.g., spacer 1464, see FIG. 26) coupled between the top cap 1440A and the top core portion 1436A, a second core spacer 1460B coupled between the top core portion 1436A and the bottom core portion 1436B, and a third core spacer 1460C coupled between the bottom core portion 1436B and the bottom cap 1440B.

Further, it is contemplated that each core spacer 1460 may be axially aligned (e.g., in a direction that extends between the caps 1440A, 1440B) with the side outlet ports 1452. For example, the first core spacer can be axially aligned with the first row 1456A of side outlet ports 1452, the second core spacer 1460B can be axially aligned with the second row 1456B of side outlet ports 1452, and the third core spacer 1460C can be axially aligned with the third row 1456C of side outlet ports 1452. Moreover, a core spacer 1460 can include one or more spacer outlet ports 1464 disposed around the perimeter thereof which may enhance cooling of the core 1436. For example, the core spacers 1460 can each include a plurality of spacer outlet ports 1464 disposed circumferentially about the spacer 1460. Relatedly, it is contemplated that each of the spacer outlet ports 1464 can be arranged as any shape, such as, for example, rectangular ports, circular ports, ovular, ports, etc. The outlets ports 1464 can be formed as channels in the core spacer 1460.

In this way, the core spacers can direct coolant flow through the inductor assembly. In particular, an inductor coolant duct may be defined through the inlet port 1448, the core 1436, the core spacers 1460, the coil 1432, and the side outlet ports 1452. Put another way, coolant may be provided through the inlet port 1448 and down into the core 1436, thereby cooling the core 1436. Further, coolant may exit the core 1436 through the spacer outlet ports 1464 and be directed through the coil 1432 (e.g., in a radial direction), thereby cooling the coil 1432. Finally, coolant may exit the housing assembly 1440 through the side outlet ports 1452. In this way, thermal regulation of the core may be enhanced.

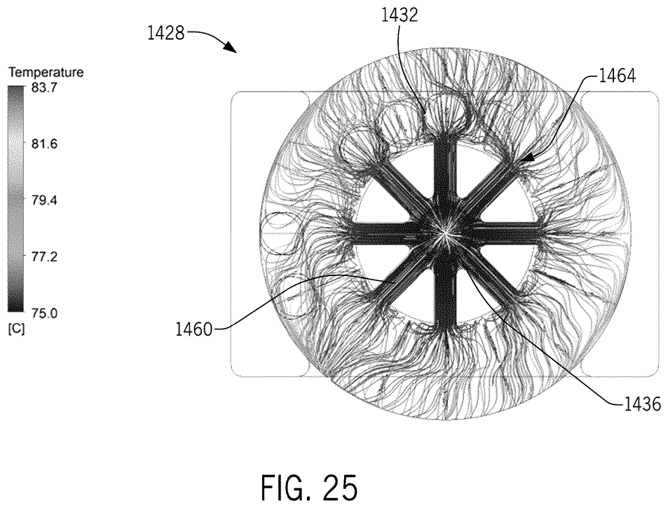

FIG. 25 illustrates a top view of a heat map of the inductor assembly 1428 including radial coolant flow through a core spacer 1460 (see FIG. 24). As illustrated, the temperature of the core 1436 and the core spacer 1460 is generally lower than the temperature of the coil since coolant can enter the core before the coil 1432. Accordingly, as the coolant passes through the coil 1432, heat generated by the coil 1432 is absorbed by the coolant. The heated coolant then exits the inductor assembly 1428, where the heat is rejected from the system.

FIG. 26 illustrates an isometric view of a core spacer (e.g., one of the core spacers 1460). The core spacer 1460 may have a substantially circular shape and can define a central aperture 1468 therethrough. When the core spacer 1460 is coupled to the core 1436 (see FIG. 24), the central aperture 1468 may be aligned with the inlet port 1448 (see FIG. 24) such that coolant may flow through the inlet port 1448 (see FIG. 24), through the central aperture 1468, and into the core 1436 (see FIG. 24). In addition, the core spacer 1460 can include a plurality of spacer outlet ports 1464. As mentioned above, the outlets ports 1464 are formed as radial channels in the core spacer 1460. The coolant can flow radially outward from the central aperture 1468 and through the outlet ports 1464. In this way, coolant can be effectively cycled through a core 1436. Moreover, the spacer outlet ports 1464 can be angled radially outward from the central aperture 1468 and may be equally spaced from one another circumferentially around the core spacer 1460. Further, the core spacer 1460 may include spacer outlet ports 1464 on either side (e.g., a top side 1472 and a bottom side 1476) thereof. In some aspects, the outlet ports 1464 disposed in the top side 1472 are offset relative to the outlet ports 1464 disposed in the bottom side 1476.

It is contemplated that a core spacer can include any number of suitable outlet ports to direct coolant from the core to the coil and/or the inductor assembly. For example, the core spacer 1460 illustrated in FIG. 26 can have eight spacer outlet ports 1464 in the top side 1472 and eight spacer outlet ports 1464 in the bottom side 1476. In other examples, the core spacer can include more or fewer than eight spacer outlet ports (e.g., between 2 and 50 spacer outlet ports, or between 4 and 20 spacer outlet ports, or between 6 and 18 spacer outlet ports, or between 12 and 18 spacer outlet ports). However, in other examples, more or fewer core spacers can be used, and the core spacers can be arranged and/or shaped differently.

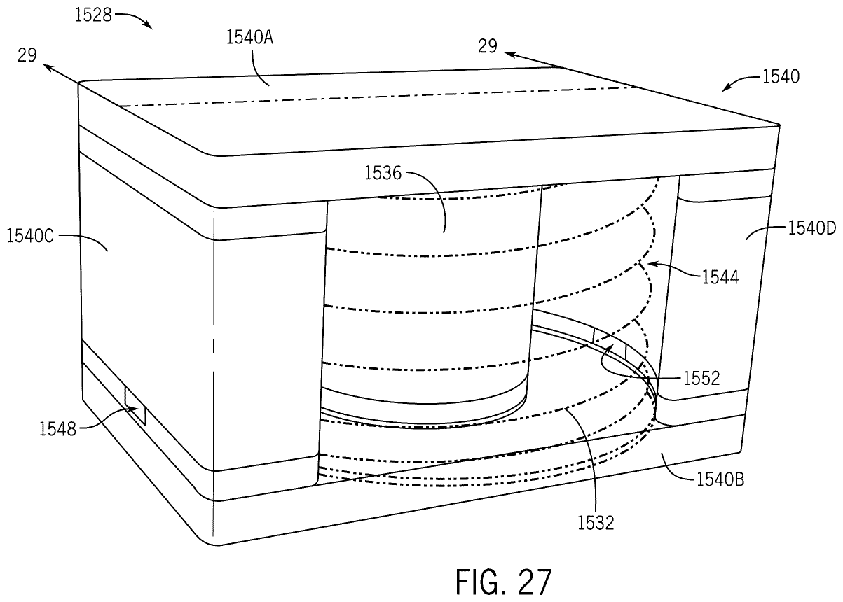

Referring now to FIG. 27 an isometric view is illustrated of another example of an inductor assembly which includes an example coolant guide disposed therein. A coolant guide can be provided to direct coolant through a coil and along a core, and/or a coolant guide may also be configured as a coil guide which protects and/or contains the coil in a fixed location in the inductor assembly. Specifically, FIG. 27 illustrates an inductor assembly 1528 which includes a copper winding or coil 1532 that may be around a central core 1536 and within a housing assembly 1540. In some aspects, the housing assembly 1540 may be substantially similar to the housing assembly 1440 (see FIG. 24), meaning that the housing assembly 1540 can have a top cap 1540A, a bottom cap 1540B, a first side wall 1540C, and a second side wall 1540D. Further, a window 1544 can be defined between the top cap 1540A and the bottom cap 1540B such that the window 1544 exposes the coil 1532. The inductor assembly 1528 may be (e.g., a “PQ” style inductor with a litz style coil). In other examples, the inductor assembly 1528 is an inductor of another type and/or includes a non-litz style coil.

In some examples, an inlet port 1548 may extend through the first side wall 1540C adjacent to the bottom cap 1540B and can be configured to receive a flow of coolant. Additionally, an outlet port 1552 may extend through the second side wall 1540D adjacent to the bottom cap 1540B and can be configured to direct a flow of coolant out of the housing assembly 1540. Alternatively, the ports 1548,1152 may each function as inlets and outlets, meaning that coolant can flow in and out through each of the ports 1548, 1552. In other examples, the window 1544 may define an inlet and/or an outlet to direct a flow of coolant in and out of the housing assembly 1540. Thus, it will be understood that coolant can be introduced and removed from the housing assembly in a variety of different ways. In addition, the housing assembly can further include a coolant guide which may be configured to direct coolant through the coil and along the core, as will be discussed below in greater detail.

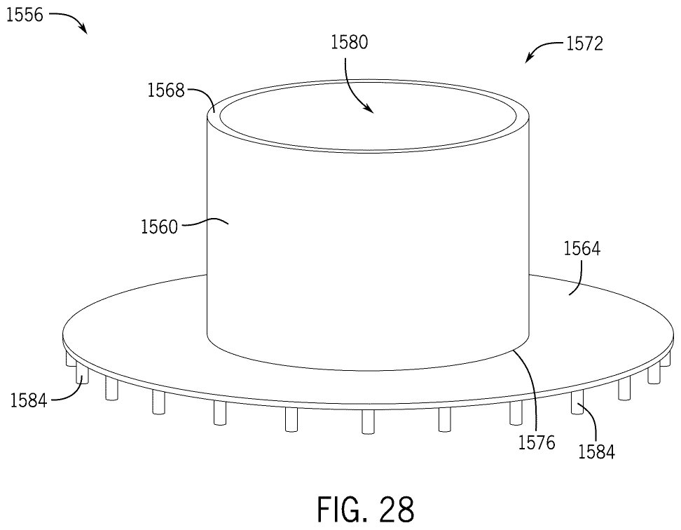

Referring now to FIG. 28, a perspective view is illustrated of an example coolant guide (e.g., a coolant guide 1556). In some aspects, the coolant guide 1556 may define a baffle wall 1560 and a base 1564 can be coupled to the baffle wall 1560. The baffle wall 1560 and the base 1564 may each define a central core aperture 1580 therethrough. The baffle wall 1560 can be formed as a cylinder or any other suitable shape, which may, in some cases, correspond to a shape of the core 1536 (see FIG. 27). The baffle wall 1560 can also define a rim 1568 that is formed at a top end 1572 thereof. Relatedly, the base 1564 may be configured as a flange which extends around a bottom end 1576 of the baffle wall 1560. The base 1564 may be configured to abut the bottom cap 1540B (see FIG. 27) when the coolant guide 1556 is arranged in the inductor assembly 1528 (see FIG. 27). Correspondingly, a plurality of pegs 1584 may extend downwardly from the base 1564. The pegs 1584 can function as standoffs that engage with the bottom cap 1540B and elevate the coolant guide 1556 from the bottom cap 1540B (see FIG. 27). It is contemplated that the coolant guide may be formed as a unitary component, meaning that the baffle wall and the base can be integrally or monolithically formed with one another.

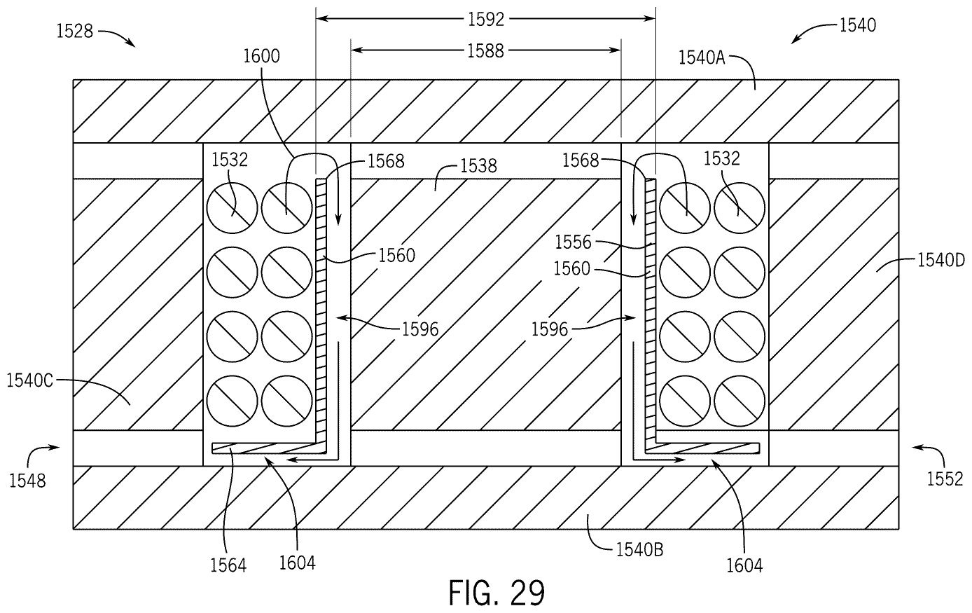

Referring now to FIG. 29, a cross sectional view is illustrated of the inductor assembly 1528 with the coolant guide 1556 disposed therein, taken through line 29-29 of FIG. 27. Specifically, the coolant guide 1556 is illustrated as being disposed radially between the coil 1532 and the core 1536, such that the core 1536 may be located inside the central core aperture 1580. However, in some aspects, the baffle wall 1560 may only extend a portion of a height of the coil 1532 measured between the top cap 1540A and the bottom cap 1540B. For example, the baffle wall 1560 may extend between about 75% and about 100%, or between about 75% and about 85%, or about 80% of the height of the coil 1532. Further, the core 1538 can define a first diameter 1588, and the baffle wall 1560 can define a second diameter 1592 that is larger than the first diameter 1588. In some aspects, the first diameter 1588 is between about 75% and about 100%, or between about 80% and about 90%, or about 88% of the second diameter 1592. In this way, an axial coolant duct 1596 can be formed between the core 1538 and the baffle wall 1560. Put another way, the axial coolant duct 1596 can be formed in the space between the core 1538 and the baffle wall 1560.

Further, and as mentioned above, the coolant guide 1556 can be elevated off of the bottom cap 1540B by the pegs 1584. In this way, the coolant guide 1556 can form a radial coolant duct within the inductor assembly 1528. The direction of coolant flow in the inductor assembly 1528 is indicated by arrows 1600. Specifically, coolant may enter the housing assembly 1540 through the inlet port 1548 and/or the outlet port before flowing radially inward through the coil 1532 and toward the core 1538. The coolant can flow upward through the coil 1532 before flowing over the rim 1568. In some aspects, coolant can directly contact the top cap 1540A. Coolant may then flow over the rim 1568 and downward through the axial coolant duct 1596 to directly cool the core 1536. In some aspects, a second radial coolant duct 1604 is defined between the bottom cap 1540B and the base 1564, and the radial coolant duct 1604 can be in fluid communication with the axial coolant duct 1596 and the ports 1548, 1552. Accordingly, coolant may flow from the axial coolant duct 1596, into the radial coolant duct 1604, and then radially outward through the ports 1548, 1552 and/or to exit the housing assembly 1540 to sump. Put another way, the axial coolant duct 1596 and the radial coolant duct 1604 may define an L-shaped coolant duct. Thus, it is an advantage of the present disclosure that a coolant guide can be used to direct coolant through an inductor assembly to thermally regulate a coil and/or a core of the inductor. It is contemplated that the above description is an example of an inductor assembly that may be compatible with a variety of different inductor jacket assemblies, such as, for example, the cooling jacket 1332 of FIG. 21 and/or the inductor assembly 1428 of FIG. 24. To that end, an inductor assembly can have alternative configurations which may further enhance thermal regulation of an inductor coil.

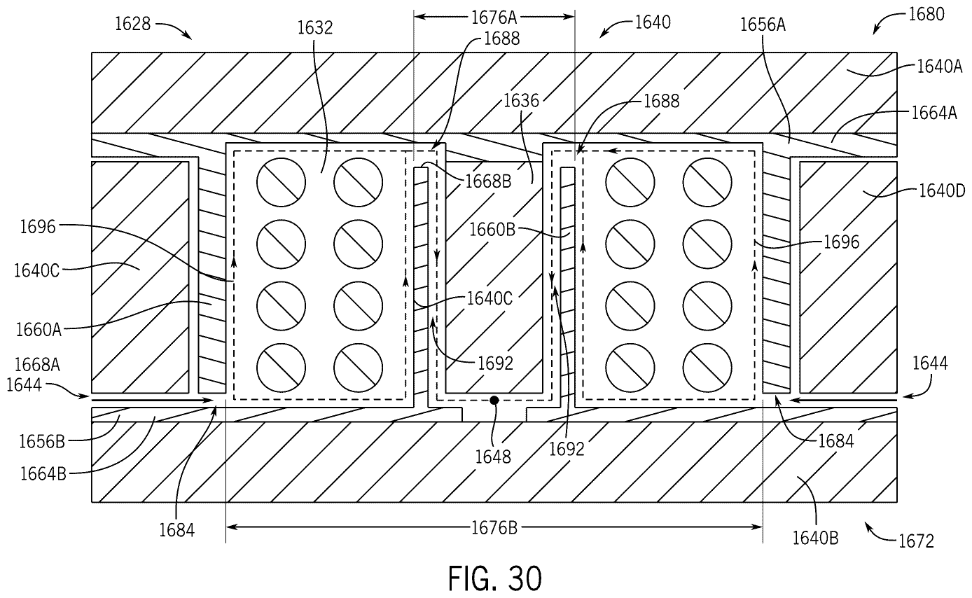

In another example of the present disclosure, a coolant guide for an inductor assembly may be configured as a multi-piece guide having a first guide and a second guide that can fit together to define a coolant duct through an inductor assembly. For example, referring now to FIG. 30, a cross sectional view is illustrated of another inductor assembly 1628 which includes a coil 1632, a core 1636, and a housing assembly 1640 (e.g., a top cap 1640A, a bottom cap 1640B, a first side wall 1640C, a second side wall 1640D). Further, the inductor assembly 1628 may include one or more radial inlet ports 1644 defined in the side walls 1640C, 1640D, and the radial inlet ports 1644 may be configured to receive coolant. Correspondingly, an outlet port 1648 may be defined axially beneath the core 1638, and the outlet port 1648 can be configured to direct a flow of coolant out of the housing assembly 1640. The outlet port 1648 may direct coolant axially downward (i.e., below the inductor assembly 1628) and/or radially outward, (e.g., out of the page with respect to FIG. 30).

The inductor assembly 1628 can further include a coolant guide 1656 having a top guide 1656A and a bottom guide 1656B (e.g., a first guide and a second guide) that can fit together to direct coolant through the inductor assembly 1628. In addition, the coolant guide 1656 can also protect and/or hold the components of the inductor assembly 1628 (e.g., to hold the coil 1632 and the core 1638 in fixed positions within the housing assembly 1640) thereby increasing the structural integrity of the inductor assembly 1628 and eliminating the need for additional fastening components. In some aspects, each of the coolant guides 1656A, 1656B may be separately formed using any suitable technique (e.g., injection molded and/or 3D printing).

Moreover, the top guide 1656A can include a first baffle wall 1660A and a first base 1664A that is coupled to the first baffle wall 1660A. The first baffle wall 1660A can be formed as a cylinder or any other suitable shape, which may correspond to the shapes of the side walls 1640C, 1640D. Further, the first baffle wall 1660A can also define a first rim 1668A, opposite the first base 1664A. Relatedly, the first base 1664A may be configured to abut the top cap 1640A, meaning that the first base 1664A can separate the top cap 1640A from the other components in the inductor assembly 1628. For example, the first base 1664A can be arranged between each of the coil 1632 and the top cap 1640A, the core 1638 and the top cap 1640A, and/or the side walls 1640C, 1640D and the top cap 1640A. Further, the first baffle wall 1660A can define a first diameter 1676A. It is contemplated that the first baffle wall and the first base can be integrally or monolithically formed with one another.

Correspondingly, the bottom guide 1656B can include a second baffle wall 1660B and a second base 1664B that is coupled to the second baffle wall 1660B. The second baffle wall 1660B can be formed as a cylinder or any other suitable shape which may correspond to the shape of the core 1636. Further, the second baffle wall 1660B can also define a second rim 1668B which is formed towards a front end 1680 of the inductor assembly 1628. Relatedly, the second base 1664B may be configured to abut the bottom cap 1640B, meaning that the second base 1664B can separate the bottom cap 1640B from the other components in the inductor assembly 1628. For example, the second base 1664B can be arranged between each of the coil 1632 and the bottom cap 1640B, the core 1638 and the bottom cap 1640B, and/or the side walls 1640C, 1640D and the bottom cap 1640B. Further, the first baffle wall 1660B can define a second diameter 1676B. In some aspects, the first diameter 1676A is between about 1% and about 50% of the second diameter 1676B, or between about 20% and about 30% of the second diameter 1676B, or about 25% of the second diameter 1676B. It is contemplated that the second baffle wall and the second base can be integrally or monolithically formed with one another, or they can be formed as separate parts.

Thus, it will be understood that the coolant guides 1656A, 1656B may define cooperating shapes. However, the first baffle wall 1660A can be arranged in between the side walls 1640C, 1640D and the coil 1632, while the second baffle wall 1660B can be arranged between the coil 1632 and the core 1636. Accordingly, the coil 1632 may be surrounded by the coolant guide 1656. Further, inlet gaps 1684 can be formed between the second base 1664B and the first rim 1668A, and the inlet gaps 1684 may be in fluid communication with the radial inlet ports 1644. Put another way, the first baffle wall 1660A may only extend along a portion of a height of the coil 1632. Further, a top gap 1688 can be formed between the first base 1664A and the second rim 1668B, meaning that the second baffle wall 1660B may only extend along a portion of a height of the coil 1632. In some aspects, the first baffle wall 1660A may directly contact the side walls 1640C, 1640D, but the second baffle wall 1660B may not directly contact the core 1636. Accordingly, an axial coolant duct 1692 can be formed between the core 1636 and the second baffle wall 1660B, and the axial coolant duct 1692 may be in fluid communication with the outlet port 1648.

Still referring to FIG. 30, the coolant guide can form a coolant duct in an inductor coil. The direction of coolant flow in the inductor assembly 1628 is indicated by dashed arrows 1696. For example, coolant may enter the inductor assembly 1628 through the inlet ports 1644 and the inlet gaps 1684 formed between the second base 1664B and the first rim 1668A before flowing through the coil 1632. In particular, coolant can flow upward through the coil 1632 (e.g., along the baffle walls 1660) before flowing through the top gap 1688 formed between the first base 1664A and the second rim 1668B (i.e., radially inward toward the core 1636). As illustrated in FIG. 30, coolant may directly contact the bases 1664 rather than the caps 1640A, 1640B. Further, coolant may flow through the top gap 1688 and downward along the axial coolant duct 1692 to directly cool the core 1636. After flowing past and/or along the core 1636, coolant may flow out of the inductor assembly 1628 through the outlet port 1648 (e.g., in a direction that is out of the page with respect to FIG. 30). Put another way, coolant may be sumped through the outlet port 1648. Thus, it is an advantage of the present disclosure that a coolant guide can be used to direct coolant through an inductor coil and secure components in an inductor coil in a fixed location. Moreover, it is contemplated that the above description is an example of an inductor assembly that may be compatible with a variety of different inductor jacket assemblies, such as, for example, the cooling jacket 1332 of FIG. 21, the inductor assembly 1428 of FIG. 24, and/or the inductor assembly 1528 of FIG. 27. To that end, an inductor assembly can have alternative configurations which may further enhance thermal regulation in a PCM.

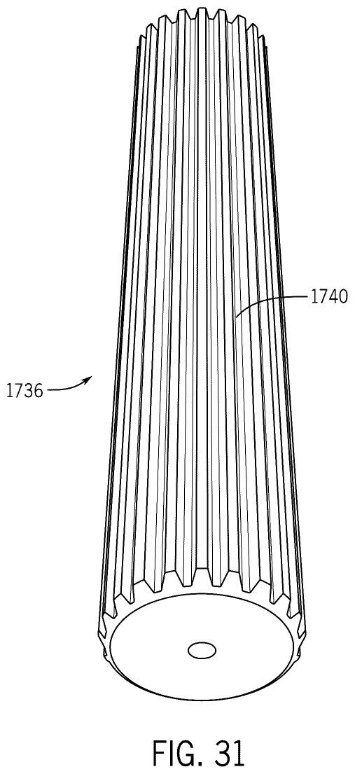

In some aspects, an inductor assembly can include additional components that are configured to optimize thermal regulation in a PCM. For example, an inductor assembly can include components with fins and/or ridges to increase the surface area thereof, which in turn may result in improved heat transfer and thermal regulation in a PCM and/or a power converter. For example, referring now to FIG. 31, a perspective view is illustrated of a core 1736 which includes a plurality of fins 1740 formed longitudinally thereon. Specifically, the plurality of fins 1740 may extend along an axial length of the core 1736. However, it will be understood that fins can be formed on a core in a variety of different ways, such as, for example, circumferential fins, spiraling fins, grid-like fins, etc. Further, it will be understood the use of fins is not limited to the core, and that any particular component in a PCM and/or power converter can be configured to increase the surface area thereof in a similar way.

As generally discussed above, there are several advantages of arranging a cooling jacket to at least partially enclose one or more power electronic components that are coupled to a circuit board in a power converter. In particular, cooling jackets can constrain the flow of the fluid to provide a fully wetted device under cooling. Limiting the coolant flow volume for a given flow rate, as proposed in some embodiments herein, is counter to traditional design, which typically relies on higher flow rates. Further, the clearance formed between the cooling jacket and the power electronic components disposed therein can yield high heat transfer coefficients for a given flow rate and ensure that that the pressurized, viscous coolant flows through all available paths, specifically, by flowing over heat-dissipating components, rather than bypassing them. Correspondingly, arranging a power electronic component to include one or more inserts (e.g., coolant spacers and/or guides) can further increase heat transfer coefficients for a given flow rate in a power electronic component. Specifically, using guides to direct coolant flow in a power electronic component flow can improve cooling of the power electronic component ensure that coolant is efficiently cycled through the power electronic component. In addition, the use of an integrated coolant path using coolant ducts formed by cooling jackets can also lead to decreased maintenance costs since coolant can be re-used in multiple components.

It will be apparent to one of skill in the art that the above descriptions are examples of cooling jackets in a power converter and that cooling jackets can be configured in any desired shape or combination of shapes to facilitate thermal regulation of power electronic components. Accordingly, an advantage of the present disclosure is that a cooling jacket can be used to enclose one or more power electronic components and fluidly coupled to an integrated coolant path in a drive unit to increase the thermal efficiency and performance of a power converter.

As discussed above, cooling fins can be used to draw heat from power electronic components (e.g., IGBT, MOSFET, and GAN switches, etc.) to enhance cooling within a power converter. Put another way, cooling fins can conduct thermal energy generated by a power electronic component away therefrom, which in turn can cool the power electronic component. To accomplish this, cooling fins can be provided to maximize the surface area that comes into contact with coolant, which in turn ensures optimal exchange of thermal energy between the fins and the coolant. That is, increasing the contact area of the fins can lead to greater thermal exchange and efficiency. In some cases, surface area can be increase by configuring a cooling fin as a three-dimensional lattice structure. The lattice structure can increase surface area for a given volume and can also define a tortuous path through the cooling fin, which can improve fluid mixing and turbulent flow that further increase heat transfer to the coolant, improving cooling. In some aspects, cooling fins are provided as part of a heatsink or conduit that is coupled to a power electronic component. For example, cooling fins may be provided as standalone fins, part of a sinusoidal heatsink, a grid-like or pin heatsink, a tortuous path heatsink, a clamshell heatsink assembly, or any combination thereof. Further, it is contemplated that cooling fins may be manufactured using any suitable conductive material such as, for example, aluminum, aluminum alloys, copper, graphite, a ceramic compound, or any combination thereof. In some examples, cooling fins are manufactured using an open-cell, closed-cell, regular foamed, and/or irregular foamed metal foam.

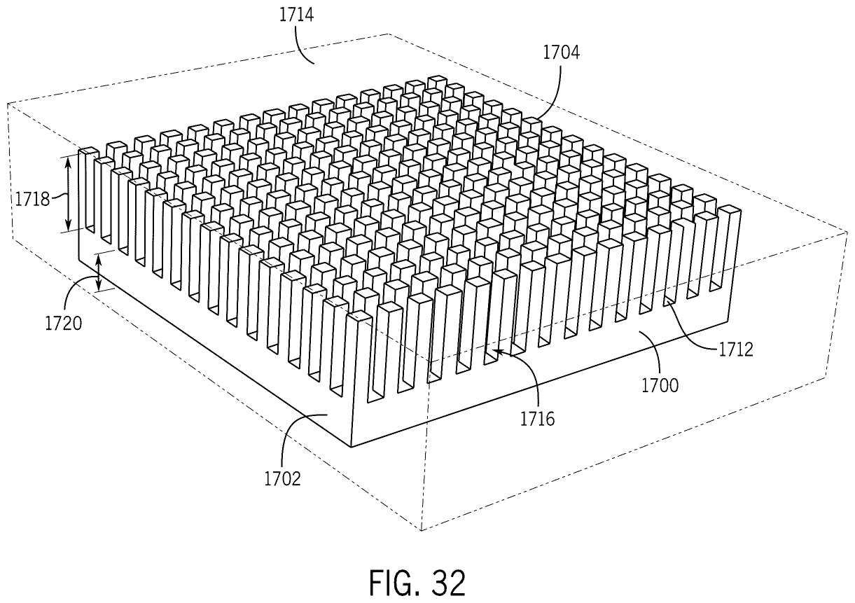

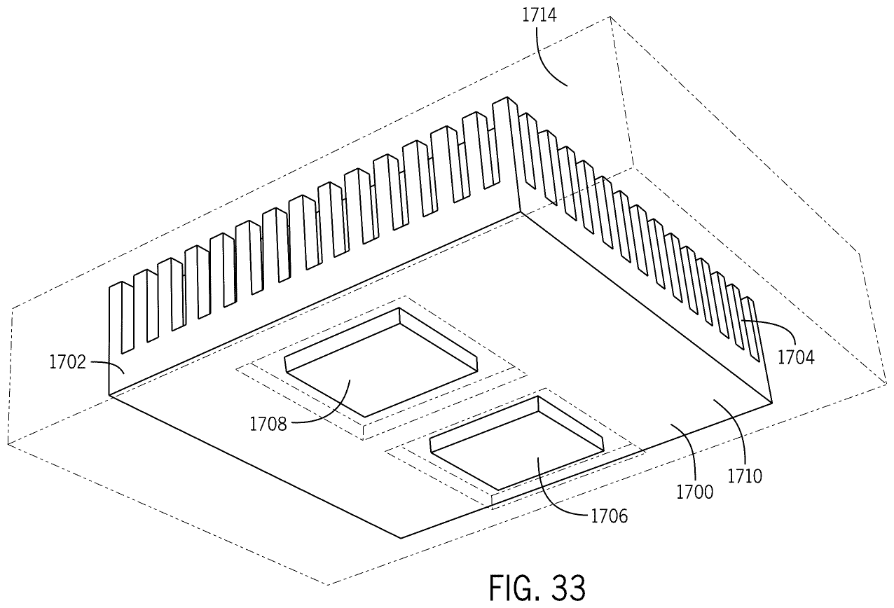

In some examples, a heatsink can be coupled directly to one or more power electronic components, and/or a heatsink can be received within a seat, as discussed above. Further, a heatsink can include a plurality of pins in a grid-like arrangement that extend upward from a base, thus increasing the surface area of the heatsink that is exposed to coolant. Referring now to the non-limiting example illustrated in FIGS. 32 and 33, a heatsink 1700 including a base 1702 and a plurality of pins 1704 extending away therefrom can be coupled to one or more power electronic components (e.g., a first FET 1706 and a second FET 1708). In particular, the FETs 1706, 1708 can be coupled to an underside 1710 of the base 1702, while the plurality of pins 1704 can extend upward from a top side 1712 of the base 1702. It is contemplated that the base 1702 and the plurality of pins 1704 may be provided as any suitable shape or combination of shapes (e.g., a square, circle, rectangle, etc.). In the illustrated non-limiting example, the base 1702 is a substantially square base and the pins 1704 are substantially rectangular in shape, which may streamline manufacturing of the heatsink 1700. Further, the heatsink 1700 may be at least partially received within a seat 1714 that is also coupled to the FETs 1706, 1708. It will be understood that the seat 1714 may be partially open on one or more sides thereof to allow coolant to enter the seat 1714 and flow through the heatsink 1700, or the seat 1714 may enclose the heatsink 1700 and define inlets/outlets to provide coolant to the heatsink 1700. Moreover, the FETs 1706, 1708 can be directly coupled to the heatsink 1700 (i.e., the underside 1710 of the base 1702), and/or the FETs 1706, 1708 may be directly coupled to the seat 1714.

In addition, the pins may comprise an array, such as a square or rectangular array (e.g., a 5×5 array, a 10×10 array, a 15×15 array, a 20×20 array, a 25×25 array, a 50×50 array, or another suitable configuration). Referring specifically to FIG. 32, the plurality of pins 1704 can be arranged in a substantially square array (i.e., an m×n array) such that a plurality of grid-like channels 1716 can be formed between the plurality of pins 1704. The channels 1716 can define coolant flow paths through the heatsink 1700 such that coolant can flow past (i.e., contact) the plurality of pins 1704, thereby leading to more efficient thermal regulation of the heatsink 1700, and by extension the FETs 1706, 1708. That is, coolant may contact each side of each pin in the plurality of pins 1704 to improve heat exchange with the heatsink 1700. Relatedly, the plurality of pins 1704 may serve as baffle walls to direct coolant through the heatsink 1700 and increase coolant mixing within the heatsink 1700, which in turn can further enhance thermal exchange by disrupting any thermal boundary layers that develop in the coolant as it absorbs heat from the heatsink 1700.

In some examples, a pin of the plurality of pins can define a first height that is greater than a second height defined by the base of the heatsink. In the illustrated non-limiting example, a pin of the plurality of pins 1704 defines a first height 1718 that is measured from the top side 1712 of the base 1702 to a distal end of the pin, and the base 1702 can define a second height 1720 that is measured from the underside 1710 (see FIG. 33) thereof to the top side 1712 thereof. In some aspects, the second height 1720 is between about 20% and about 80% of the first height 1718, or between about 20% and about 60% of the first height 1718, or between about 30% and about 50% of the first height 1718, or about 40% of the first height 1718.

In some examples, a heatsink can define one or more tortuous paths and can be coupled to one or more power electronic components to facilitate thermal efficiency within a power converter. It will be understood that a “tortuous path” as used herein may refer to a fluid pathway (e.g., a coolant pathway) that has a winding profile defined by a plurality of turns between an inlet and an outlet, as well as cross-flow between different pathways. Thus, a tortuous path heatsink may include one or more tortuous paths through which coolant may be directed to improve thermal management of the heatsink and any power electronic components that are coupled thereto. Moreover, the profile of a fluid pathway within a tortuous path heatsink may be designed to increase the total distance travelled by coolant within the heatsink and the surface area of the heatsink that may come into contact with coolant, which in turn may improve thermal energy exchange between the heatsink and the coolant. In addition, a tortuous path can reduce thermal boundary layer formation in coolant circulating through a heatsink by promoting greater mixing, thus further enhancing cooling efficiency. Further, coupling a heatsink that includes tortuous paths to power electronic components allows the components to achieve a higher maximum continuous current in comparison with use of conventional heatsinks. Additionally, this advantage of higher maximum continuous current may be increased or amplified as the flow rate of coolant fluid through the heatsink increases. That is, a tortuous path heatsink can maintain a coupled component at a lower temperature at high continuous currents in comparison with those achievable with conventional heatsinks, thus further enhancing power output and efficiency. For example, in one example testing, a heatsink including tortuous paths, as described herein, enabled an increase of between 30-40% in maximum continuous current of coupled power electronic components (e.g., four FETs) compared to use of a pin-based heatsink, where the particular increase varied based on a coolant fluid flow rate that ranged from 1 liter per minute to six liters per minute.

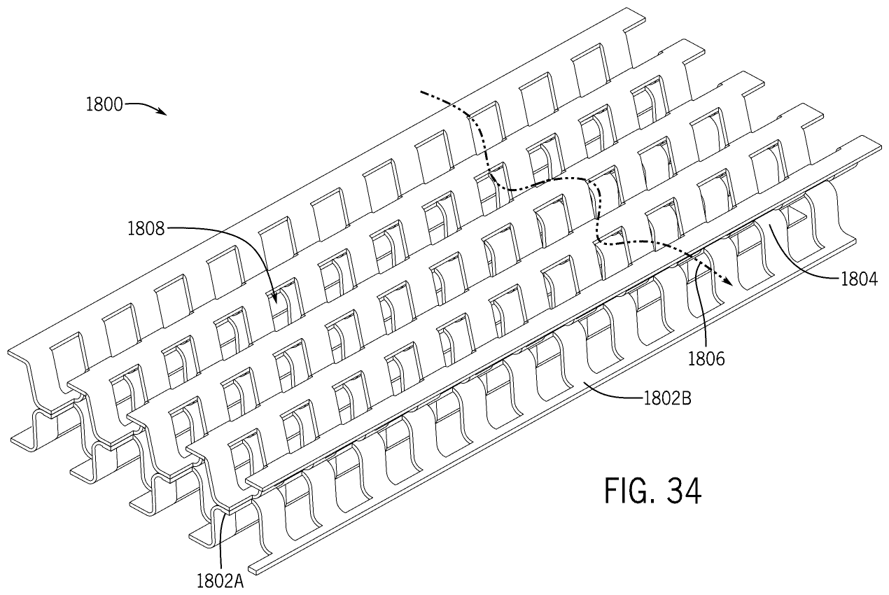

Referring now to the non-limiting example illustrated in FIG. 34, an example heatsink 1800 can include one or more rails 1802 that are coupled to one or more connectors 1804 to define a tortuous path 1806 through the heatsink 1800. In some examples, the connectors 1804 may be spaced apart from one another and staggered along the direction of flow to define gaps 1808 therebetween, which can define the tortuous path(s) 1806 through the heatsink 1800. That is, coolant can weave in and out of the gaps 1808 as it flows through the heatsink 1800, contacting and absorbing heat from the rails 1802 and connectors 1804 to regulate the temperature of the heatsink 1800. In some examples, the connectors 1804 are sinusoidal in shape. In particular, a connector 1804 can be coupled to a first rail 1802A at one end thereof and a second rail 1802B at a second (i.e., opposite) end thereof, and the connector 1804 can curve convexly away from the first rail 1802A at the first end thereof before reaching an inflection point and then curving concavely toward the second rail 1802B from the inflection point. In this way, a heatsink can define a substantially sinusoidal profile. Moreover, the connectors 1804 and gaps 1808 may be arranged in a repeating pattern, which in turn can simplify manufacture of the heatsink 1800 and allow heatsinks to be designed to achieve particular cooling profiles within a power converter. For example, such heat sicks can be stamped and bent from sheet metal. Additionally, such heat sinks can be coupled in layers to form a three-dimensional lattice structure, with rails of a first heatsink coupled to rails of a second heat sink in a stacked configuration.

To that end, the heatsink can be a scalable or modular heatsink that can be extended to reach any desired length to provide a particular thermal regulation profile in a power converter. That is, a length of the rails 1802 can be increased to allow more connectors 1804 to be coupled therebetween, thus increasing the surface area of the heatsink 1800. In some examples, the heatsink can be manufactured from steel, aluminum, or another metal such that the heatsink is thermally and electrically conductive.

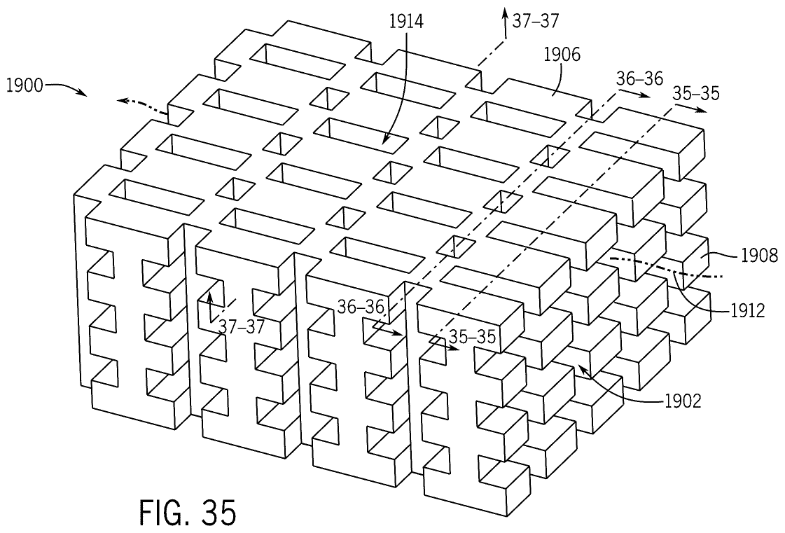

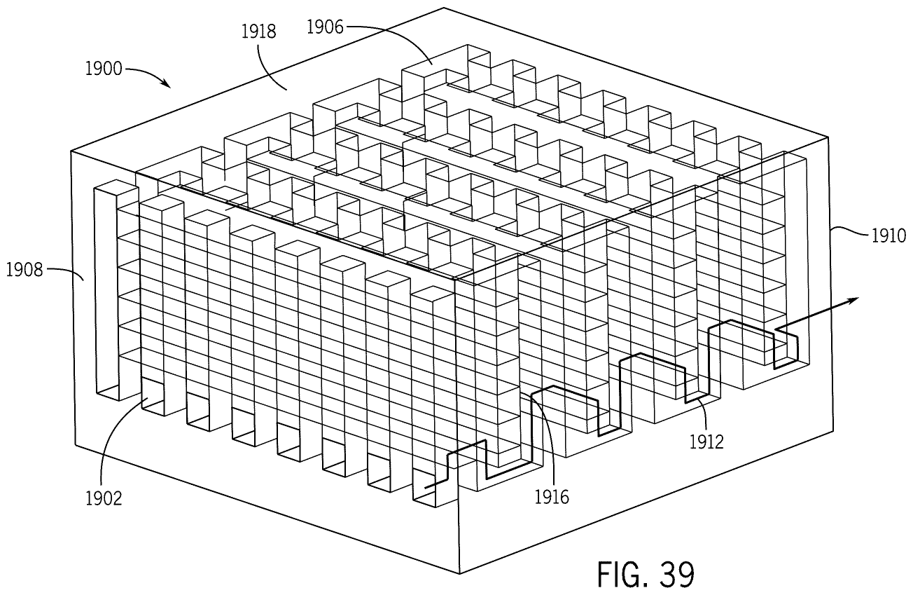

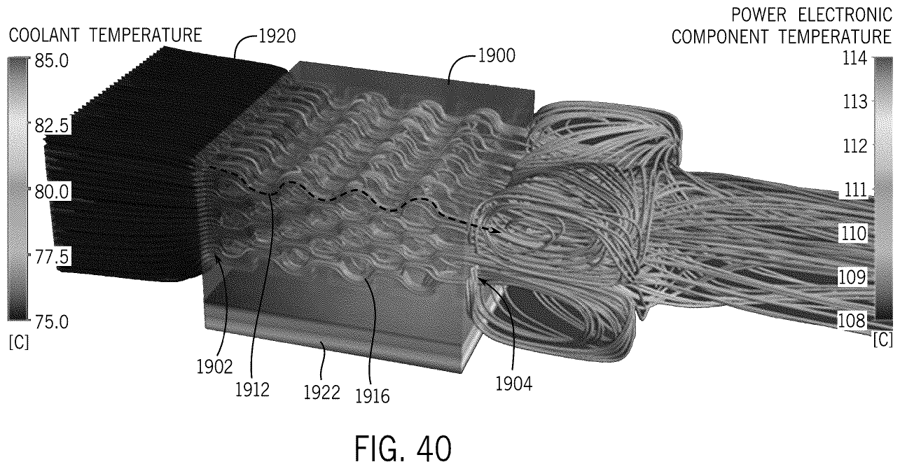

Relatedly, a heatsink may define a variety of different coolant paths (e.g., tortuous paths) therethrough (see e.g., FIGS. 39 and 40). Referring now to the non-limiting examples illustrated in FIGS. 35-39, another example heatsink (e.g., a tortuous path heatsink 1900) can include a plurality of inlets 1902 and a plurality of outlets 1904 (see FIG. 40) that may be formed as slots within a body 1906 of the heatsink 1900. In particular, the inlets 1902 can be defined on a first side 1908 of the tortuous path heatsink 1900, and the outlets 1904 can be defined on a second side 1910 (see FIG. 40) of the tortuous path heatsink 1900 that is opposite the first side 1908. Correspondingly at least one tortuous path 1912 can extend between the inlets 1902 and the outlets 1904 (see FIG. 40) (i.e., between the first side 1908 and the second side 1910). In some aspects, a tortuous path 1912 can be formed by one or more cavities 1914 defined in the body 1906, and the tortuous path 1912 can define a serpentine or wave-like profile as it extends toward the second side 1910 (see FIG. 40) of the tortuous path heatsink 1900. It is contemplated that the tortuous path heatsink may include any number of suitable inlets, outlets, and/or tortuous paths to promote thermal efficiency within a power converter. In some cases, fluid can flow along a variety of paths from any inlet or subset of inlets, to any outlet or subset of outlets. In some cases, flow along particular paths may vary depending on operational conditions, for example, fluid pressure or flow rate.

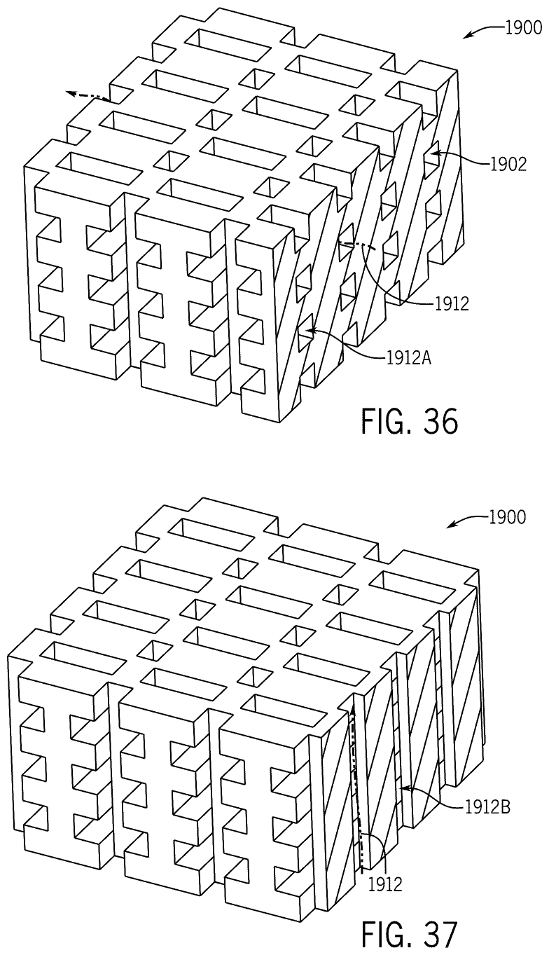

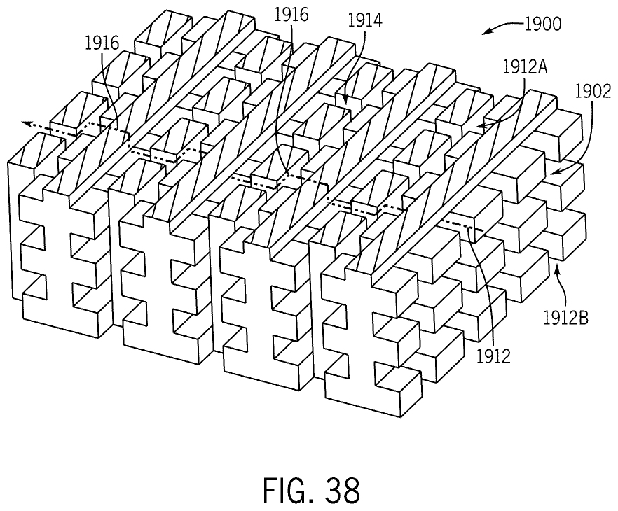

Correspondingly, inlets, outlets, and tortuous paths may be arranged in a grid-like configuration (i.e., an array) within a tortuous path heatsink. For example, and with particular reference to FIG. 36, the inlets 1902 can be arranged in a 4×4 array. As shown, the inlets 1902 open into the tortuous paths 1912 that can extend toward the second side 1910 (see FIG. 40) of the heatsink 1900 (i.e., in a horizontal direction) Put another way, the tortuous paths 1912 can include horizontal channels 1912A. However, portions of the tortuous paths 1912 may also extend in a vertical direction, as illustrated in FIG. 37. That is, the tortuous paths 1912 can also include vertical channels 1912B, and intersections between the horizontal channels 1912A and the vertical channels 1912B can form a plurality of turns 1916 (e.g., alternating 90 degree turns) that change the direction of coolant as it flows through the heatsink 1900. Correspondingly, changing the direction of coolant can increase the distance travelled by coolant through the heatsink 1900, promote mixing, and reduce thermal boundary layer formation, thus further improving thermal efficiency within the heatsink 1900. Accordingly, and as illustrated in FIG. 38, the tortuous paths 1912 can include the horizontal channels 1912A and the vertical channels 1912B to facilitate improved thermal exchange within the heatsink 1900. For example, coolant can enter a tortuous path 1912 at the inlet 1902 and travel along a horizontal direction (i.e., along a horizontal channel 1912A) before encountering a turn 1916 (e.g., a wall) and then flowing along a vertical direction (i.e., along a vertical channel 1912B). Coolant flow may continue to alternate in direction before exiting the heatsink 1900 at the outlet 1904 (see FIG. 40), which can increase the surface area of the heatsink 1900 that comes into contact with coolant.

Relatedly, a heatsink can include a housing or outer shell to further increase the contact area between the heatsink and coolant. As illustrated in the non-limiting example of FIG. 39, the heatsink 1900 can be enclosed by an outer shell 1918 that is configured to define a clearance around the body 1906 of the heatsink 1900. As coolant enters the inlets 1902, some coolant may flow over the body 1906 through a duct defined by the clearance between the body 1906 and the outer shell 1918, which can facilitate faster cooling of the heatsink 1900, and by extension any power electronic components coupled to the heatsink 1900. In some examples, the tortuous paths 1912 may be in fluid communication with the clearance formed between the body 1906 and the outer shell 1918 (e.g., via the cavities 1914 defined in the body 1906). It is contemplated that the outer shell 1918 may share the inlets 1902 and/or outlets 1904 with the body 1906, or the outer shell 1918 may define additional inlets and/or outlets.

As discussed above, the profiles of coolant paths in a heatsink may be provided to enhance cooling of power electronic components within a power converter. In particular, tortuous paths may include winding (e.g., serpentine) profiles to increase coolant travel distance through a heatsink, meaning that coolant comes into contact with more surface area of the heatsink, thereby allowing for more efficient heat absorption by the coolant. Put another way, increasing the surface area of a heatsink that comes into contact with coolant can increase the thermal energy exchange between the coolant and the heatsink. Referring now to FIG. 40, an example heat map is illustrated of thermal energy exchange between the tortuous path heatsink 1900 and a flow of coolant 1920. As discussed above, a power electronic component 1922 (e.g., IGBT, MOSFET, and GAN switches, etc.) can be coupled to the heatsink 1900, and the heatsink 1900 can be configured to draw thermal energy from the power electronic component 1922 to regulate the temperature thereof. To accomplish this, the coolant 1920 can enter the tortuous path heatsink 1900 at each of the inlets 1902, flow through the tortuous paths 1912, and exit the tortuous path heatsink 1900 at each of the outlets 1904. The coolant 1920 can absorb heat from the heatsink 1900 as the coolant 1920 flows through the tortuous paths 1912, thereby reducing a temperature of the heatsink 1900. Accordingly, the temperature of the power electronic component 1922 can also be reduced.

In addition, the profiles of the tortuous paths promote turbulent flow within the tortuous path heatsink, which further enhances cooling efficiency. As discussed above, the tortuous paths 1912 can include a plurality of turns 1916 that can increase the total distance travelled by coolant within the tortuous path heatsink 1900 and disrupt thermal boundary layer formation. It is contemplated that a plurality of turns can include sharp turns, rounded or curved turns, alternating turns, and/or any combination thereof. In the illustrated non-limiting example, the plurality of turns 1916 can be implemented as sharp (e.g., 90 degree) turns that may disrupt laminar flow of the coolant 1920 as the coolant 1920 is directed through the tortuous paths 1912, thus reducing development of a thermal boundary layer within the coolant 1920 (i.e., the coolant 1920 in direct contact with surfaces of the tortuous paths 1912). In this way, the profiles of the tortuous paths 1912 can encourage mixing within the flow of coolant 1920 to homogenize the temperature of the coolant 1920 that contacts surfaces of the tortuous path heatsink 1900. That is, the profiles of the tortuous paths 1912 can prevent hot spots from developing within the tortuous path heatsink 1900, thereby resulting in a more uniform temperature distribution across the heatsink 1900 and, by extension, the power electronic component 1922.

Further, a heatsink may be manufactured using a metal foaming technique to create a solid metal matrix (e.g., comprised of rails and connectors) with gas filled-pores (e.g., gaps) distributed throughout the matrix. Specifically, the heatsink can be manufactured using open-cell or closed-cell metal foaming techniques to further increase the surface area of the heatsink while reducing weight and manufacturing costs due to high replicability. This in turn can streamline production of the heatsink, the power converter, and the drive unit as a whole. However, it will be understood that a heatsink can be manufactured using a variety of suitable techniques, such as casting, die casting, extrusion, stamping, machining, forging, powder metallurgy, 3D printing, injection molding, metal foaming, etc.

As discussed above, a cooling jacket can be used to enclose a power electronic component such that a coolant duct (i.e., a path for coolant to travel) is defined by clearance between the cooling jacket and the power electronic component. In some examples, a cooling jacket can also be used to enclose a cooling fin (e.g., a heatsink) that is coupled to a power electronic component to direct coolant therethrough and/or create additional coolant ducts to further facilitate thermal exchange within a power converter or a power conversion unit. For example, a cooling fin may define a first coolant duct therethrough, and clearance between an exterior surface of the cooling fin and a cooling jacket may define a second coolant duct. Put another way, coolant may flow through the cooling fin (e.g., through the first coolant duct) and around the exterior of the cooling fin (e.g., through the second coolant duct). As a result, use of a cooling jacket can increase the surface area of a cooling fin that comes into contact with coolant, thus leading to more rapid cooling and greater thermal efficiency. In some aspects, a cooling jacket can be provided as a jacket assembly, as discussed above.

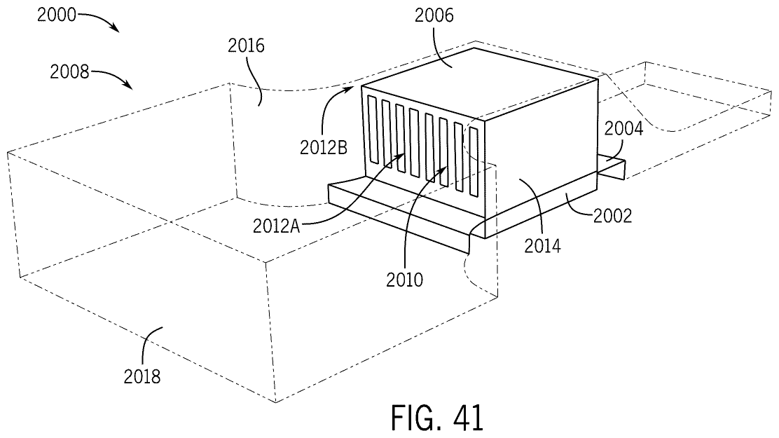

Referring now to FIG. 41, a thermal regulation system 2000 can include a power electronic component 2002, a seat 2004, a cooling fin 2006 (i.e., a heatsink), and a cooling jacket assembly 2008. Specifically, the power electronic component 2002 can be coupled to a first side of the seat 2004, and the cooling fin 2006 can be coupled to a second side of the seat 2004 that is opposite the first side. It is contemplated that the cooling fin may be provided as a heatsinking element such as those discussed above (e.g., a pin heatsink, a tortuous path heatsink, a standalone cooling fin, etc.). For example, the cooling fin 2006 can include a plurality of slots 2010 that extend therethrough to define a first coolant duct 2012A through the cooling fin 2006 (i.e., through an interior of the cooling fin 2006). Further, the cooling jacket assembly 2008 can be configured to enclose at least the cooling fin 2006 and the second side of the seat 2004 to define a second coolant duct 2012B in the clearance between the cooling fin 2006 and the cooling jacket assembly 2008. Put another way, the second coolant duct 2012B can be formed between the cooling jacket assembly 2008 and an exterior surface 2014 of the cooling fin 2006. Thus, when a flow of coolant is received by the cooling jacket assembly 2008, coolant can flow both through the cooling fin 2006 (via the first coolant duct 2012A) and over the cooling fin 2006 (via the second coolant duct 2012B). In this way, the total surface area of the cooling fin 2006 that comes into contact with coolant can be increased, thus enhancing thermal regulation of the cooling fin 2006 and the power electronic component 2002.

In some examples, the cooling jacket assembly includes multiple components that are arranged to cover the cooling fin and define the coolant ducts. In the non-limiting example, the cooling jacket assembly 2008 is a clamshell assembly that includes a first or top jacket 2016 and a second or bottom jacket 2018. The first jacket 2016 can be configured to cover the second side of the seat 2004 and the cooling fin 2006. Further, the first jacket 2016 may be a separate housing, or the first jacket 2016 may be a portion of the power unit housing 904 (see FIG. 12). The second jacket 2018 can be configured to couple to the first jacket 2016 to fully enclose the cooling fin 2006. In some examples, the second jacket 2018 can be a PCB (e.g., the first PCB 928, see FIG. 12), and the seat 2004 can be unitary with the second jacket 2018 such that the power electronic component 2002 is coupled to the second jacket 2018. To create the second coolant duct 2012B, the first jacket 2016 can be configured to cover the cooling fin 2006 by coupling to the second jacket 2018. Put another way, the cooling jacket assembly can be a clamshell assembly such that the first and second jackets can fit together to surround the cooling fin.

There are several advantages of implementing a cooling fin as a heatsink and using coolant ducts to direct coolant therethrough. In particular, using a heatsink can increase the total surface area of the cooling fin that comes into contact with coolant, which in turn can lead to faster, more efficient cooling within a power converter. Specifically, the cooling fins discussed herein can provide more efficient thermal exchange with circulating coolant, thus providing more efficient thermal management of power electronic components that are in thermal communication with the cooling fins. In addition, the use of an integrated coolant path using coolant ducts formed by cooling jackets can also lead to decreased operating costs since coolant can be re-used in multiple components.

It will be apparent to one of skill in the art that the above descriptions are examples of cooling fins in a power converter and that cooling fins can be configured in any desired shape(s) and comprise any desired material(s) to promote efficient thermal regulation of power electronic components. Accordingly, an advantage of the present disclosure is that a cooling fin can be implemented as a heatsink to enhance cooling and provide coolant ducts that are part of an integrated coolant path in a drive unit to increase the thermal efficiency and performance of a power converter.

As used in the claims, the phrase “at least one of A, B, and C” means at least one of A, at least one of B, and/or at least one of C, or any one of A, B, or C or combination of A, B, or C. A, B, and C are elements of a list, and A, B, and C may be anything contained in the Specification.

The present invention has been described in terms of one or more preferred embodiments, and it should be appreciated that many equivalents, alternatives, variations, and modifications, aside from those expressly stated, are possible and within the scope of the invention. For example, it will be appreciated that all preferred features described herein are applicable to all aspects of the invention described herein.

Thus, while the invention has been described in connection with particular embodiments and examples, the invention is not necessarily so limited, and that numerous other embodiments, examples, uses, modifications and departures from the embodiments, examples and uses are intended to be encompassed by the claims attached hereto. The entire disclosure of each patent and publication cited herein is incorporated by reference, as if each such patent or publication were individually incorporated by reference herein.

Various features and advantages of the invention are set forth in the following claims.

### FURTHER EXAMPLES

Example 1: A drive unit for an electric vehicle, the drive unit comprising: a transmission; a motor operatively coupled to the transmission; and a power converter configured to supply electrical power to the motor, the power converter including a housing that is secured to at least one of the transmission and the motor.

Example 2: The drive unit of Example 1, wherein the housing is shaped corresponding to a shape of the motor so that the housing at least partially surrounds the motor.

Example 3: The drive unit of Examples 1 or 2, wherein the motor extends away from a first side of the transmission along a motor axis, and wherein the power converter extends parallel to the motor axis.

Example 4: The drive unit of Examples 1 to 3, wherein the transmission includes an input configured to operatively couple to the motor and an output configured to operatively couple to a drive shaft, the input defining an input axis and the output defining an output axis, and wherein the power converter is positioned between the input axis and the output axis.

Example 5: The drive unit of Example 4, wherein the housing defines a first cylindrically concave side that is contoured around the input axis.

Example 6: The drive unit of Examples 4 or 5, wherein the housing is shaped corresponding to a shape of the output so that the housing at least partially surrounds the output.

Example 7: The drive unit of Example 6, wherein the housing defines a second cylindrically concave side that is contoured around the output axis.

Example 8: The drive unit of Examples 1 to 7, wherein the power converter defines a first coolant path that is in fluid commination with at least one of a second coolant path of the transmission and a third coolant path of the motor.

Example 9: The drive unit of Examples 8, wherein a coolant is configured to flow from the transmission to the power converter and from the power converter to the motor.

Example 10: The drive unit of Examples 1 to 9, wherein the power converter includes a plurality of power conversion modules configured to provide electrical power to the motor at a plurality of discrete maximum power levels.

Example 11: The drive unit of Examples 1 to 10, wherein the power converter is a modular power converter that includes a first power conversion unit and a second power conversion unit that are configured to couple to one another, each of the first power conversion unit and the second power conversion unit including a unit housing and a power conversion module disposed within the unit housing.

Example 12: The drive unit of Example 11, wherein the first power conversion unit and the second power conversion unit are selectively operable to provide power to the motor.

Example 13: The drive unit of Examples 11 or 12, further comprising an electronic controller configured to selectively operate each of the first power conversion unit and the second power conversion unit based on an operational parameter of the drive unit.

Example 14: The drive unit of Examples 11 to 13, wherein the first power conversion unit and the second power conversion unit are coupled in stacked configuration to extend parallel to a motor axis.

Example 15: The drive unit of Examples 11 to 14, wherein the power conversion module of at least one of the first power conversion unit and the second power conversion unit is configured operate in a charging mode to supply electrical power to a battery.

Example 16: The drive unit of Examples 11 to 15, wherein the housing of the first power conversion unit defines a first external recess and the housing of the second power conversion unit defines a second external recess, the first external recess and the second external recess collectively forming a shared coolant channel between the first power conversion unit and the second power conversion unit.

Example 17: The drive unit of Examples 1 to 16, further comprising an end cap configured to couple to both the motor and the power converter, wherein the motor and the power converter are secured between the end cap and the transmission.

Example 18. A modular power converter, comprising: a first power conversion unit including a first power conversion module disposed within a first housing, the first housing defining a first external recess; and a second power conversion unit including a second power conversion module disposed within a second housing, the second housing defining a second external recess and being configured to couple to the first housing so that the first external recess and the second external recess collectively define a first coolant channel between the first housing and the second housing.

Example 19: The modular power converter of Example 18, wherein at least one of the first power conversion module and the second power conversion module are configured to collectively operate as both an inverter and a charger.

Example 20: The modular power converter of Examples 18 or 19, wherein at least one of the first power conversion module and the second power conversion module is configured to operate as both an inverter and a charger.

Example 21: The modular power converter of Examples 18 to 19, wherein at least one of the first power conversion module and the second power conversion module is configured to operate as a three-phase inverter.

Example 22: The modular power converter of Examples 18 to 21, wherein the second housing further defines a third external recess opposite the second external recess.

Example 23: The modular power converter of Example 22 further comprising a cover plate configured to couple to the second housing to cover the third external recess to define a second coolant channel between the second housing and the cover plate.

Example 24: The modular power converter of Examples 18 to 23 further comprising a third power conversion unit including a third power conversion module disposed within a third housing, the third housing defining a fourth external recess and being configured to couple to the second housing so that the third external recess and the fourth external recess collectively define a second coolant channel between the second housing and the third housing.

Example 25: The modular power converter of Examples 18 to 24, wherein the first power conversion unit further includes a third power conversion module disposed within the first housing, the third power conversion module arranged in an opposed configuration with the first power conversion module.

Example 26: A modular power converter, comprising: a plurality of power conversion units each having a first power conversion module disposed within a housing, the plurality of power conversion units including: a first power conversion unit, a second power conversion unit, and a plurality of third power conversion units arranged in a stacked configuration between the first power conversion unit and the second power conversion unit.

Example 27: The modular power converter of Example 26, wherein the plurality of power conversion units defines a plurality of first coolant channels between each pair of coupled power conversion units.

Example 28: The modular power converter of Example 27, wherein each of the plurality of first coolant channels has a first lateral half defined by a first housing and a second lateral half defined by a second housing.

Example 29: The modular power converter of Examples 27 or 28, further including: a first cover configured to couple to the housing of the first power conversion unit to form a second coolant channel between the first cover and the first power conversion unit; and a second cover configured to couple to the housing of the second power conversion unit to form a third coolant channel between the second cover and the second power conversion unit.

Example 30: The modular power converter of Examples 26 to 29, wherein each of the plurality of power conversion units further includes a second power conversion module disposed within the housing.

Example 31: The modular power converter of Example 30, wherein the first power conversion module is arranged in an opposed configuration with the second power conversion module, with each and the second power conversion module coupled to a bus bar that extends between the first power conversion module and the second power conversion module.

Example 32: The modular power converter of Examples 26 to 31, wherein at least one of the plurality of power conversion units is configured to operate as a three-phase inverter.

Example 33: The modular power converter of Examples 26 to 32, wherein at least one of the plurality of power conversion units is configured to operate as a charger.

Example 34: A power converter, comprising: a housing; a first power conversion module disposed in the housing and configured to supply electrical power at a first maximum power level; a second power conversion module disposed in the housing and configured to supply electrical power at a second maximum power level; and a bus bar secured between the first power conversion module and the second power conversion module so that the first power conversion module and the second power conversion module are in an opposed configuration about the bus bar Example 35: The power converter of Example 34, wherein each of the first power conversion module and the second power conversion module includes a circuit board defining a first side configured to couple to the bus bar and a second side configured to couple to an inductor and a field effect transistor.

Example 36: The power converter of Example 35, wherein the housing includes a first external recess configured to receive a first flow of coolant and a second external recess configured to receive a second flow of coolant, the first external recess extending along the second side of the circuit board of the first power conversion module and the second external recess extending along the second side of the circuit board of the second power conversion module.

Example 37: The power converter of Example 36, wherein the housing includes a first seat configured to receive the field effect transistor of the first power conversion module and a second seat configured to receive the field effect transistor of the second power conversion module, the first seat being in fluid communication with the first external recess and the second seat being in fluid communication with the second external recess.

Example 38: The power converter of Examples 34 to 37, wherein at least one of the first power conversion module and the second power conversion module is configured to operate as both an inverter and a charger.

Example 39: The power converter of Examples 34 to 38, wherein at least one of the first power conversion module and the second power conversion module is a three-phase inverter.

Example 40: The power converter of Examples 34 to 39, wherein the first power conversion module and the second power conversion module are configured to be operated simultaneously to provide electrical power at a third maximum power level.

Example 41: The power converter of Examples 34 to 40, wherein the housing is configured to be secured to a drive unit that includes a transmission and a motor.

Example 42: The power converter of Example 41, wherein the housing is shaped to at least partially surrounding the motor, the housing defining a cylindrically concave side that is contoured around an axis of the motor.

Example 43: A power converter, comprising: a housing defining a cooling path configured to receive a flow of a coolant, and a seat having an internal area that is in fluid communication with the cooling path; and a power conversion module including a power electronic component that is received in the seat so that the coolant flows over the power electronic component.

Example 44: The power converter of Example 43, wherein the power converter includes a coolant jet configured to spray a jet of the coolant from the cooling path to the power electronic component.

Example 45: The power converter of Example 44, wherein the coolant jet is integrally formed with a material of the housing.

Example 46: The power converter of Examples 43 to 45, wherein the power electronic component defines a plane, and wherein the power electronic component is coupled to a circuit board so that the power electronic component is positioned at an angle that is a non-orthogonal angle relative to the circuit board.

Example 47: The power converter of Example 46, wherein the angle is about 45 degrees.

Example 48: The power converter of Examples 43 to 47, wherein the power electronic component includes cooling fins that are receive within the seat.

Example 49: The power converter of Examples 43 to 48, wherein the power electronic component is a field effect transistor.

Example 49: The power converter of Examples 43 to 48, wherein the power electronic component is a field effect transistor.

Example 50: A bus bar assembly, comprising: a first conduction bar, a second conduction bar spaced from the first conduction bar to define a gap therebetween; and a capacitor positioned within the gap and coupled to each of the first conduction bar and the second conduction bar.

Example 51: The bus bar assembly of Example 50, wherein each of the first conduction bar and the second conduction bar include a conduction tab and a conduction rail extending from the conduction tab, the capacitor being secured between the conduction tab of the first conduction bar and the conduction tab of the second conduction bar.

Example 52: The bus bar assembly of Example 51, wherein the conduction tab defines a first height and the conduction rail defines a second height that is less than the first height.

Example 53: The bus bar assembly of Example 52, wherein the conduction tab defines a first length and the conduction rail defines a second length that is less than the second length.

Example 54: The bus bar assembly of Example 50, wherein the first bar is arranged concentrically with the second bar so that the gap has a substantially constant width along a length of the bus bar assembly.

Example 55: The bus bar assembly of Example 50, wherein the capacitor is one of a plurality of capacitors.

Example 56: The bus bar assembly of Example 55, wherein the plurality of capacitors are arranged in series between the first conduction bar and the second conduction bar.

Example 57: The bus bar assembly of Example 55, wherein the plurality of capacitors are secured relative to one another and to each of the first conduction bar and the second conduction bar by a mounting bracket.

Example 58: The bus bar assembly of Example 50, wherein the capacitor includes a first plurality of capacitors, a second plurality of capacitors, and a cavity formed between the first plurality of capacitors and the second plurality of capacitors.

Example 59: The bus bar assembly of Example 58, wherein the capacitor defines a plurality of slits configured to couple to a power electronic component.

Example 60: The bus bar assembly of Example 50, wherein the capacitor in is a DC link capacitor.

Example 61: A power conversion module, comprising: a circuit board; a power electronic component coupled to the circuit board, a cooling jacket surrounding the power electronic component; and a jacket housing coupled to the circuit board and covering the cooling jacket, wherein the cooling jacket defines a coolant duct configured to receive a flow of coolant so that coolant flows over the power electronic component.

Example 62: The power conversion module of Example 61, wherein the power electronic component is at least one of a FET and an inductor coil.

Example 63: The power conversion module of Example 61, wherein a clearance of less than 10 millimeters is formed between an inner surface of the cooling jacket and the power electronic component, and wherein the coolant duct is formed in the clearance.

Example 64: The power conversion module of Example 61, wherein the jacket housing is shaped corresponding to a shape of the cooling jacket so that the jacket housing at least partially surrounds the cooling jacket.

Example 65: The power conversion module of Example 61, wherein inductor terminal ports are formed in the cooling jacket and the jacket housing.

Example 66: The power conversion module of Example 61, wherein the cooling jacket includes a top jacket that is configured to couple to a bottom jacket.

Example 67: The power conversion module of Example 61, wherein the jacket housing defines an inlet opening at a first end thereof and an outlet opening at a second end thereof.

Example 68: The power conversion module of Example 61, wherein the cooling jacket is one of a plurality of cooling jackets.

Example 69: The power conversion module of Example 68, wherein two or more cooling jackets in the plurality of cooling jackets are coupled in parallel, such that a first inlet of a first cooling jacket and a second inlet of a second cooling jacket are coupled to one another.

Example 70: The power conversion module of Example 68, wherein two or more cooling jackets in the plurality of cooling jackets are coupled in series, such that an outlet of a first cooling jacket is coupled to an inlet of a second cooling jacket.

Example 71: A thermal regulation system for a power conversion module that includes a power electronic component, the thermal regulation system comprising: a cooling jacket configured to enclose the power electronic component, the cooling jacket including a top jacket and a bottom jacket configured to couple to the top jacket, wherein at least one of the top jacket and the bottom jacket is shaped in accordance with the power electronic component to define a coolant duct between the cooling jacket and the power electronic component, the coolant duct configured to receive a flow of coolant.

Example 72: The thermal regulation system of Example 71, wherein the power electronic component includes electrical contacts; and wherein apertures are formed in the cooling jacket, such that the electrical contacts of the power electronic component extend through the apertures.

Example 73: The thermal regulation system of Example 71, wherein a clearance of less than 1 millimeter is formed between an inner surface of the cooling jacket and the power electronic component.

Example 74: The thermal regulation system of Example 71, wherein the power electronic component is at least one of a FET and an inductor coil.

Example 75: The thermal regulation system of Example 74, wherein the cooling jacket further defines a FET jacket and an inductor jacket, the FET jacket defining a FET cavity in which the FET is seated and the inductor jacket defining a coil cavity in which the inductor coil is seated.

Example 76: The thermal regulation system of Example 75, wherein a duct inlet is formed in the FET jacket and a duct outlet is formed in the inductor jacket; and wherein the coolant duct is defined between the duct inlet and the duct outlet.

Example 77: A power conversion module, comprising: a power electronic component including: a core; a coil wound around the core; a housing assembly coupled to at least one of the core and the coil; and an insert coupled to at least one of the core and the housing assembly, the insert defining a coolant duct configured to receive a flow of coolant and to direct the coolant to flow through the coil.

Example 78: The power conversion module of Example 77, wherein the housing assembly includes: a first cap coupled to a first side of the core; a second cap coupled to a second side of the core; a first side wall coupled to the first cap and the second cap; and a second side wall coupled to the first cap and the second cap.

Example 79: The power conversion module of Example 78, wherein the first cap includes an inlet port that is configured to receive the flow of coolant so that coolant flows into the core, and wherein the first side wall and the second side wall include a plurality of side outlet ports that are configured to direct the flow of coolant out of the housing assembly.

Example 80: The power conversion module of Example 77, wherein the core includes a first core and a second core; and wherein the insert is coupled between the first core and the second core.

Example 81: The power conversion module of Example 80, wherein the insert includes a central aperture that is radially aligned with the core; and wherein the insert defines spacer outlet ports disposed configured to allow coolant to flow from the central aperture to the coil.

Example 82: The power conversion module of Example 81, wherein the spacer outlet ports are arranged radially about the central aperture.

Example 83: The power conversion module of Example 78, wherein the insert is configured as a coolant guide that includes a cylindrical baffle wall and a base extending radially from an end of the baffle wall.

Example 84: The power conversion module of Example 83, wherein the core has a first diameter that is less than a second diameter of the baffle wall; and wherein the baffle wall is disposed radially between the coil and the core.

Example 85: The power conversion module of Example 83, wherein an axial coolant duct is formed between the baffle wall and the core; and wherein the axial coolant duct configured to direct the flow of coolant along the core.

Example 86: The power conversion module of Example 85, wherein the coolant guide further includes a plurality of pegs extending downwardly from the base, the pegs being configured to engage the housing assembly to space the base from one of the first cap and the second cap of the housing assembly.

Example 87: The power conversion module of Example 86, wherein a radial coolant duct is formed between the base and the one of the first cap and the second cap; and wherein the radial coolant duct is in fluid communication with the axial coolant duct.

Example 88: The power conversion module of Example 77, wherein the core includes a plurality of cooling fins formed thereon.

Example 89: A gasket for sealing between a first housing and a second housing, the gasket comprising: an outer rim including an inner peripheral edge that bounds an internal area of the gasket and an outer peripheral edge, the outer rim configured to be positioned between the first housing and the second housing; and a wall formed as a unitary component with the outer rim, the wall extending into the internal area from the inner peripheral edge of the outer rim.

Example 90: The gasket of Example 89, wherein the wall has a wall area that is at least five-percent of the internal area.

Example 91: The gasket of Example 89, wherein the wall is one of a plurality of walls that extend from the inner peripheral edge.

Example 92: The gasket of Example 89, wherein the wall is a flange that extends into the internal area from a first portion of the outer rim.

Example 93: The gasket of Example 89, wherein the wall is a flange that spans part of the internal area from a first section of the outer rim to a second section of the outer rim.

Example 94: The gasket of Example 93, wherein the first section of the outer rim is at a non-zero angle relative to the second section of the outer rim.

Example 95: The gasket of Example 93, wherein the first section of the outer rim is spaced apart from the second section of the outer rim.

Example 96: A drive unit for an electric vehicle, the drive unit comprising: a housing including a first housing defining a first internal volume and a second housing defining a second internal volume, the first housing configured to couple to the second housing so that the first internal volume is in communication with the second internal volume to define an internal volume of the housing; and a gasket including an outer rim that is positioned to seal between the first housing and the second housing, and a wall that extends from the outer rim and into the internal volume of the housing.

Example 97: The drive unit of Example 96, wherein the wall is configured control a flow of coolant between the first internal volume and the second internal volume.

Example 98: The drive unit of Example 96, wherein the wall spans at least two percent of an area bounded by an inner edge of the outer rim.

Example 99: The drive unit of Example 96, wherein the first housing includes a first protrusion extending from the first housing into the internal volume to guide a flow of coolant over the wall from the first internal volume to the second internal volume.

Example 100: The drive unit of Example 99, wherein the first housing defines a trough to collect the flow of coolant, the wall of the gasket spanning the trough and including an opening to control the flow of coolant out of the trough from the first internal volume to the second internal volume.

Example 101: The drive unit of Example 96, wherein the first housing is a cover and the second housing is a main housing.

Example 102: The drive unit of Example 96, wherein the first internal volume is configured to receive a transmission system and the second housing further includes a third internal volume configured to receive a power converter and a fourth internal volume configured to receive a motor.

Example 103: A power conversion module, comprising: a power electronic component; and a cooling fin coupled to the power electronic component, the cooling fin configured as a three-dimensional lattice structure defining a plurality of flow paths for coolant to flow through the cooling fin.

Example 104: The power conversion module of Example 103, wherein the cooling fin defines one or more tortuous paths to direct coolant therethrough.

Example 105: The power conversion module of Example 104, wherein the one or more tortuous paths include a plurality of turns to cause turbulent coolant flow within the cooling fin.

Example 106: The power conversion module of Example 103 further comprising a cooling jacket configured to enclose the cooling fin to define at least one coolant duct that receives a flow of coolant.

Example 107: The power conversion module of Example 106, wherein the at least one coolant duct includes a first coolant duct to direct coolant through an interior of the cooling fin and a second coolant duct to direct coolant over an exterior of the cooling fin.

Example 108: The power conversion module of Example 103, wherein the cooling fin includes a first rail that is coupled to a second rail via a connector, and wherein the connector curves convexly away from the first rail to an inflection point and concavely curves toward the second rail from the inflection point.

Example 109: The power conversion module of Example 108, wherein the connector is one of a plurality of connectors that are spaced apart from one another by a plurality of gaps, the plurality of gaps defining the plurality of flow paths to direct coolant through the cooling fin.

Example 110: The power conversion module of Example 103, wherein the cooling fin is manufactured using at least one of open-cell or closed-cell metal foaming to form a metal matrix with gas-filled pores distributed throughout the metal matrix.

Example 111: The power conversion module of Example 103, wherein the plurality of flow paths are defined by a plurality of cavities defined within a body of the cooling fin, and wherein the plurality of cavities are arranged in a grid configuration within the three-dimensional lattice structure.

Example 112: The power conversion module of Example 103, wherein the plurality of flow paths include horizontal coolant channels and vertical coolant channels to direct coolant through the cooling fin.

1. A drive unit for a vehicle, the drive unit comprising:
a transmission;
a motor operatively coupled to the transmission; and
a power converter configured to supply electrical power to the motor, the power converter including a housing that is secured to at least one of the transmission and the motor.

2. The drive unit of claim 1, wherein the housing is shaped corresponding to a shape of the motor so that the housing at least partially surrounds the motor.

3. The drive unit of claim 1, wherein the motor extends away from a first side of the transmission along a motor axis, and
wherein the power converter extends parallel to the motor axis.

4. The drive unit of claim 1, wherein the transmission includes an input configured to operatively couple to the motor and an output configured to operatively couple to a drive shaft, the input defining an input axis and the output defining an output axis, and
wherein the power converter is positioned between the input axis and the output axis.

5. The drive unit of claim 4, wherein the housing defines a first cylindrically concave side that is contoured around the input axis.

6. The drive unit of claim 4, wherein the housing is shaped corresponding to a shape of the output so that the housing at least partially surrounds the output.

7. The drive unit of claim 6, wherein the housing defines a second cylindrically concave side that is contoured around the output axis.

8. The drive unit of claim 1, wherein the power converter defines a first coolant path that is in fluid communication with at least one of a second coolant path of the transmission and a third coolant path of the motor.

9. The drive unit of claim 8, wherein a coolant is configured to flow from the transmission to the power converter and from the power converter to the motor.

10. The drive unit of claim 1, wherein the power converter includes a plurality of power conversion modules configured to provide electrical power to the motor at a plurality of discrete maximum power levels.

11. The drive unit of claim 1, wherein the power converter is a modular power converter that includes a first power conversion unit and a second power conversion unit that are configured to couple to one another, each of the first power conversion unit and the second power conversion unit including a unit housing and a power conversion module disposed within the unit housing.

12. The drive unit of claim 11, wherein the first power conversion unit and the second power conversion unit are selectively operable to provide power to the motor.

13. The drive unit of claim 12, further comprising an electronic controller
configured to selectively operate each of the first power conversion unit and the second power conversion unit based on an operational parameter of the drive unit.

14. The drive unit of claim 11, wherein the first power conversion unit and the second power conversion unit are coupled in stacked configuration to extend parallel to a motor axis.

15. The drive unit of claim 11, wherein the power conversion module of at least one of the first power conversion unit and the second power conversion unit is configured operate in a charging mode to supply electrical power to a battery.

16. The drive unit of claim 11, wherein the housing of the first power conversion unit defines a first external recess and the housing of the second power conversion unit defines a second external recess, the first external recess and the second external recess collectively forming a shared coolant channel between the first power conversion unit and the second power conversion unit.

17. The drive unit of claim 1, further comprising an end cap configured to couple to both the motor and the power converter, wherein the motor and the power converter are secured between the end cap and the transmission.

18.-112. (canceled)
